(19) United States
(12) Patent Application Publication
(10) Pub. No.: US 2006/0005676 A1
(43) Pub. Date: Jan. 12, 2006

(54) Miter saw having digital display

(76) Inventors: Hideaki Terashima, Hitachinaka-shi (JP); Shigeharu Ushiwata, Hitachinaka-shi (JP); Hiromi Ozawa, Hitachinaka-shi (JP); Ryuichi Imamura, Hitachinaka-shi (JP); Toshihiko Hayashizaki, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/169,958

(22) Filed: Jun. 30, 2005

(30) Foreign Application Priority Data
Jul. 6, 2004 (JP) P2004-199762
Jan. 20, 2005 (JP) P2005-012611

(51) Int. Cl. B23D 45/04

(52) U.S. Cl. 83/471.3; 83/473; 83/490

(57) ABSTRACT

A miter saw including a base section, a support section extending from the base section, and a circular saw unit supported to the support section and having a handle and a motor housing. The circular saw unit rotatably supports a circular saw blade. A digital display is provided at an upper portion and a front side of the motor housing. The digital display displays a first angle of a side surface of the circular saw blade relative to a fence, and/or a second angle of the side surface relative to the upper surface of the base section.

### BACKGROUND OF THE INVENTION

The present invention relates to a miter saw, and more particularly, to such a miter saw capable of performing slant cutting in which a side surface of a circular saw blade is laterally tilted with respect to an upper surface of a base section, and/or capable of performing angled cutting in which a side surface of the circular saw blade extends obliquely relative to a fence.

In a conventional table top circular saw, a workpiece such as a wood block is mounted on a base section, and the workpiece is cut by a circular saw unit vertically movable above the base section. If the workpiece is to be cut obliquely, a posture of the workpiece on the base section must be changed. Thus, workability may be lowered.

Japanese Patent Application Publication No. H08-336802 discloses a miter saw including a base section, a support section, and a circular saw unit. The base section includes a base and a turntable mounted on the base and rotatable about its axis. A workpiece is mounted on the turntable. The support section upwardly extends from the turntable and laterally tiltable. The circular saw unit is positioned above the base section and is pivotally movably supported to the support section. The circular saw unit includes a circular saw blade and a motor for rotating the blade.

For the angled cutting, the turntable is angularly rotated about its axis to change the angle of the side surface of the circular saw blade relative to the fence. For the slant cutting, the support section is laterally tilted to laterally tilt the circular saw blade relative to the base section.

In order to perform slant cutting at a desired slant angle of the circular saw blade, the user must go to a rear side of the miter saw so as to observe a scale engraved at one of the base and the circular saw unit. Such work is intricate and low working efficiency results.

In order to perform the angled cutting, the circular saw blade is set to a desired angle relative to the fence with reference to a scale engraved at the turntable or the base. However, the scale may be covered with cutting chips generated during cutting, thereby lowering visibility to the scale. Further, it would be difficult to set a desired angle defined between the circular saw blade and the fence if a massive workpiece is mounted on the turntable, because the scale may be hidden by the massive workpiece if the workpiece is greater than the turntable or the base.

### SUMMARY OF THE INVENTION

It is therefore an object of the present invention to provide a miter saw capable of providing a sufficient visibility to a cutting angle including the angle between the side surface of the circular saw blade and the fence, and/or the angle between the side surface of the circular saw blade and a top surface of the base section.

This and other object of the present invention will be attained by a miter saw including a base section having a base and a turntable, a circular saw unit, a support section, a rotation amount detection unit, and a digital display. The turntable is adaptd for mounting thereon a workpiece and is supported on the base and is rotatable about a rotation axis relative to the base. The circular saw unit rotatably supports a circular saw blade. The support section is provided to the turntable and pivotally movably supports the circular saw unit at a position above the turntable. The rotation amount detection unit detects rotation amount of the turntable relative to the base. The digital display is disposed at the circular saw unit for displaying a rotation angle based on date transmitted from the rotation amount detection unit.

In another aspect of the invention, there is provided a miter saw including a base section, a circular saw unit, a support section, a rotation amount detection unit, a display, and a control unit. The base section is adapted for mounting thereon a workpiece, and includes a base and a turntable supported to the base and rotatable about a rotation axis. The workpiece is mountable on the base and the turntable. The circular saw unit rotatably supports a circular saw blade. The support section is supported to the turntable and pivotally movably supports the circular saw unit toward and away from the turntable about a pivot shaft. The rotation amount detection unit detects angular rotation amount of the turntable relative to the base and transmits an output signal indicative of a rotation amount. The display has a display surface that displays a rotation angle of the turntable. The display is attached to the circular saw unit in such a manner that an orientation of a normal line of the display surface is changeable with respect to the circular saw unit. The control unit outputs signal indicative of the rotation angle to the display based on the output signal transmitted from the rotation amount detection unit.

In still another aspect of the invention, there is provided miter saw including a base section, a circular saw unit, a support section, a tilting amount detection unit, and a digital display. The base section is adapted for mounting thereon a workpiece. The circular saw unit rotatably supports a circular saw blade. The support section is laterally tiltably supported to the base section, and pivotally movably supports the circular saw unit toward and away from the base section. The tilting amount detection unit detects a tilting amount of a side surface of the circular saw blade relative to an upper surface of the base section. The digital display is disposed at the circular saw unit for displaying a tilting angle based on data transmitted from the tilting amount detection unit.

In still another aspect of the invention, there is provided a miter saw including a base section, a circular saw unit, a support section, a tilting amount detection unit, a display, and a control unit. The base section is adapted for mounting thereon a workpiece. The circular saw unit rotatably supports a circular saw blade. The support section is laterally tiltably supported to the base section and pivotally supports the circular saw unit movably toward and away from the base section about a pivot shaft. The tilting amount detection unit detects a tilting amount of a side surface of the circular saw blade relative to an upper surface of the base section and transmits an output signal indicative of a tilting amount. The display has a display surface that displays a tilting angle of the circular saw blade, and is attached to the circular saw unit in such a manner that an orientation of a normal line of the display surface is changeable relative to the circular saw unit. The control unit outputs signal indicative of the tilting angle to the display based on the output signal transmitted from the tilting amount detection unit.

### BRIEF DESCRIPTION OF THE DRAWINGS

In the drawings:

FIG. 1 is a perspective view of a miter saw as viewed from its front side according to a first embodiment of the present invention;

FIG. 2 is a perspective view of the miter saw as viewed from its rear side according to the first embodiment;

FIG. 3 is a front view of the miter saw according to the first embodiment;

FIG. 4 is a front view of the miter saw according to the first embodiment, and particularly showing a tilting state of a circular saw unit;

FIG. 5 is a bottom view of the miter saw according to the first embodiment;

FIG. 6 is a cross-sectional left side view of the miter saw according to the first embodiment;

FIG. 7 is an enlarged cross-sectional right side view showing an essential portion of the miter saw according to the first embodiment;

FIG. 8 is a bottom view of a turntable in the miter saw according to the first embodiment;

FIG. 9 is a cross-sectional right side view showing an adjustment mechanism for fine-adjusting the rotational position of the turntable in the miter saw according to the first embodiment;

FIG. 10 is a sight-through view as viewed from the bottom for showing the adjustment mechanism for fine adjusting the rotational position of the turntable in the miter saw according to the first embodiment;

FIG. 11 is a view showing a lower face of the turntable in the miter saw according to the first embodiment;

FIG. 12 is a cross-sectional view showing a supporting arrangement for supporting rotation of the turntable at a base in the miter saw according to the first embodiment;

FIG. 13 is a plan view showing a rotation amount detection unit in the miter saw according to the first embodiment;

FIG. 14 is an enlarged cross-sectional view showing a pin and a screw for the rotation amount detection unit in the miter saw according to the first embodiment;

FIG. 15 is an exploded cross-sectional view showing the positional relationship between a tilt motion support and a tilt section in the miter saw according to the first embodiment;

FIG. 16 is a rear view showing the tilt section a rotation amount detection unit in the miter saw according to the first embodiment;

FIG. 17 is a view for description of the tilt section and an adjustment mechanism for finely adjusting the tilting angle of the tilt section in the miter saw according to the first embodiment;

FIG. 18 is a cross-sectional view taken along the line XVIII-XVIII of FIG. 17;

FIG. 19 is a view showing a tilting amount detection unit in the miter saw according to the first embodiment;

FIG. 20 is a cross-sectional view taken along the line XX-XX of FIG. 19;

FIG. 21 is a view showing the tilting amount detection unit in the miter saw according to the first embodiment;

FIG. 22 is a cross-sectional view taken along the line XXII-XXII of FIG. 19;

FIG. 23 is a plan view of a digital display in the miter saw according to the first embodiment;

FIG. 24 is a control circuit in the miter saw according to the first embodiment;

FIG. 25 is a cross-sectional view taken along the line XXIV-XXIV of FIG. 9;

FIG. 26 is a plan view showing the rotation amount adjusting mechanism for the turntable in the miter saw according to the first embodiment;

FIG. 27 is a plan view showing the rotation amount adjusting mechanism for the turntable, and particularly showing a temporary fixing position in the miter saw according to the first embodiment;

FIG. 28 is a plan view showing the rotation amount adjusting mechanism for the turntable, and particularly showing a fine-adjustment state in the miter saw according to the first embodiment;

FIG. 29 is a plan view showing the rotation amount adjusting mechanism for the turntable, and particularly showing a full fixing position in the miter saw according to the first embodiment;

FIG. 30 is a rear view showing the mechanism for finely adjusting tilting angle of the circular saw unit in the miter saw according to the first embodiment;

FIG. 31 is a flowchart showing a processing routine for displaying rotation angle of a turntable and a tilting angle of a circular saw blade according to the first embodiment;

FIG. 32 is a block diagram showing two pulse trains generated in the rotation amount detection unit according to the first embodiment;

FIG. 33 is a block diagram showing two pulse trains generated in the tilting amount detection unit according to the first embodiment;

FIG. 34 is an explanatory view for description of an angle defined between a surface of a digital display and an upper surface of a base when a circular saw unit is positioned at its upper dead center and lower dead center, respectively according to the first embodiment of the present invention;

FIG. 35 is a front view showing a miter saw according to a second embodiment pertaining to a modification to a handle;

FIG. 36 is a right side view showing a miter saw according to a third embodiment of the present invention;

FIG. 37 is a left side view showing the miter saw according to the third embodiment;

FIG. 38 is a front view showing the miter saw according to the third embodiment;

FIG. 39 is a left side view showing a state where a circular saw unit is at its frontmost position in the third embodiment;

FIG. 40 is a left side view showing a state where the circular saw unit is pivotally moved toward a turntable when the circular saw unit is at its frontmost position in the third embodiment;

FIG. 41 is a left side view showing a state where the circular saw unit is at its rearmost position while the circular saw unit is pivotally moved toward the turntable in the third embodiment;

FIG. 42 is a left side view showing a state where the circular saw unit is at its rearmost position and a pair of pipes are at their frontmost positions in the third embodiment;

FIG. 43 is a left side view particularly showing a spiral code in a state where the circular saw unit and the pair of pipes are at their frontmost positions in the third embodiment;

FIG. 44 is a rear view particularly showing a tilting angle fine adjustment mechanism in the miter saw according to the third embodiment;

FIG. 45 is a cross-sectional view showing an essential portion of the tilting angle fine adjustment mechanism in the miter saw according to the third embodiment;

FIG. 46 is a rear view particularly showing the tilting angle fine adjustment mechanism in a state where the circular saw unit is tilted to its most rightward position in the third embodiment;

FIG. 47 is a rear view particularly showing the tilting angle fine adjustment mechanism in a state where the circular saw unit is tilted to its most leftward position in the third embodiment;

FIG. 48 is a bottom view showing an essential portion of a rotation angle fine adjustment mechanism in the miter saw according to the third embodiment;

FIG. 49 is a cross-sectional view showing a mechanism including a pair of pipes for moving the circular saw unit in axial direction of the pipe the miter saw according to the third embodiment;

FIG. 50 is a cross-sectional view taken along the line L-L in FIG. 49 for particularly showing a first slide support portion;

FIG. 51 is a cross-sectional view taken along the line L1-L1 in FIG. 49 for particularly showing a second slide support portion;

FIG. 52(a) is a right side view showing a cover that covers the pair of pipes in the miter saw according to the third embodiment;

FIG. 52(b) is a plan view of the cover;

FIG. 52(c) is a left side view of the cover;

FIG. 53 is a plan view showing the cover fixed to a first end holding member and a second end holding member in the miter saw according to the third embodiment;

FIG. 54(a) is a front view showing a display unit in the miter saw according to the third embodiment;

FIG. 54(b) is a left side view showing the display unit in the third embodiment;

FIG. 55 is a perspective view as viewed from a front side showing a miter saw according to a fourth embodiment of the present invention;

FIG. 56 is a perspective view as viewed from a rear side showing the miter saw according to the fourth embodiment;

FIG. 57 shows a first modification and is a plan view of a mechanism for fine-adjusting rotation angle of the turntable;

FIG. 58 shows a second modification and is a cross-sectional view of a mechanism for adjusting rotation angle of the turntable;

FIG. 59 is a bottom view of the second modification;

FIG. 60 is a frontal cross-sectional view of the second modification;

FIG. 61 shows a third modification and is a cross-sectional view of a mechanism for adjusting tilting angle of the circular saw unit;

FIG. 62 shows a fourth modification and is a rear view of a mechanism for adjusting tilting angle of the circular saw unit;

FIG. 63 is a rear view according to the fourth modification;

FIG. 64 shows a fifth modification and is a rear view of a mechanism for adjusting tilting angle of the circular saw unit;

FIG. 65 shows a six modification and is a rear view of a mechanism for adjusting tilting angle of the circular saw unit;

FIG. 66 shows a seventh modification and is a rear view of a tilting amount detection unit;

FIG. 67 is a cross-sectional view taken along the line LXVII-LXVII of FIG. 66;

FIG. 68 shows an eighth modification and is a rear view of a tilting amount detection unit;

FIG. 69 shows a ninth modification and is a block diagram of a control circuit which is a modification to the control circuit of FIG. 24;

FIG. 70 shows a tenth modification and is a plan view of a rotation angle fine adjustment mechanism; and

FIG. 71 shows the tenth modification and is a plan view of a turntable rotated by an angle from an original position by the operation of the rotation angle fine adjustment mechanism.

### DETAILED DESCRIPTION OF THE PREFERRED EMBODIMENTS

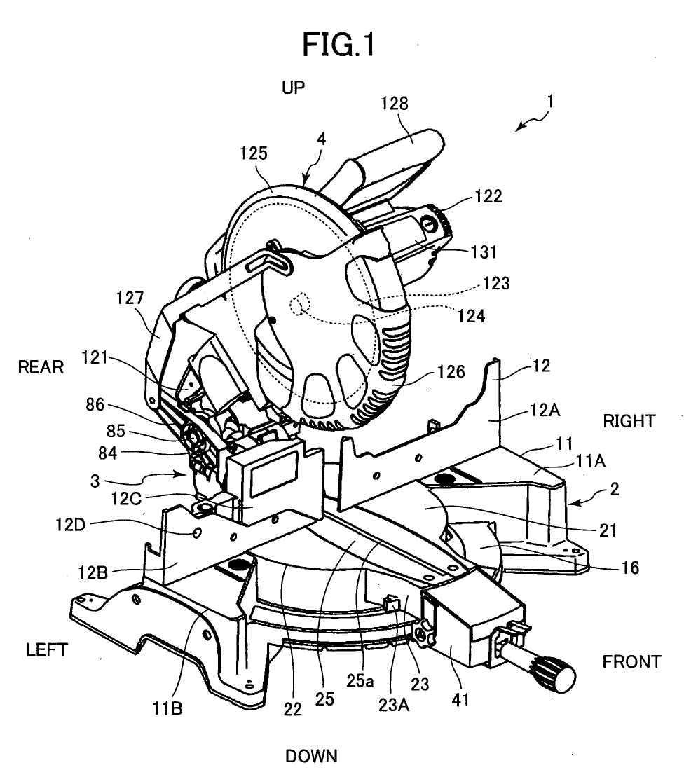

A miter saw according to a first embodiment of the present invention will be described with reference to FIGS. 1 through 34.

As shown in FIG. 1, the miter saw 1 includes a base section 2 installed on a stand or a floor for mounting thereon a workpiece such as a wood, a circular-saw unit 4 that cuts a workpiece, and a support section 3 supporting the circular saw unit 4 pivotally movably toward and away from the base section 2 and laterally tiltably relative to the base section.

As shown in FIG. 1, the base section 2 includes a base 11 serving as a ground section, a turntable 21 and a fence 12. The turntable 21 is supported on the base 11 and is rotatable about its axis with respect to the base 11. The turntable 21 cooperates with the base 11 to support a workpiece such as a wood block. The fence 12 laterally extends over the base 11 and is supported on the base 11 The fence 12 has an abutment surface extending in the lateral direction and facing frontward in contact with a side surface of the workpiece for positioning the workpiece. In the following description, the facing side of the abutment surface is defined as the front side, the extending direction of the fence is defined as leftward/rightward or lateral direction, and a ground side of the base 11 is defined as a lower side.

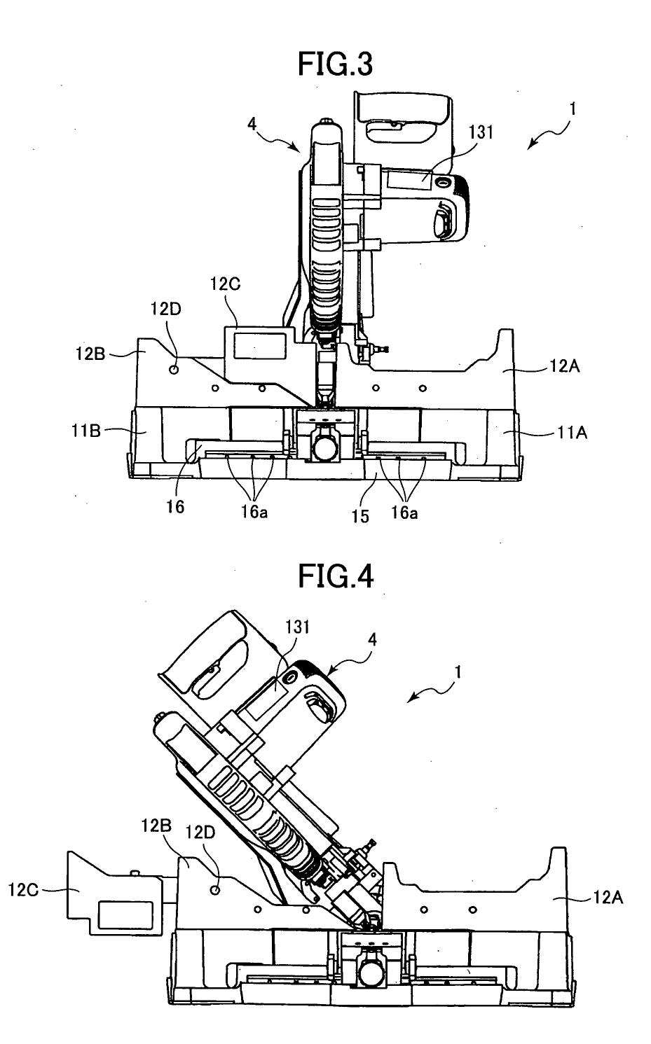

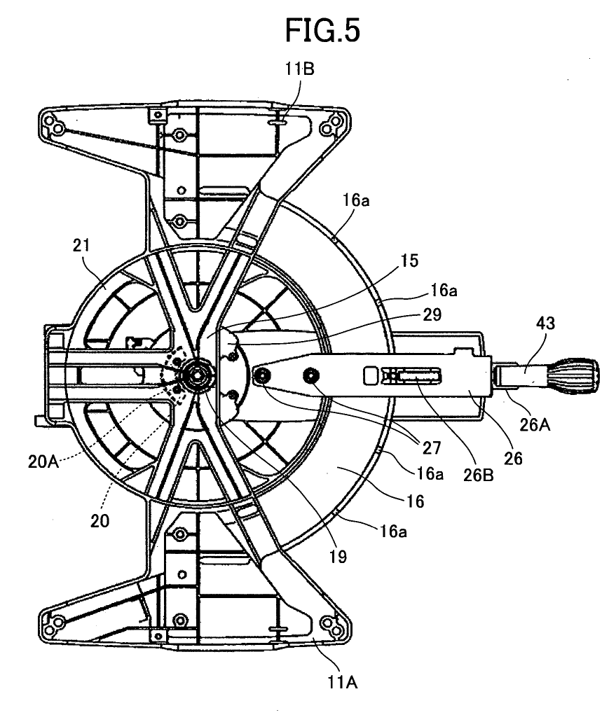

As shown in FIGS. 1 and 3, the base 11 includes a right base 11A and a left base 11B interposing the turntable 21 therebetween. Each top surface of each base 11A, 11B serves as a workpiece mounting surface. As shown in FIGS. 3 and 5, the base 11 also includes an arcuate portion 16 disposed between the right base 11A and the left base 11B and protruding frontward. The arcuate portion 16 has a peripheral side whose center is coincident with a rotation axis of the turntable 21. As shown in FIG. 5, the peripheral side has a lower end formed with a plurality of locking grooves 16a engageable with a protruding portion 26B of a lock lever 26 described later.

The plurality of locking grooves 16a are positioned at a predetermined angles such as 15 degrees, 30 degrees and 45 degrees relative to a reference axis (0 degrees) extending frontward from the rotation axis of the turntable 21 in a direction perpendicular to the fence 12. Further, as shown in FIG. 5, a linking portion 15 is provided for linking the right base 11A to the left base 11B at a position in direct confrontation with the installation spot such as a floor. The linking portion 15 has a center region provided with a rotation support 19 for rotatably supporting the turntable 21. The rotation support 19 defines the rotation axis.

As shown in FIGS. 1 and 3, the fence 12 includes a right fence 12A fixed to the right base 11A and a left fence 12B fixed to the left base 11B. These fences 12A, 12B have abutment surfaces in abutment with the workpiece, and the abutment surfaces extend in a direction substantially perpendicular to the upper surfaces of the base 11 carrying the workpiece. As shown in FIG. 3, the left fence 12B has a pivot shaft 12D, and a separate pivotable fence 12C is pivotally supported to the left fence 12B through the pivot shaft 12D. Thus, as shown in FIG. 4, a direct abutment of a circular saw blade 123 described later in the circular-saw unit 4 against the fence 12 can be avoided by pivotally moving the pivotable fence 12C away from a locus of the blade 123, even if the circular saw unit 4 is tilted laterally.

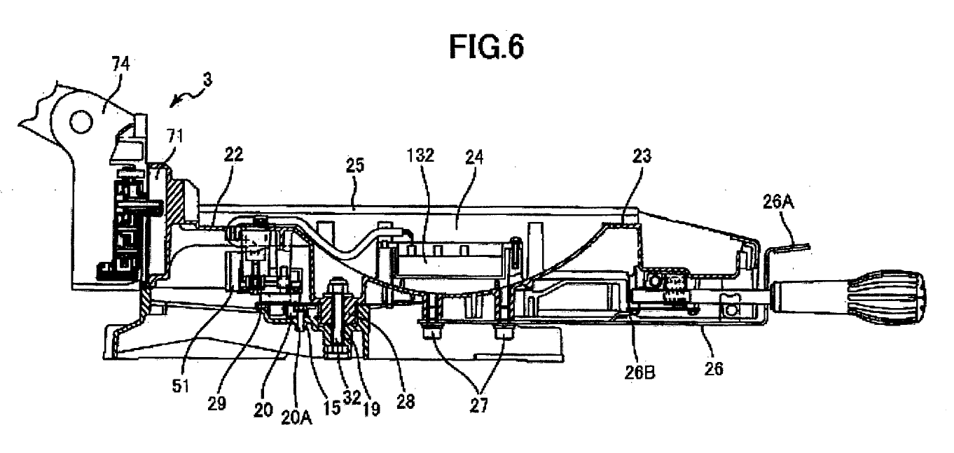

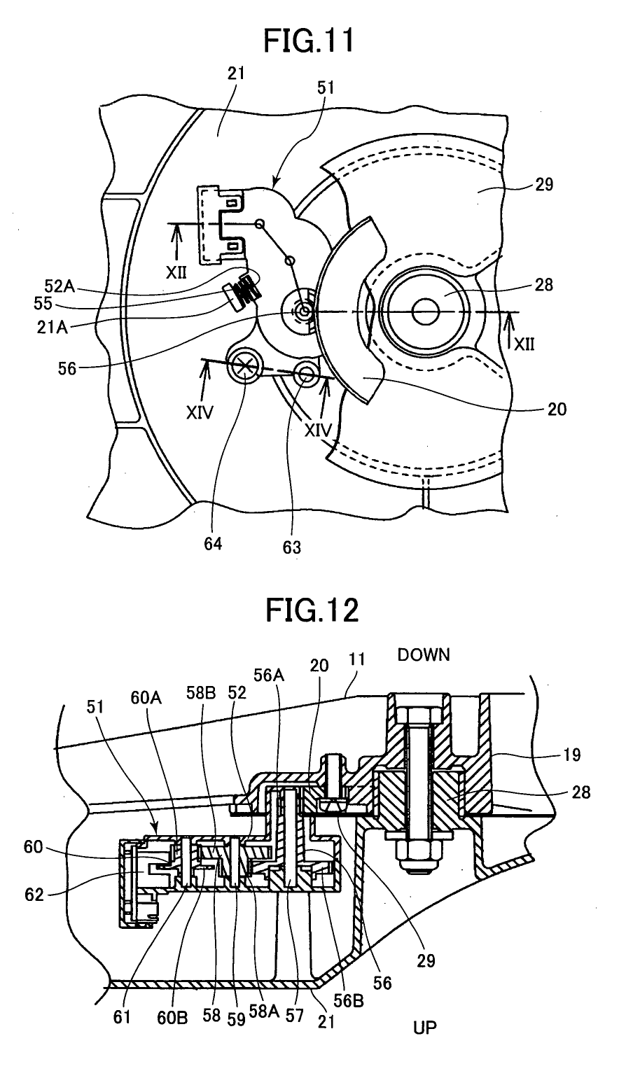

As shown in FIGS. 5 and 6, an arcuate outer gear teeth segment 20 is fixed with a screw 20A to an upper surface of the linking portion 15 at a position rearward of the rotation support 19. The arcuate outer gear teeth segment 20 is on an imaginary circle whose center is coincident with the central axis of the rotation support 19. A rotation amount detection unit 51 (FIG. 11 and described later) is displaceable relative to the arcuate outer gear teeth segment 20 for detecting an angular rotation amount of the turntable 21.

As shown in FIG. 1, the turntable 21 includes a circular table section 22 interposed between the right and left bases 11A and 11B, and having an upper surface on which a workpiece is mounted. The circular table section 22 defines therein a rotation axis of the turntable 21. The turntable 21 also includes a neck table section 23 extending frontward from the circular table section 22 and positioned above the arcuate portion 16. The upper surfaces of the circular table section 22 and the neck table section 23 are flush with the upper surface of the base 11. A semicircular recess 24 is formed at the turntable 21. The semicircular recess 24 is open at the upper surfaces of the circular table section 22 and the neck table section 23 in a fusiform-shaped configuration, and has a semi-circular contour in the vertical direction in conformance with the contour of the circular saw blade 123. The upper opening is covered with a fusiformed shaped slit plate 25 having a center portion formed with a slit 25a which allows the circular saw blade 123 to pass therethrough when the circular saw unit 4 is pivotally moved toward the turntable 21.

A battery box 132 (FIG. 6) is disposed in the semicircular recess and at a left side of the slit 25a the battery box 132 is adapted for supplying electric current to a microcomputer 142 described later.

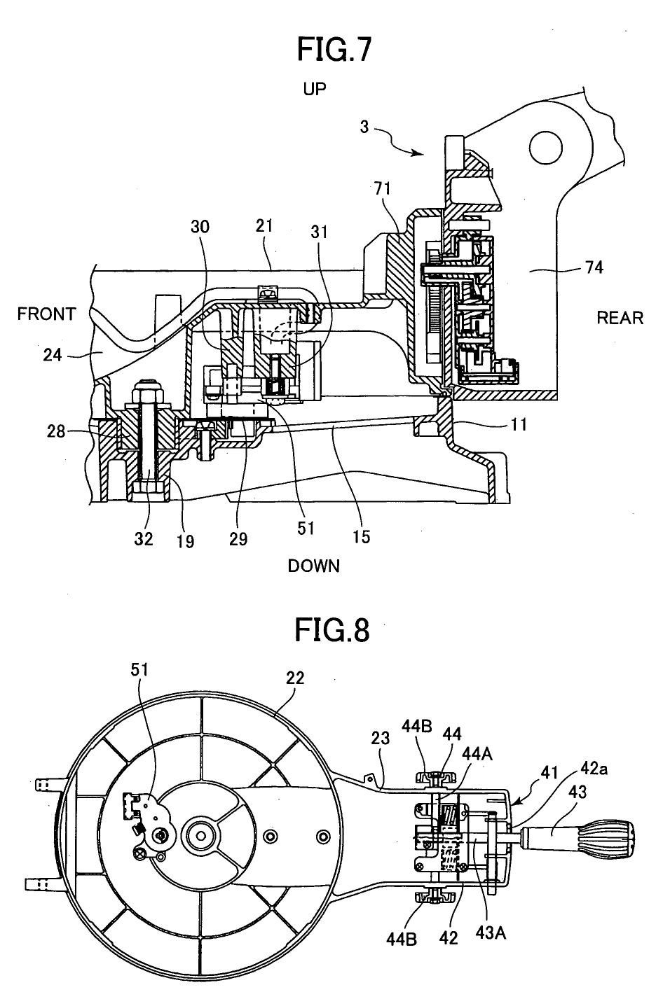

As shown in FIGS. 6 and 7, a rotation shaft section 28 is disposed at a bottom of the semi-circular recess 24 and at a position in alignment with the center of the circular table section 22. The rotation shaft section 28 is housed in a space defined by the rotation support 9 of the base 11. The rotation shaft section 28 and the rotation support 9 are formed with through holes through which a bolt 32 extends so as to allow the turntable 21 to be rotatable relative to the base 11 without disassembly of the turntable 21 from the base 11.

A protrusion 23A (FIG. 1) protrudes from a left side of the neck table section 23. The protrusion 23A is abuttable against the left base 11B when the turntable 21 is angularly rotated. A corresponding protrusion also protrudes from a right side of the neck table section 23 so as to be abuttable against the right base 11A. Thus, the turntable 21 is angularly rotatable relative to the base 11 within a range defined by the abutments.

An adjustment unit 41 (FIG. 1) is provided at a front end of the neck table section 23 for adjusting angular rotational position of the turntable 21. As shown in FIGS. 7 and 8, a pin fixing portion 30 and a screw fixing portion 31 protrude from a lower face of the turntable 21. Further, the rotation amount detection unit 51 (FIG. 8) in association with the outer gear teeth segment 20 of the base 11 is disposed below the pin fixing portion 30 and the screw fixing portion 31 for detecting the angular rotation amount of the turntable 21.

As shown in FIGS. 5 and 6, a resilient lock lever 26 is fixed with screws 27 to the lower surface of the turntable 21 at a position below the arcuate portion 16 and in front of the rotation shaft section 28. The lock lever 28 extends to a front end, position of the adjustment unit 41 (FIG. 8). The front end portion of the lock lever 26 is positioned below the adjustment unit 41, and is folded upwardly along a front end surface of the adjustment unit 41.

A push-down portion 26A is provided at the free front end of the lock lever 26. The lock lever 26 is provided with an upward protrusion 26B at a position in confrontation with a lower end face of the peripheral wall of the arcuate portion 16. The upward protrusion is engageable with a selected one of the plurality of locking grooves 16a formed at the lower end face of the arcuate portion 16. Accordingly, angular rotational position of the turntable 21 is fixed by the engagement of the upward protrusion 26B with the selected one of the locking grooves 16a, since the lock lever 26 is angularly moved together with the angular movement of the turntable 21.

The push-down portion 26A is positioned at the front side of the miter saw 1. Normally, the user is positioned in front of the miter saw 1. Therefore, access to the pushdown portion 26A is easily made for the user.

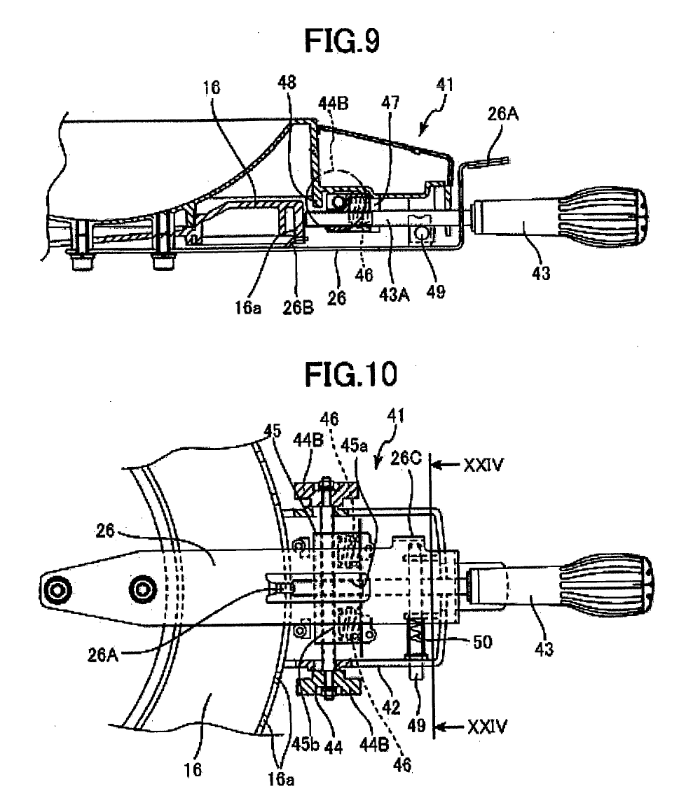

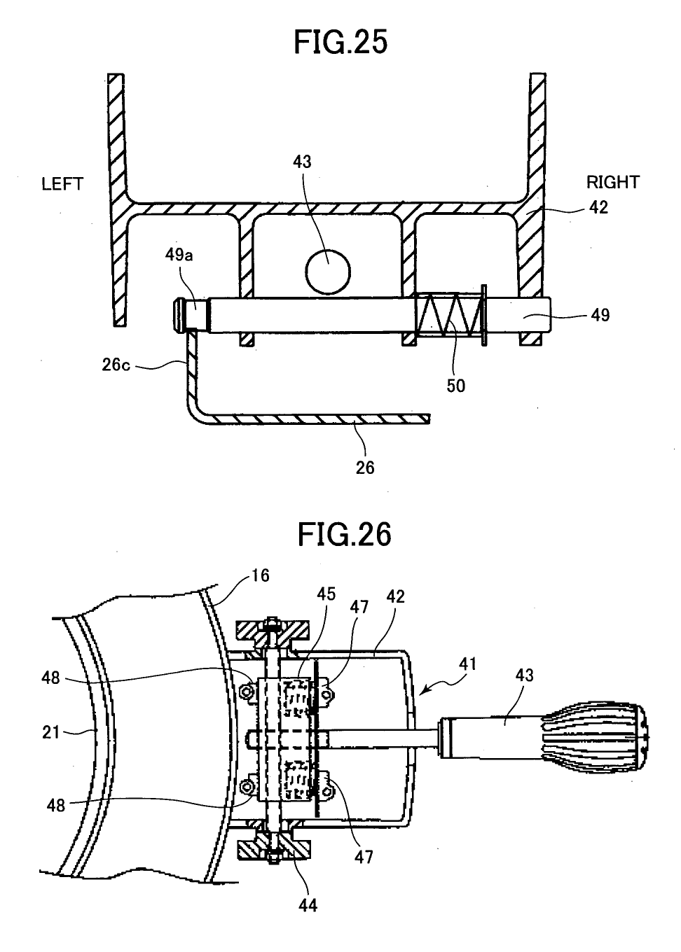

As shown in FIGS. 9 and 10, the adjustment unit 41 includes a front frame 42 with which a lock lever fixing pin 49 is laterally slidably supported for avoiding engagement of the upward protrusion 26B with the one of the locking grooves 16a. As shown in FIG. 5, the lock lever fixing pin 49 has a tip end portion formed with an annular fixing groove 49a. Further, a spring 50 is disposed over the lock lever fixing pin 49 for urging the pin 49 rightward. A tongue 26C extends upwardly from a left side of the lock lever 26. The fee end of the tongue 26C is positioned in superposed relation to the slide locus of the lock lever fixing pin 49. Normally, the lock lever fixing pin 49 is biased rightward by the biasing force of the spring 50. In this case, the tongue 26C is out of engagement from the annular fixing groove 49a, so that the upward protrusion 26B is engagable with one of the locking grooves 16a. On the other hand, if the push-down portion 26A of the lock lever 26 is pushed down and the lock lever fixing pin 49 is pushed leftward in FIG. 25, the tongue 26 can be engaged with the annular fixing groove 49a when the push-down portion 26A is released. As a result, the engagement of the upward protrusion 26B with the one of the locking grooves 16a is prevented to allow the turntable 21 to be freely angularly rotated to a desired angle.

As shown in FIGS. 8 through 10, the adjustment unit 41 further includes a fixing handle 43, an adjusting screw 44 and a table contact piece 45 in addition to the lock lever fixing pin 49. The front frame 42 of the turntable 21 has a front wall 47 (FIG. 9) and a rear wall 48 (FIG. 9) and is formed with a front opening 42a, and lateral holes. The fixing handle 43 has a shaft portion 43A extending through the front opening 42a in frontward/rearward direction, and has an inner distal end pressure contactable with the outer peripheral surface of the arcuate portion 16 of the base 11. The adjusting screw 44 extends through the lateral holes in a direction perpendicular to the shaft portion 43A. The adjusting screw 44 includes a shaft portion 44A and a pair of knobs 44B at both ends of the shaft portion 44A. The shaft portion 43A is formed with a male thread at a region crossing with the adjusting screw 44. The adjusting screw 44 is also formed with a male thread at a region crossing with the shaft portion 43A.

The table contact piece 45 is movable between the front wall 45 and the rear wall 48 and is selectively contactable with the front wall 45 in accordance with the frontward movement of the table contact piece 45 or with the rear wall 48 in accordance with a rearward movement thereof. The table contact piece 45 is formed with a first female thread 45a threadingly engageable with the male thread of the shaft portion 43A, and a second female thread 45b threadingly engageable with the male thread of the adjusting screw 44. The first and second female thread 45a and 45b extend perpendicular to each other, and are not intersected with each other but are offset from each other in the vertical direction. Thus, the fixing handle 43 and the adjusting screw 44 are directed perpendicular to each other by way of the table contact piece 45. The fixing handle 43 and the table contact piece 45 constitute engagement components.

As shown in FIGS. 9 and 10, springs 46 are juxtaposed laterally and are interposed between the table contact piece 45 and the front wall 47 for permitting the piece 45 to abut on the rear wall 48. By threadingly advancing the fixing handle 43, the shaft portion 43A is moved rearward relative to the piece 45. However, after the distal inner end of the shaft portion 43A abuts on the outer peripheral surface of the arcuate portion 16, the fixing handle 43 cannot any more be moved rearward. Instead, the piece 45 is then moved frontward because of the threading engagement with the shaft portion 43A.

Each end of the adjusting screw 44 is provided with the knob 44B interposing the front frame 42 therebetween. Therefore, the adjusting screw 44 is not movable laterally, i.e., in its axial direction relative to the front frame 42. By the rotation of the adjusting screw 44 about its axis, relative movement between the piece 45 and the shaft portion 44A occurs. In this case, since the shaft portion 44A is immovable in its axial direction, the piece 45 is moved laterally within the front frame 42. The angular rotational position of the turntable 21 is fixed at a predetermined position by the engagement of the upward protrusion 26B with one of the locking grooves 16a. However, the engagement between the upward protrusion 26B and the locking groove 16a is prevented at positions nearby the particular locking grooves which define angular rotation angle such as 0 degree, and 15 degrees in order to perform fine angular position control of the turntable 21 nearby these angles.

When the tip end of the shaft portion 43A is brought into tight contact with the outer peripheral surface of the arcuate portion 16a of the base 11, the fixing handle 43 is considered to be integral with the base 11. Therefore, the lateral movement of the table contact piece 45 relative to the front frame 42 implies the lateral movement of the front frame 42 relative to the base 11, i.e., a minute lateral angular movement of the turntable 21 relative to the base 11.

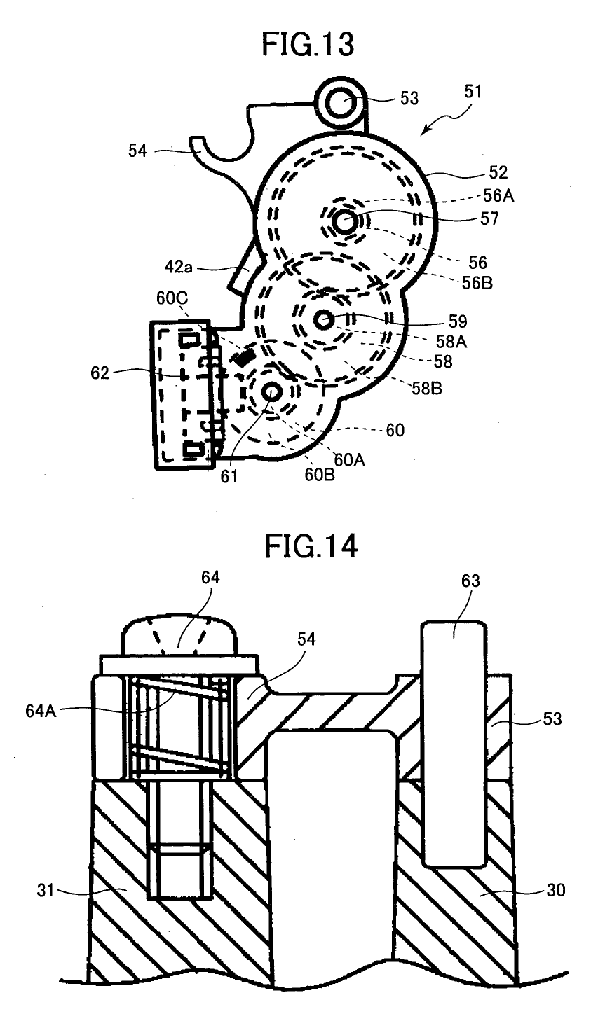

As shown in FIGS. 12 and 13, the rotation amount detection unit 51 includes a sealed housing 52 supported to the turntable 21. In the housing 52, an amplifier including a first gear set 56 and a second gear set 58, a detected segment 60 and an optical sensor 62 are assembled. Shafts 57, 59 and 61 are disposed in and rotatably supported to the housing 52. The first gear set 56 includes a first gear 56A and a second gear 56B. The first gear 56A protrudes outwardly from the housing 52 and is meshedly engaged with the outer gear teeth segment 20. The second gear 56B is coaxially with and integral with the first gear 56A and is meshedly engaged with the second gear set 58. A diameter of the second gear 56B is greater than that of the first gear 56A. The first and second gears 56A and 56B are rotatable about the shaft 57, and the second gear 56B and a major part of the first gear 56A are disposed in the housing 52.

The second gear set 58 includes a third gear 58A and a fourth gear 58B. The third gear 58A is meshedly engaged with the second gear 56B. The fourth gear 58B is coaxially with and integral with the third gear 58A and is meshedly engaged with the detected segment 60. A diameter of the fourth gear 58B is greater than that of the third gear 58A. The third and fourth gears 58A and 58B are rotatable about the shaft 59 and are disposed in the housing 52.

The detected segment 60 includes a fifth gear 60A meshedly engaged with the fourth gear 58B, and a disc like detected element 60B coaxially with and integral with the fifth gear 60A. The detected segment 60 is rotatable about the shaft 61 and is disposed in the housing 52. The disc like detected element 60B is formed with a hundred of radial slits 60C. The optical sensor 62 has a pair of arms for supporting the disc like detected element 60B therebetween. Slits 60C is detected at the arms for detecting rotation angle of the disc like detected element 60B.

The optical sensor 62 includes two light emitting elements (not shown) and two light receiving elements (not shown) each positioned in confronting relation to each light emitting element. The disc like detected element 60B is positioned between the light emitting elements and the light receiving elements. In accordance with the rotation of the disc like detected element 60B, lights emitted from the two light emitting elements pass through the respective slits 60C and reach the light receiving elements, and are shut off by a solid region of the disc like detected element 60B alternately, the solid region being positioned between the neighboring slits 60C and 60C to generate optical pulses.

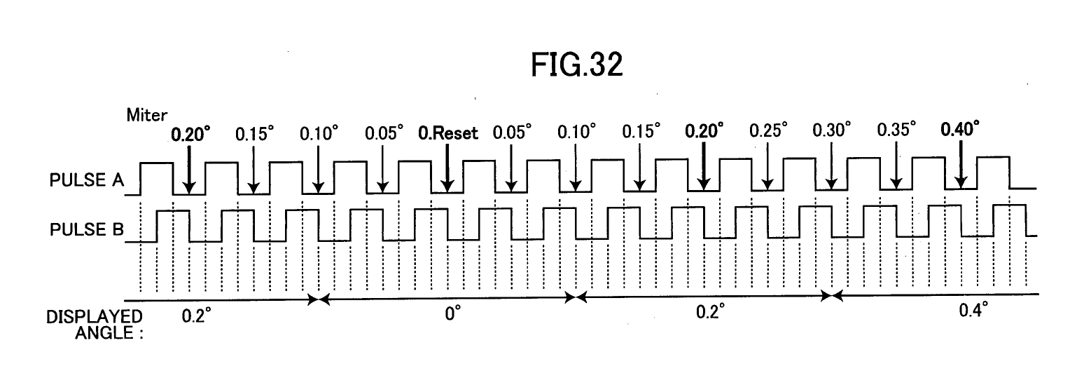

One of the pair of light emitting and receiving elements are angularly displaced from the remaining pair of light emitting and receiving elements in the circumferential direction of the disc like detected element 60B. The microcomputer 142 receives two pulse trains A and B displaced from each other by 90 degrees as shown in FIG. 32 corresponding to the angular displacement.

Since the two pulse trains A and B displaced from each other by 90 degrees are detected, rotating direction of the disc like detected element 60B can be detected. In other words, the direction of the angular rotation of the turntable 21 can be detected, the direction being one of the clockwise direction and counterclockwise direction.

More specifically, regarding pulse trains A and B in FIG. 32, high level and low level are designated by “1” and “0”, respectively. Assuming that the present pulse in the pulse train A is “0”, and the present pulse in the pulse train B is “0”. Then, if the pulse in the pulse train A is “1”, whereas the pulse in the pulse train B is “0”, the angular rotating direction of the turntable 21 is assumed to be clockwise direction, i.e., rightward in FIG. 32. On the other hand, assuming that the present pulse in the pulse train A is “0”, and the present pulse in the pulse train B is “0”, and if the pulse in the pulse train A is “0”, whereas the pulse in the pulse train B is “1”, the angular rotating direction of the turntable 21 is assumed to be counterclockwise direction, i.e., leftward in FIG. 32. Incidentally, the gear ratio of the rotation amount detection unit 51 is set so as to provide rotation of the detected segment 60 by 72 degrees per every rotation of the turntable 21 by 1 degree.

As shown in FIG. 13, in the rotation amount detection unit 51, a pin extension hole 53 and a screw fixing region 54 are formed at the housing 52 in the vicinity of the first gear set 56. A pin 63 extends through the pin extension hole 53. The screw fixing region 54 has a C-shape configuration having an open end part. As shown in FIG. 14, when a screw 64 is attached to the screw fixing portion 31, the screw fixing region 54 can be separated from the screw 64 as long as the screw 64 is unfastened. The Open end part of the screw fixing region 54 allows the rotation amount detection unit 51 to be pivotally moved while the unfastened screw 64 extends into the screw fixing portion 31. Thus, the rotation amount detection unit 51 is pivotable with respect to the turntable 21 about a pin 63. Further, the pivot position of the rotation amount detection unit 51 can be fixed relative to the turntable 21 at a desired angle by fastening the screw 64. Incidentally, a spring 64A is interposed between the screw 64 and the screw fixing portion 31 so that the spring 64A functions as a spring washer. Thus, reaction force is always imparted on the screw 64 in its axial direction, which prevents the screw 64 from being freely rotated about is axis. Consequently, accidental release of the screw 64 from the screw fixing portion 31 due to vibration can be prevented even if the screw 64 is unfastened.

As shown in FIG. 11, the housing 52 has an abutment region 52A, and the turntable 21 has an abutment plate 21A protruding downward from the lower face of the turntable 21 and in confrontation with the abutment region 52A. A spring 55 is interposed between the abutment plate 21A and the abutment region 52A when the rotation amount detection unit 51 is attached to the turntable 21. By the biasing force of the spring 55, the first gear 56A of the first gear set 56 is pressed against the outer gear teeth segment 20. Accordingly, rattling of the first gear 56A relative to the outer gear teeth segment 20 can be restrained, and consequently, angular rotation of the turntable 21 relative to the base 11 can be accurately detected.

As shown in FIGS. 6 and 7, the turntable 21 has a rear end provided with a tilting motion support 71. The support section 3 includes a tilt section 74 tiltable relative to the tilting motion support 71.

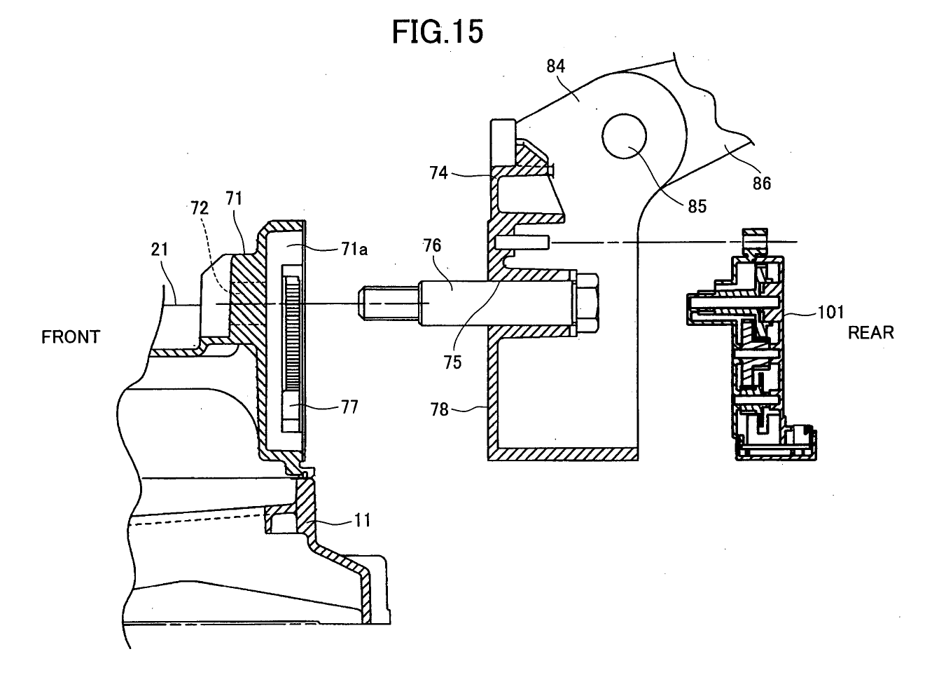

As shown in FIG. 6, the tilting motion support 71 extends upward from the rearmost end of the turntable 21. As shown in FIG. 15, The tilting motion support 71 is formed with a support bore 72 positioned flush with the upper surface of the turntable 21 and coaxially with the widthwise centerline of the slit 25a (FIG. 1). The tilt section 74 has a pin bolt 76 inserted into the support bore 72, so that the tilt section 74 is linked to the tilting motion support 71. The tilting motion support 71 has a wall in contact with the tilt section 74, and the wall is formed with a circular recess 71a. An arcuate inner gear teeth 77 is fixed to the circular recess 71a by a screw (not shown). The arcuate inner gear teeth 77 is on an imaginary circle whose center is coincident with a center axis of the support bore 72.

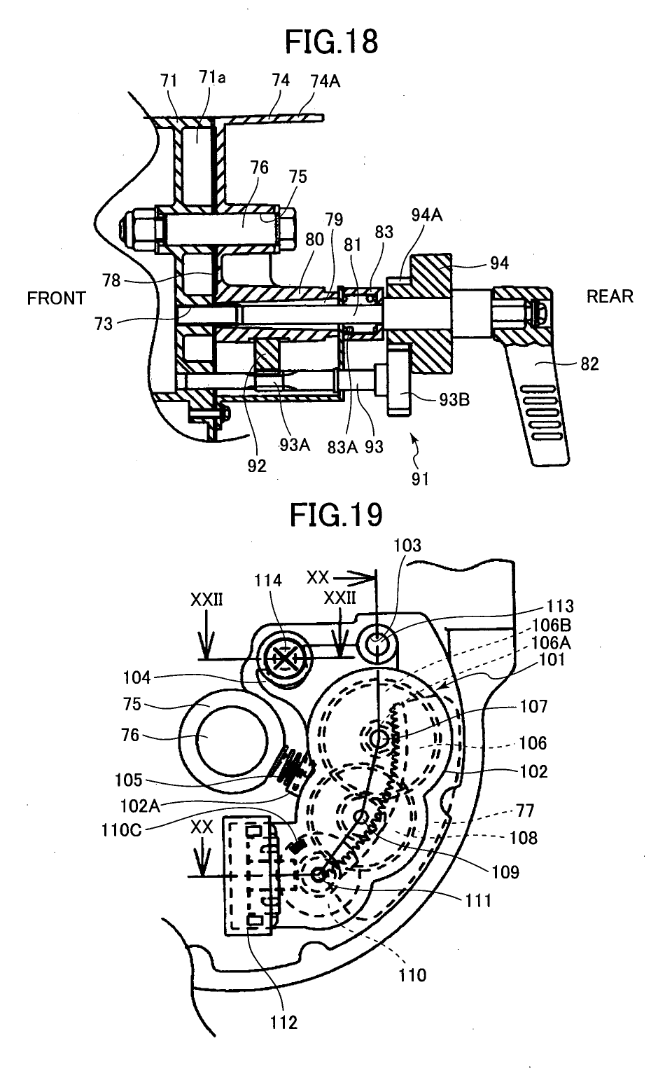

As shown in FIG. 18, a slide wall 78 is provided at the tilt section 74 and at a position in sliding contact with the tilting motion support 71. A pivot hole 75 is formed at an approximately center of the slide wall 78, and the pin bolt 77 extends through the pivot hole 75. Thus, the slide wall 78 is in sliding contact with a contour edge of the circular recess 71a at the rear side of the tilting motion support 71 when the tilt section 74 is pivotally moved relative to the tilting motion support 71. A rear wall 74A extends rearward from an edge of the slide wall 78. That is, the rear wall 74A extends substantially in parallel with the pin volt 76, and in a direction from the tilting motion support 71 to the tilt section 74.

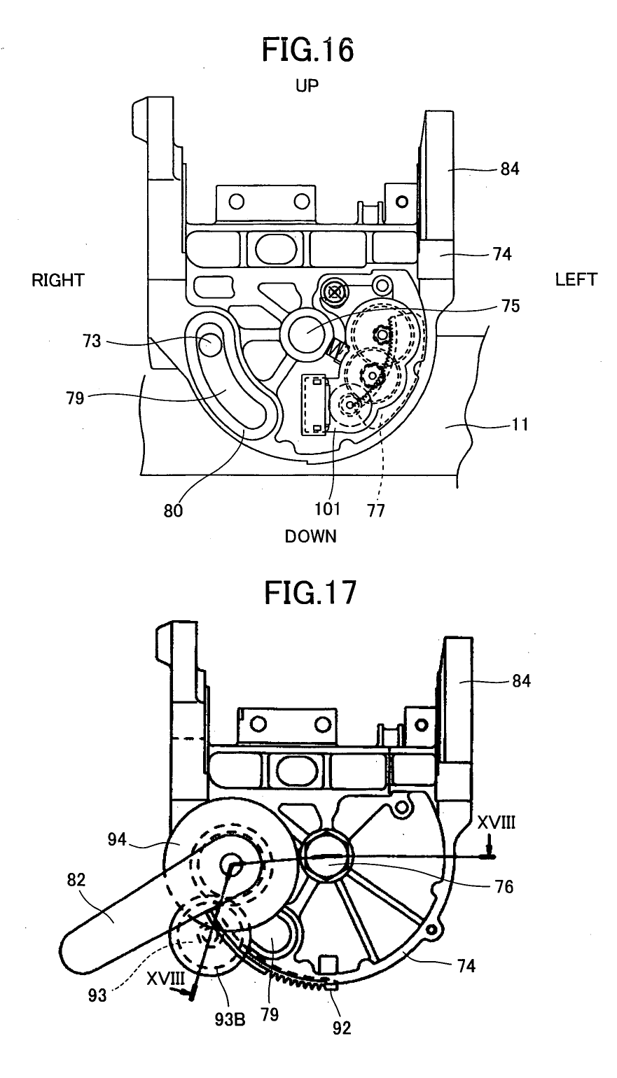

As shown in FIG. 16, an arcuate elongated slot 79 whose contour is defined by an arcuate rib 80 is formed in the tilt section 74 and at a position rightward of the pivot hole 75 of the tilt section 74. The elongated slot 79 is open at the surface of the slide wall 78, and is located on an imaginary circle whose center is coincident with the center axis of the pivot hole 75. The tilting motion support 71 is formed with a clamp hole 73 threadingly engageable with a clamp shaft 81 (described later). The clamp hole 73 is positioned in confronting relation to the elongated slot 79.

A tilting amount detection unit 101 is disposed leftward of the pivot hole 75 and at a position surrounded by the slide wall 78 and the rear wall 74A. The tilting amount detection unit 101 is adapted for detecting a tilting amount of the tilt section 74 relative to the tilting motion support 71 in association with the arcuate inner gear teeth 77 provided therein.

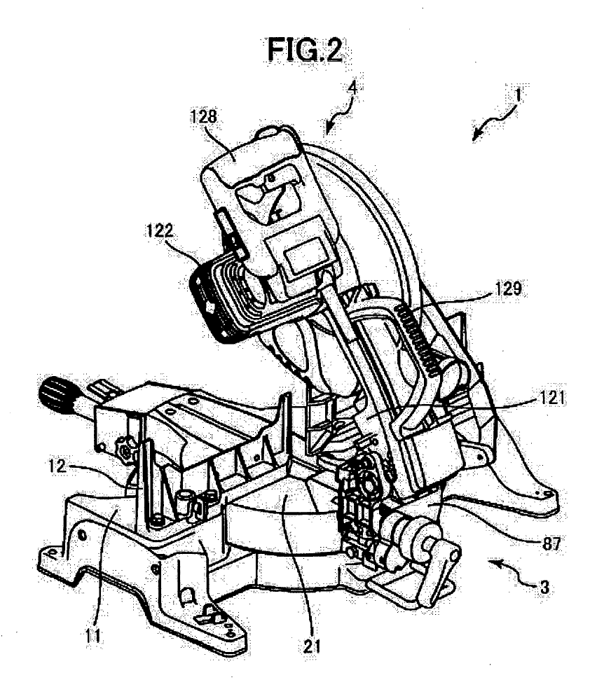

A pair of tilt support arms 84 extend upward from the tilt section 74 at a position above the pivot hole 75 for supporting the circular saw unit 4. A tilt support pin or a pivot pin 85 (FIG. 15) extends between the pair of tilt support arms 84,84 for connecting the circular saw unit 4 to the support section 3. A cover 87 (FIG. 2) is provided at the end of the rear wall 74A for protecting the elongated slot rib 80, the tilting amount detection unit 101, and the pin bolt 76. Therefore, these components 80, 101 and 76 are not exposed to the atmosphere. An arm support 86 (FIG. 1) is provided at the left tilt support arm 84 for supporting an arm 127 (described later, FIG. 1).

As shown in FIG. 18, the clamp shaft 81 has a tip end formed with a male thread for threadingly engaging with the clamp hole 73. Thus, a tiltable range of the tilt section 74 relative to the tilting motion support 71 is defined by a movable range of the clamp shaft 81 within the elongated slot 79. In the depicted embodiment, the tiltable range is 45 degrees.

As shown in FIG. 18, the arcuate rib 80 defining the elongated slot 79 extends rearward from the rear surface of the tilt section 74. A clamp lever 82 is provided at a rear end of the clamp shaft 81. A spacer 83 assembling therein a spring 83A is interposed between the clamp lever 82 and the rear end face of the arcuate rib 80. Since the clamp shaft 81 is threadingly engaged with the clamp hole 73 of the tilting motion support 71, the clamp lever 82 and the spacer 83 are moved toward the tilting motion support 71 upon fastening the clamp shaft 81 in response to the pivotal motion of the clamp lever 82 about an axis of the clamp shaft 81. Since the arcuate rib 80 which is a part of the tilt section 74 exists between the spacer 83 and the tilting motion support 71, the arcuate rib 80 is nippingly interposed between the spacer 83 and the tilting motion support 71. Accordingly, a frictional force is generated between the slide wall 78 and the tilting motion support 71 so that the tilt section 74 is fixed to the tilt motion support 71 at a desired tilting posture. Thus, a clamp unit is constituted by the clamp shaft 81, the clamp lever 82, the spacer 83 and the spring 83A. Because of the provision of the spring 83A within the spacer 83, the clamp lever 82 is urged rearward relative to the tilting motion support 71 and the arcuate rib 80. Consequently, accidental pivotal motion of the clamp lever 82 can be restrained to reduce rattling.

As shown in FIGS. 17 and 18, a tilt amount fine control unit 91 is disposed nearby the clamp shaft 81 for finely controlling tilting amount of the tilt section 74 relative to the tilt motion support 71. The tilt amount fine control unit 91 includes an arcuate gear teeth 92 fixed to the tilt section 74, a rotation shaft 93 meshedly engaged with the arcuate gear teeth 92, and an adjustment knob 94 meshedly engaged with the rotation shaft 93. The arcuate gear teeth 92 is located on an imaginary circle whose center is coincident with the center axis of the pivot hole 75. Further, the arcuate gear teeth 92 is fixed at a position along a radially outer edge of the elongated slot 79 (FIG. 17). The rotation shaft 93 is rotatably supported to the tilting motion support 71 and extends rearward in a direction approximately parallel with the clamp shaft 81. The rotation shaft 93 includes a first gear 93A meshedly engaged with the arcuate gear teeth 92. The rotation shaft 93 also includes a second gear 93B having a diameter greater than that of the first gear 93A and provided at a rear end of the rotation shaft 93. The adjustment knob 94 is coaxially with and rotatably disposed over the clamp shaft 81. The coaxial arrangement of the adjustment knob 94 with the clamp shaft 81 can save a space, thereby improving implementation or packaging of the tilt amount fine control unit 91.

A third gear 94A meshedly engaged with the second gear 93B is provided integrally and coaxially with the adjustment knob 94 at a position in front of the adjustment knob 94. Incidentally, since the arcuate gear teeth 92 is drivingly connected to the adjustment knob 94, the adjustment knob 94 continues rotating as long as the tilt section 74 is tiltingly moved for tilting the circular saw unit 4.

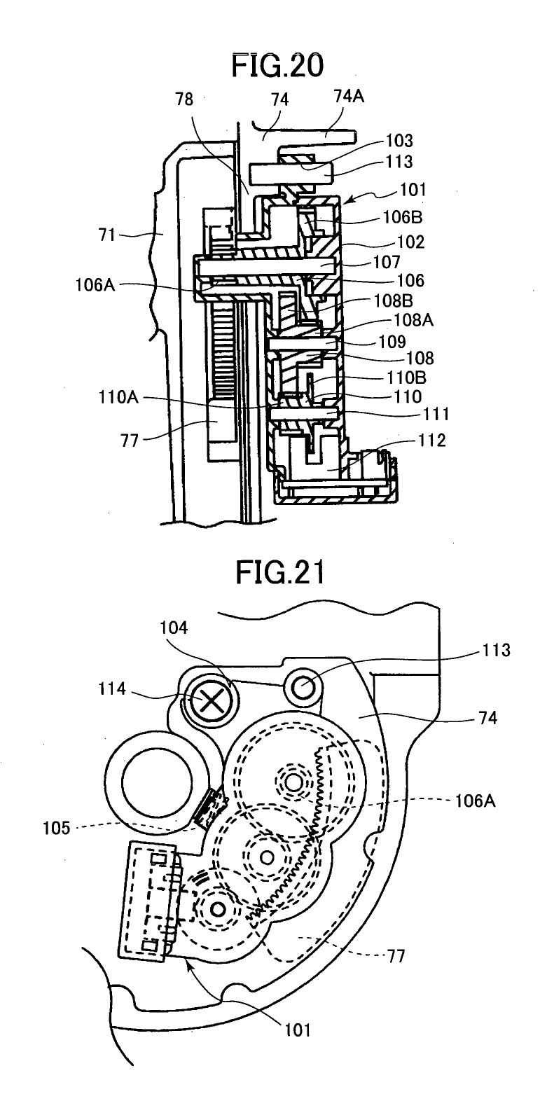

As shown in FIGS. 19 and 20, the tilting amount detection unit 101 includes a sealed housing 102, an amplifier containing a first gear set 106 and a second gear set 108, a detected segment 110 and an optical sensor 112, those assembled in he housing 102. Shafts 107, 109 and 111 are disposed in and rotatably supported to the housing 102. The first gear set 106 is supported to the shaft 107 and includes a first gear 106A and a second gear 106B. The first gear 106A protrudes outwardly from the housing 102, and the protruding part extends through a bore (not shown) formed in the tilt section 74, and is meshedly engaged with the arcuate inner gear teeth 77. The second gear 106B is coaxially with and integral with the first gear 106A and is meshedly engaged with the second gear set 108. A diameter of the second gear 106B is greater than that of the first gear 106A. The first and second gears 106A and 106B are rotatable about an axis of the shaft 107, and the second gear 106B and a major part of the first gear 106A are disposed in the housing 102.

The second gear set 108 includes a third gear 108A and a fourth gear 108B. The third gear 108A is meshedly engaged with the second gear 106B. The fourth gear 108B is coaxially with and integral with the third gear 108A and is meshedly engaged with the detected segment 110. A diameter of the fourth gear 108B is greater than that of the third gear 108A. The third and fourth gears 108A and 108B are rotatable about an axis of the shaft 109 and are disposed in the housing 102.

The detected segment 110 includes a fifth gear 110A meshedly engaged with the fourth gear 108B, and a disc like detected element 110B coaxially with and integral with the fifth gear 110A. The detected segment 110 is rotatable about an axis of the shaft 111 and is disposed in the housing 102. The disc like detected element 110B is formed with a hundred of radial slits 110C. The optical sensor 112 has a pair of arms for supporting the disc like detected element 110B therebetween. Slits 110C is detected at the arms for detecting rotation angle of the disc like detected element 110B.

The optical sensor 112 includes two light emitting elements (not shown) and two light receiving elements (not shown) each positioned in confronting relation to each light emitting element. The disc like detected element 110B is positioned between the light emitting elements and the light receiving elements. In accordance with the rotation of the disc like detected element 110B, lights emitted from the two light emitting elements pass through the respective slits 110C and reach the light receiving elements, and are shut off by a solid region of the disc like detected element 110B alternately, the solid region being positioned between the neighboring slits 110C and 110C to generate optical pulses.

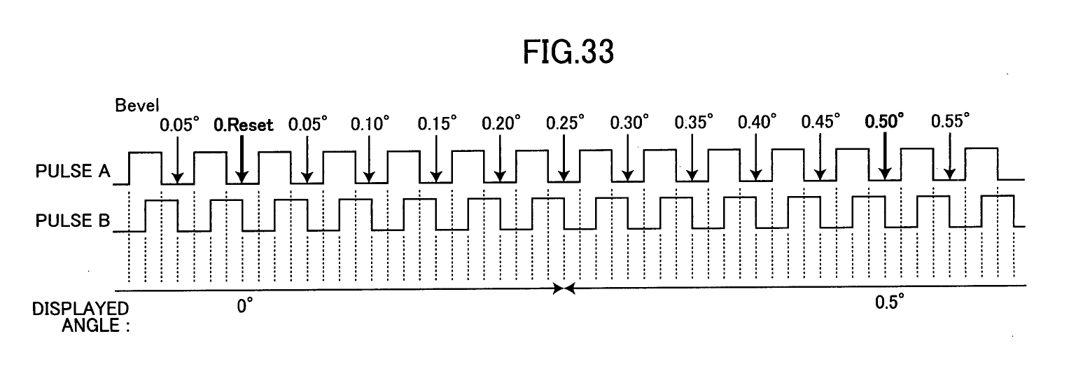

One of the pair of light emitting and receiving elements are angularly displaced from the remaining pair of light emitting and receiving elements in the circumferential direction of the disc like detected element 110B. The microcomputer 142 receives two pulse trains A and B displaced from each other by 90 degrees as shown in FIG. 33 corresponding to the angular displacement.

Since the two pulse trains A and B displaced from each other by 90 degrees are detected, rotating direction of the disc like detected element 110B can be detected. In other words, the tilting direction of the circular saw unit 4 can be detected, the direction being one of the clockwise direction and counterclockwise direction.

More specifically, regarding pulse trains A and B in FIG. 33, high level and low level are designated by “1” and “0”, respectively. Assuming that the present pulse in the pulse train A is “0”, and the present pulse in the pulse train B is “0”. Then, if the pulse in the pulse train A is “1”, whereas the pulse in the pulse train B is “0”, the tilting direction of the tilt section 74 is assumed to be clockwise direction, i.e., leftward in FIG. 33. On the other hand, assuming that the present pulse in the pulse train A is “0”, and the present pulse in the pulse train B is “0”, and then if the pulse in the pulse train A is “0”, whereas the pulse in the pulse train B is “1”, the tilting direction of the circular saw unit 4 is assumed to be counterclockwise direction, i.e., rightward in FIG. 33. Incidentally, the gear ratio of the tilting amount detection unit 101 is set so as to provide rotation of the detected segment 110B by 72 degrees per every tilting angle of the tilt section 74 by 1 degree.

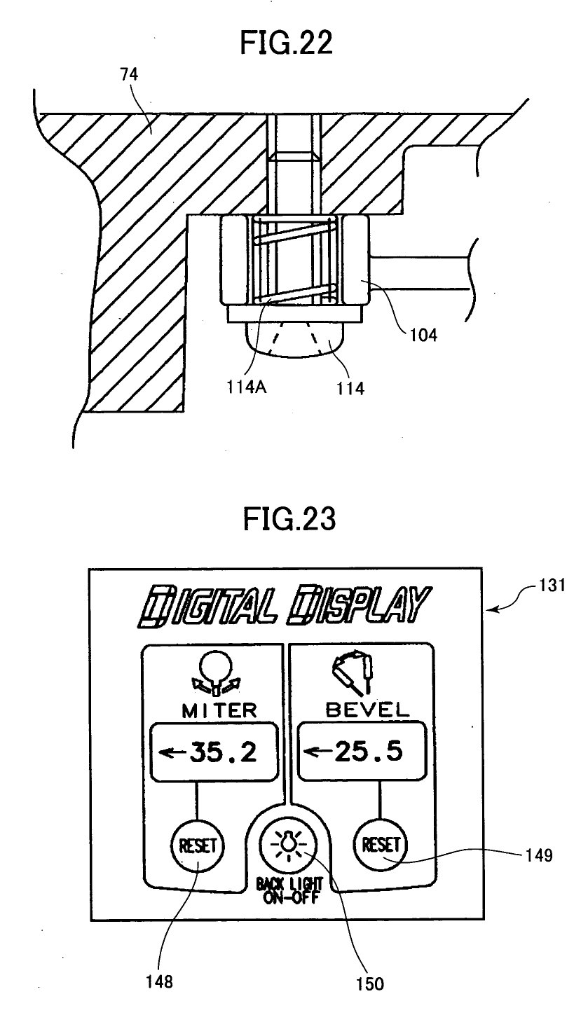

As shown in FIG. 19, in the tilting amount detection unit 101, a pin extension hole 103 and a screw fixing region 104 are formed at the housing 102 in the vicinity of the first gear set 106. A pin 113 extends through the pin extension hole 103. The screw fixing region 104 has a Cshape configuration having an open end part. As shown in FIG. 22, when a screw 114 is attached to the screw fixing portion 104, the screw fixing region 104 can be separated from the screw 114 as long as the screw 114 is unfastened. The open end part of the screw fixing region 104 allows the tilting amount detection unit 101 to be pivotally moved while the unfastened screw 114 extends into the screw fixing portion 104. Thus, the tilting amount detection unit 101 is pivotable with respect to the tilt section 74 about a pin 113 within a range defined by the size of the screw fixing region 104. Further, the pivot position of the tilting amount detection unit 101 can be fixed relative to the tilt section 74 at a desired angle by fastening the screw 114. Incidentally, a spring 114A is interposed between the screw 114 and the tilt section 74 so that the spring 114A functions as a spring washer. Thus, reaction force is always imparted on the screw 114 in its axial direction, which prevents the screw 114 from being freely rotated about is axis. Consequently, accidental release of the screw 114 from the tilt section 74 due to vibration can be prevented even if the screw 114 is unfastened.

As shown in FIG. 19, the housing 102 has an abutment region 102A. A spring 105 is interposed between the abutment region 102A and an annular rib defining the pivot hole 75 when the pivot amount detection unit 101 is attached to the tilt section 74. By the biasing force of the spring 105, the first gear 106A of the first gear set 106 is pressed against the arcuate inner gear teeth 77. Accordingly, rattling of the first gear 106A relative to the arcuate inner gear teeth 77 can be restrained, and consequently, tilting amount (pivot amount) of the tilt section 74 relative to the tilting motion support 71 can be accurately detected.

Attachment of the tilting amount detection unit 101 to the tilt section 74 may be difficult to achieve if the first gear 106A is biased to a position to be engageable with the arcuate inner gear teeth 77. For facilitating the attachment work, the tilting amount detection unit 101 is provisionally fixed, with the screw 114, to the tilt section 74 with a specific pivot posture where the spring 105 is compressed as shown in FIG. 21. This posture provides a sufficient space between the first gear 106A and the arcuate inner gear teeth 77. Then, the screw 114 is unfastened, so that the tilting amount detection unit 101 is pivotally moved toward the arcuate inner gear teeth 77 by the biasing force of the spring 105. Thus, the first gear 106A is brought into meshing engagement with the arcuate inner gear teeth 77.

The circular-saw unit 4 includes a frame 121, a motor housing 122, a handle 128, the circular saw blade 123, a saw cover 125 and a safety cover 126. The frame 121 is connected to the tilt support arm 84 through the tilt support pin 85. A spring (not shown) is interposed between the frame 121 and the tilt support arm 84 for biasing the frame 121 upwardly. Thus, he circular saw unit 4 is at its uppermost position as a rest position in case of a non-cutting operation.

The motor housing 122 is disposed at the front side of the frame 121 for accommodating a motor (not shown). The handle 128 is disposed at an outer peripheral surface and front side of the motor housing 122. A user grips the handle 128 to move the circular saw unit 4 downward for cutting operation. The motor housing 122 rotatably supports a rotation shaft 124 to which the circular saw blade 123 is concentrically fixed. The saw cover 125 is adapted to cover an upper half of the circular saw blade 123. The safety cover 126 is pivotally movably supported to the saw cover 125 and is protrudable from and retractable into the saw cover 125 for selectively covering a lower half of the circular saw blade 123. The arm 127 serves as a pivot moving mechanism for the safety cover 126, and has one end attached to the safety cover 126. The arm 127 has another end attached to the arm support 86. A carry handle 129 (FIG. 2) is provided at an approximately center portion of the frame 121 for hand-carrying the miter saw 1.

As shown in FIG. 1, a digital display such as a liquid crystal display 131 is provided at a front side of the motor housing 122. As shown in FIG. 23, the digital display 131 displays the angular rotation angle of the turntable 21 at a rate of 0.2 degrees, and displays the tilting angle of the circular saw unit 4 at a rate of 0.5 degrees. Therefore, even minute angular rotation angle and the tilting angle can be accurately and easily recognized by the user.

Generally, the user is positioned in front of the miter saw for cutting operation. Since the digital display 131 is provided at the front side of the miter saw 1, the user can easily recognize the displayed angle. Further, since the digital display 131 is disposed at the motor housing 122, adhesion of the cutting chips generated during cutting operation onto the display surface of the digital display 131 is avoidable. Further, even if a massive workpiece is placed on the turntable 21, the workpiece does not hide the display surface of the digital display 131. Moreover, the display surface is visible from the front side of the miter saw 101 at any times regardless of the lateral tilting motion of the circular saw unit 4 or pivot motion of the circular saw unit 4 toward and away from the turntable 21.

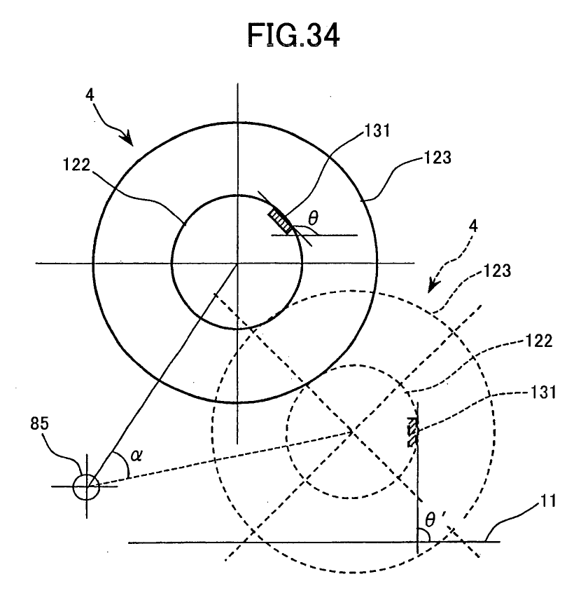

Attachment position of the digital display 131 with respect to the motor housing 122 and orientation of the digital display surface are shown in FIG. 34 in which a solid line and a broken line indicate an upper dead center position and a lowermost position of the circular saw unit 4, respectively. Further an angle α represents a maximum pivot angle between upper dead center position and the lower dead center position of the circular saw unit 4. An angle θ represents an angle defined between the upper surface of the base 11 and the surface of the digital display when the circular saw unit 4 is at its upper dead center. An angle θ′ represents an angle defined between the upper surface of the base 11 and the surface of the digital display when the circular saw unit 4 is at its lowermost position.

If the angle θ′ is smaller than 90 degrees, the surface of the digital display 131 faces downward to degrade visibility. In order to make the angle θ′ not less than 90 degrees, the following relationship (1) must be satisfied: θ≧90+α (1) where θ=θ′+α

In the first embodiment, since angle α is 45, angle θ must be not less than 135. Further, the surface of the digital display should be directed frontward even if the circular saw unit 4 is at its uppermost position. Therefore, the angle θ should be less than 180.

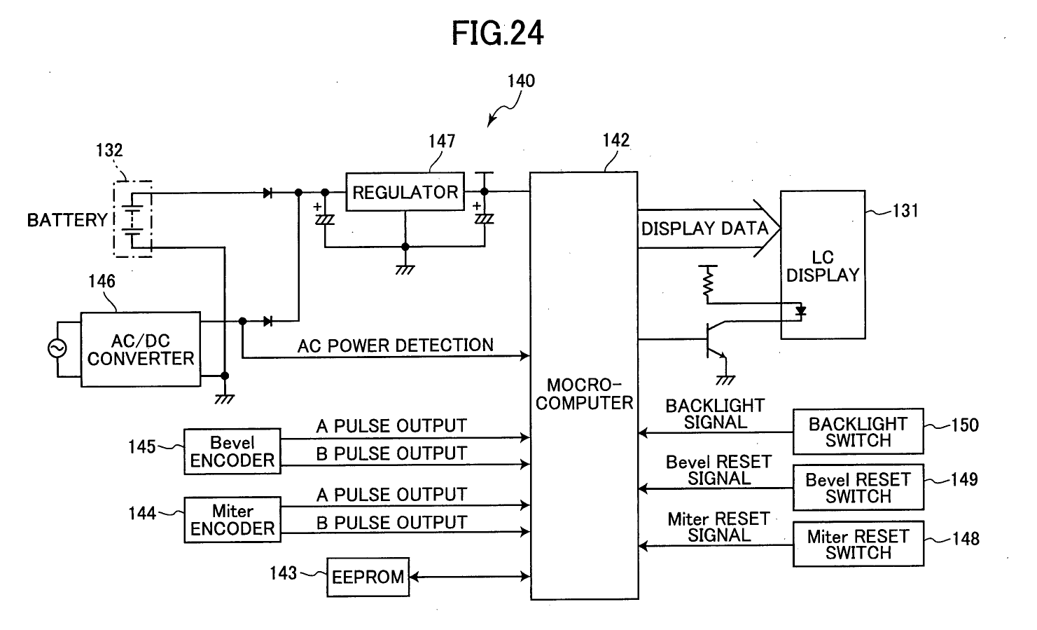

The digital display 131 displays the angles based on output signals transmitted from the microcomputer 142. The microcomputer 142 includes a computing means that performs computation based on the detection made by the units 51 and 101. FIG. 24 shows a control circuit 140. To the microcomputer 142, are connected a EEPROM 143, a Miter encoder 144, a bevel encoder 145, AC/DC converter 146, a regulator 147, a battery box 132 and the digital display 131.

The EEPROM 143 is adapted for electrically rewriting a content. The Miter encoder 144 is adapted for converting a signal from the optical sensor 62 of the rotation amount detecting unit 51 into a signal available for the microcomputer 142. The Bevel encoder 145 is adapted for converting a signal from the optical sensor 112 of the tilting amount detecting unit 101 into a signal available for the microcomputer 142. The AC/DC converter 146 is adapted for converting alternate current from a main power source into direct current. The regulator 147 is adapted for regulating or stabilizing an electric power. The battery box 132 and the AC/DC converter 146 are also connected to the Miter encoder 144, the Bevel encoder 145, and the digital display 131 for supplying electric power thereto. An electric power supply is controlled such that if a main power source through the AC/DC converter 146 is rendered OFF, an electric power from the battery box 132 is supplied to these components 144,145 and 131. On the other hand, if the main power source is rendered ON, an electric power from the main power source is supplied to these components 144,145, 131. Incidentally, the electric power from the battery box 132 is not supplied to the motive component such as the motor (not shown), but is only supplied to the microcomputer 142, the Miter encoder 144, the Bevel encoder 145 for the purpose of a control and measurement.

A Miter reset switch 148 for resetting the angular rotation of the turntable 21, a Bevel reset switch 149 for resetting the tilting angle of the tilt section 74, and a backlight switch 150 for lighting a backlight of the digital display 131 are also connected to the microcomputer 142. The digital display 131 is adapted for displaying a result of computation executed in the microcomputer 142 based on the outputs from the optical sensors 62, 112.

Cutting operation with the miter saw 1 will next be described. First, the workpiece is mounted on the upper surface of the base 11 while the workpiece is pushed onto the abutment surface of the fence 12. Then, the circular saw unit 4 is moved downward by pulling the handle 128 for cutting. For the cutting, the angled cutting is intended in which a cutting face is angled with respect to the abutment surface of the fence 12, or a slant cutting is intended in which a cutting face is slanted with respect to the upper surface of the base 11. For these cuttings, the following procedures are taken.

If the workpiece is to be cut with a cutting face angled with respect to the abutment surface of the fence 12, the turntable 21 is angularly rotated. Since the circular saw unit 4 is positioned above the turntable 21, the circular saw unit 4 is moved together with the turntable 21. Since the fence 12 is fixed to the base 11, the side surface of the circular saw blade 123 is angled relative to the workpiece as viewed from the above point of the workpiece. This cutting mode will be referred to as “angled cutting mode”.

In the angled cutting mode, a cutting angle can be determined by the engagement of the upward protrusion 26B with one of the locking grooves 16a. For the engagement, the turntable 21 is angularly rotated while the lock lever 26 is not pressed down. Then, the upward protrusion 26B is brought into engagement with the desired one of the locking grooves 16a at the desired angle. With this state, the fixing handle 43 is fastened until the fixing handle 43 cannot be rotated any more, whereupon the tip end of the fixing handle 43 is pressed against the arcuate portion 16 of the base 11. Thus, the turntable 21 is fixed to the base 11. In this state, the angular rotation angle of the turntable 21 relative to the base 11 is precisely determined by the engagement between the locking groove 16a and the upward protrusion 26B. Therefore, fine adjustment to the angular rotation of the turntable 21 is not required.

For setting the cutting angle at a desired angle offset from the predetermined angles defined by the locking grooves 16a, the push-down portion 26A of the lock lever 26 is pushed down. Further, as shown in FIG. 25, the lock lever fixing pin 49 is pushed into a space within the frame 42, so that the tongue 26C is engaged with the annular fixing groove 49a. With this engagement, the engagement of the upward protrusion 26B with one of the locking grooves 16a is prevented even if the upward protrusion 26B is vertically in alignment with the locking groove 16a. Thus, the angular rotation angle of the turntable 21 can be set at a desired angle. After the tongue 26C is engaged with the annular fixing groove 49a, the turntable 21 is angularly rotated to a position near the desired angle in the miter saw 1 according to the first embodiment, the angular rotation angle can be displayed at every 0.2 degrees. Therefore, a desired angular rotating position of the turntable 21 cannot be easily provided by gripping the fixing handle 43 and moving the fixing handle 43. Therefore in the present embodiment, after the turntable 21 is angularly rotated to a position near the desired angle, then, a fine adjustment is performed to accurately provide the desired angle.

More specifically, as shown in FIG. 26, the adjustment unit 41 provided at the turntable 21 is positioned near the desired angle relative to the arcuate portion 16 provided at the base 11. In this state, the tip end of the fixing handle 43 is separated from the outer peripheral surface of the arcuate portion 16, and further, the table contact piece 45 is in abutment with the rear wall 48 by the biasing force of the spring 46. This position of the table contact piece 45 is referred to as a release position.

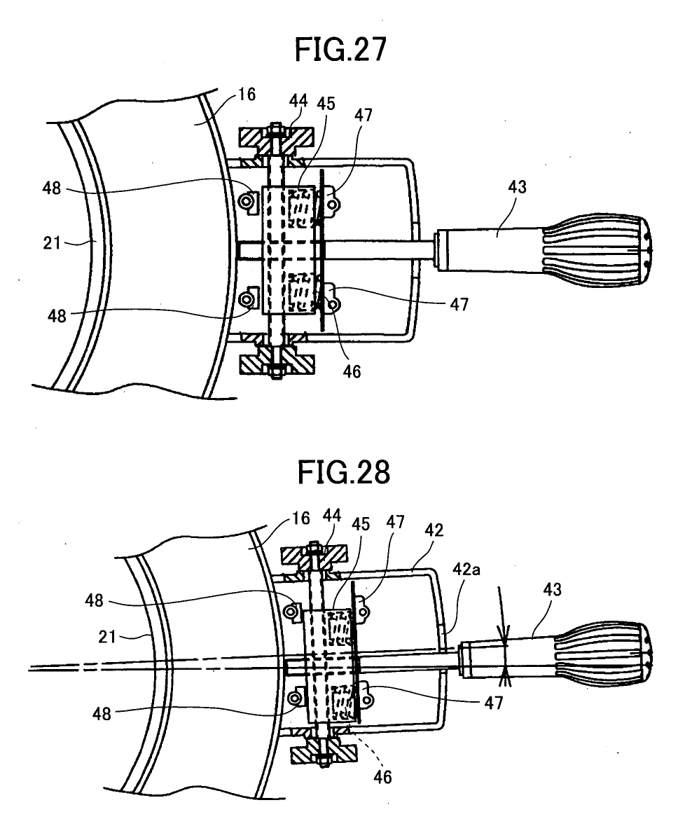

Then in FIG. 27, the fixing handle 43 is rotated about its axis so as to press the tip end of the fixing handle 43 against the arcuate portion 16. Thus, the table contact piece 45 is moved away from the rear wall 48 to an adjustment position or a temporary fixing position because of the threading engagement of the male thread at the fixing handle 43 with the female thread in the piece 45. In this case, the fixing handle 43 functions as a base abutment member as well as a fixing mechanism. Further, the table contact piece 45 is spaced away from the front wall 47, and the fixing handle 43 in threading engagement with the table contact piece 45 is pressed against the arcuate portion 16 because of the reaction force of the spring 46. In this condition, the relative position among the fixing handle 43, the table contact piece 45, and the arcuate portion 16 is fixed. However, the table contact piece 45 is not directly fixed to the frame 42, but is merely supported within the frame 42 by means of the spring 46. Therefore, as shown in FIG. 28, relative position between the frame 42 and the table contact piece 45 can be changed by rotating the adjustment screw 44 about its axis. In other words, the position of the frame 42 in the angular rotating direction of the turntable 21 relative to the fixing handle 43 and the table contact piece 45 can be finely adjusted, the fixing handle 43 having been immovable in the angular rotating direction because of the intimate contact of the tip end of the fixing handle 43 with the arcuate portion 16. The fine adjustment can be performed within a length of the front opening 42a in the angular rotating direction as shown in FIG. 28 through which the shaft portion 43A of the fixing handle 43 extends. In the depicted embodiment, plus minus 2 degrees are set in terms of the angular rotation amount of the turntable 21 for the fine adjustment.

In case of the fine adjustment, since the movement of the table contact piece 45 in the tangential direction is provided by the threading engagement between the second female thread 45b and the adjusting screw 44. Therefore, only a small moving amount results in spite of the rotation amount of the knob 44B. This facilitates the fine adjustment.

In this way, rotational position of the turntable 21 relative to the base 11 is roughly set, and then, the rotational position is temporarily fixed by the adjusting screw 43. Thereafter, fine adjustment is performed by the knob 44B. Consequently, intended rotational position of the turntable 21 can be promptly and accurately obtained.

Upon angular rotation of the turntable 21, the rotation amount detection unit 51 is moved relative to the outer gear teeth segment 20. This moving amount is converted into the rotation amount of the first gear set 56 including the first gear 56A. The rotation angle of the first gear set 56 is amplified at the second gear set 58 and the detected segment 60, such that the angular rotation of 1 degree of the turntable 21 will cause angular rotation of 72 degrees of the detected segment 60. Since the disc like detected element 60B is formed with 100 slits arrayed in a circumferential direction, 20 slits stand for 72 degrees. Further, the detected element 20B enables detection of a minimum angular rotation of 0.05 degrees for the turntable 21.

Furthermore, the miter saw 1 generates cutting chips during cutting operation. However, the components of the detection unit 51 including the first gear set 56 and the optical sensor 62 are housed in the sealed housing 52, entry of the cutting chips into the housing 52 can be prevented. Consequently, precise detection of angular rotation of the turntable 21 can result. Thus, the turntable 21 can be moved to a precise angular rotational position by the manipulation to the adjusting screw 44 while observing the angle display at the digital display 131.

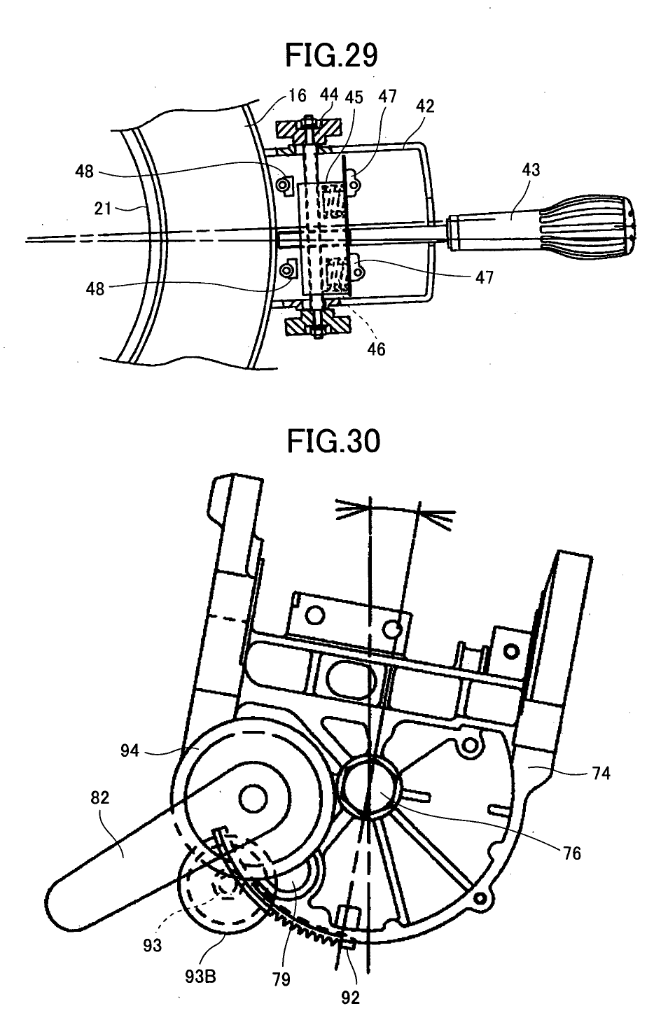

After the fine adjustment to the angular rotational position of the turntable 21, the fixing handle 43 is further clamped. As a result, the spring 46 is compressed, and as shown in FIG. 29, the table contact piece 45 is moved to its full fixing position where the table contact piece 45 is in abutment with the front wall 47 projecting from the frame 42. In this state, relative position between the frame 2 and the table contact piece 45 cannot be changed in spite of the rotation of the adjusting screw 44, since the table contact piece 45 is tightly pressed against the front wall 47. Accordingly, the displacement of the frame 42 relative to the arcuate portion 16 is prevented. (The arcuate portion 16 has been integrally with the table contact piece 45 through the fixing handle 43). Consequently, the displacement of the turntable 21 associated with the frame 42 relative to the base 11 associated with the arcuate portion 16 does not occur. Thus, the accurate angular rotating position of the turntable 21 can be promptly set and the set angle can be maintained for the angled cutting.

In this way the fine adjustment can be performed while the shaft portion 43A of the fixing handle 43 is in contact with the base 11 (at the temporary fixing position). Accordingly, during fine adjustment, accidental displacement between the base 11 and the turntable 21 due to shock or vibration can be prevented. This enhances accuracy in positioning the turntable 21 at a desired rotational angle position.

Next, if the cutting face on the workpiece is to be slanted with respect to the upper surface of the base 11 (hereinafter simply referred to as slant cutting), the circular saw unit 4 is slanted as shown in FIG. 4. As described above, the circular saw unit 4 is supported to the tilt section 74. The clamp shaft 81 is unfastened to release abutment between the slide wall 78 and the tilt motion support 71 so as to allow the tilt section 74 to be tiltable relative to the tilt motion support 71. Accordingly, the circular saw unit 4 becomes tiltable because of its own weight. With this state, the side surface of the circular saw blade 123 is slanted relative to the upper surface of the workpiece.

In the slant cutting at a desired tilting angle, the circular saw unit 4 is maintained at its desired tilting posture by operator's hand (FIG. 30). Then, the adjusting knob 94 is rotated to gradually pivotally move the tilt section 74 about an axis of the pin bolt 76.

By the pivotal movement of the tilt section 74, the tilt amount detection unit 101 is moved relative to the arcuate inner gear teeth 77. The moving amount of the unit 101 is converted into a rotation amount of the first gear 106A of the first gear set 106. The rotation angle of the first gear 106A is amplified at the second gear set 108 and the detected segment 110 such that the pivot angle of 1 degree of the tilt section 74 will cause angular rotation of 72 degrees of the detected segment 110. Since the disc like detected element 110B is formed with 100 slits arrayed in a circumferential direction, 20 slits stand for 72 degrees. Further, the detected element 110B enables detection of a minimum pivot angle of 0.05 degrees for the tilt section 74.

Furthermore, the miter saw 1 generates cutting chips during cutting operation. However, the components of the detection unit 101 including the first gear set 106 and the optical sensor 112 are housed in the sealed housing 102, entry of the cutting chips into the housing 102 can be prevented. Consequently, precise detection of pivot angle of the tilt section 74 can result. Thus, the tilt section 74 can be pivotally moved to a precise pivot position while observing the angle display at the digital display 131.

After the fine adjustment to the pivot position of the tilt section 74, the clamp shaft 81 is rotated by the clamp lever 82 so as to fix the tilt section 74 to the tilting motion support 71. As a result, the accurate tilting posture of the circular saw unit 4 can be promptly set and the set posture can be maintained for the slant cutting at the desired slant angle.

Next, a control routine for angle display at the digital display 131 will be described in case of the angled cutting and slant cutting. The detection of the angular rotation amount and the pivot angle can be made by an electrical power supplied from the battery box 132.

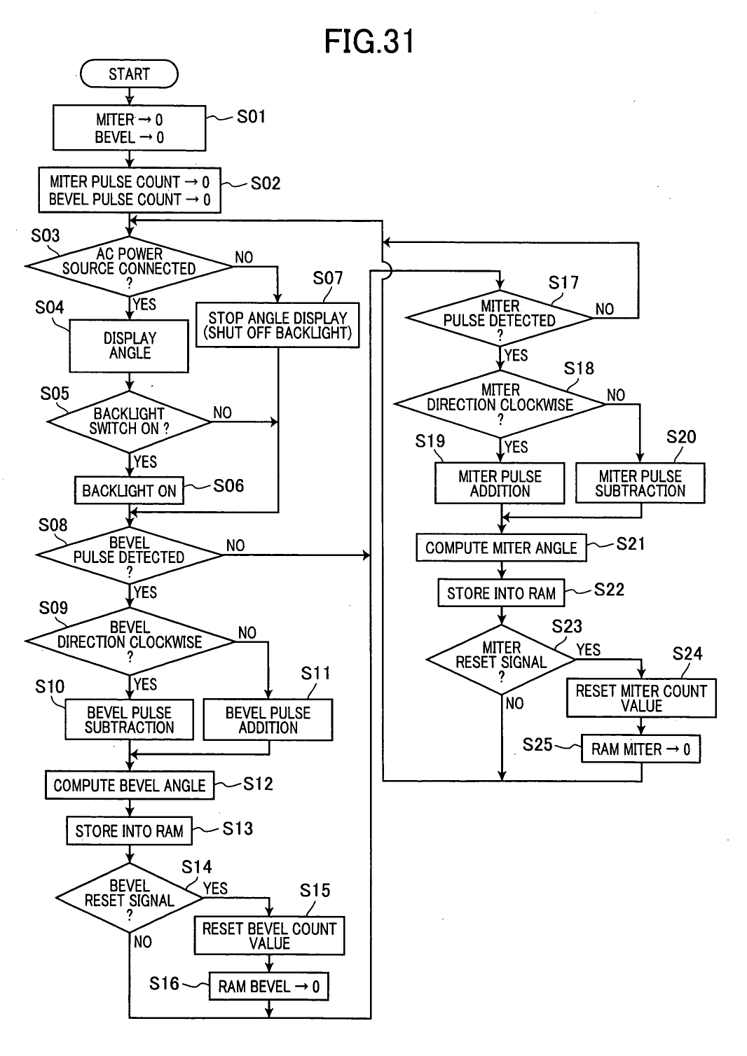

When a battery is assembled into the battery box 132, a control shown in FIG. 31 is started. Then, the angular rotation angle (Miter) and tilting angle (Bevel) held in a RAM are set to zero (S1). The RAM is a memory accommodated in the microcomputer 142. Then, the routine proceeds into S2 where optical pulse count value at the optical sensors 62 and 112 are set to zero.

Then, the microcomputer 142 performs detection as to the connection to AC power source (S03). If the AC power source has not been connected (S03:No), the routine proceeds into S7, where power supply to the digital display 131 is stopped to stop angle display, and the backlight is shut off if the backlight switch 150 had been turned ON for lighting the backlight, and then the routine goes into S08. On the other hand, if connection of AC power source is confirmed (S03:Yes), the routine is advanced into S04 where a predetermined angle (the above “0” degree) is displayed and the routine goes into S05. In S05, judgment is made as to whether or not the backlight switch 150 had been turned ON. If the backlight switch 150 has been rendered ON (S05:Yes), the backlight is turned ON (S06), and then the routine is proceeded into S08. If the backlight switch 150 had not been turned ON (S05:No), the routine proceeds into S08.

In S08, existence of optical pulse at the optical sensor 112 is detected. Non detection of the optical pulse (SO8;No) implies non-rotation of the detected segment 110 formed with the slits 110C, which implies that the tilt section 74 is not pivotally moved and thus the circular saw unit 4 is not tilted. Therefore, the routine is skipped into an angular rotation angle detection routine starting from S17 while neglecting the subsequent tilting angle detection routine from S09 to S16. On the other hand, if optical pulse is detected (SO8:Yes), the routine proceeds into S09.

In S09, tilting direction of the circular saw unit 4 is detected. If the circular saw unit 4 is tilted leftward as viewed from the front of the miter saw 1, that is, if the tilt section 74 is pivoted relative to the tilting motion support 71 in the counterclockwise direction (S09:No), the routine proceeds into S11 where the pulse numbers corresponding to the tilting angle are added. Then, the routine proceeds into S12 where an angle to be displayed on the digital display 131 is computed. On the other hand, if the circular saw unit 4 is tilted rightward as viewed from the front of the miter saw 1, that is, if the tilt section 74 is pivoted relative to the tilting motion support 71 in the clockwise direction (S09:Yes), the routine proceeds into S10 where the pulse numbers corresponding to the tilting angle are subtracted. Then, the routine proceeds into S12 where an angle to be displayed on the digital display 131 is computed. More specifically, addition or subtraction is made at every 0.05 degrees relative to the angle stored in the RAM in such a manner that detection of 20 pulses at the disc like detected element 110B amounts to the tilting angle of 1 degree. After the computation of the display angle in S12, the routine proceeds into S13 where the display angle is stored into the RAM.

Then, in S14, judgment is made as to whether or not the Bevel reset switch 149 is turned ON. The Bevel reset switch 149 is adapted for resetting the tilting angle up to S13 to zero. If the Bevel reset switch 149 is not turned ON (S14:No), the routine proceeds into S17 in order to start angular rotation angle display routine. On the other hand, if the Bevel reset switch 149 is turned ON (S14:Yes), the routine proceeds into S15 where the optical pulse count value is set to zero, and then the value stored in the RAM is cleared to zero in S16. Then, the routine proceeds into S17.

S17 through S25 pertain to process for angular rotation amount display for the turntable 21. In S17, existence of optical pulse at the optical sensor 62 is detected. Non detection of the optical pulse (S17;No) implies non-rotation of the detected segment 60 formed with the slits 60C, which implies that the turntable 21 is not angularly rotated. Therefore, the routine is returned back to S03 neglecting the subsequent angular rotation amount display routine from S18 to S25. On the other hand, if optical pulse is detected (S17:Yes), the routine proceeds into S18.

In S18, angular rotating direction of the turntable 21 is detected. If the turntable 21 is rotated in counterclockwise direction as viewed from the top of the miter saw 1 (S18:No), the routine proceeds into S20 where the pulse numbers corresponding to the rotation amount are subtracted. Then, the routine proceeds into S21 where a rotation angle to be displayed on the digital display 131 is computed. On the other hand, if the turntable 21 is rotated in the clockwise direction as viewed from the top of the miter saw 1, (S18:Yes), the routine proceeds into S19 where the pulse numbers corresponding to the rotation amount are added. Then, the routine proceeds into S21 where an angle to be displayed on the digital display 131 is computed. More specifically, addition or subtraction is made at every 0.05 degrees relative to the angle stored in the RAM in such a manner that detection of 20 pulses at the disc like detected element 60B amounts to the rotation angle of 1 degree. After the computation of the display angle in S21, the routine proceeds into S22 where the display angle is stored into the RAM.

Then, in S23, judgment is made as to whether or not the Miter reset switch 148 is turned ON. The Miter reset switch 148 is adapted for resetting the rotation angle up to S22 to zero. If the Miter reset switch 148 is not turned ON (S23:No), the routine proceeds into S03 in order to repeat the above described processing routine. On the other hand, if the Miter reset switch 148 is turned ON (S23:Yes), the routine proceeds into S24 where the optical pulse count value is set to zero, and then the value stored in the RAM is cleared to zero in S25. Then, the routine proceeds into S03 to repeat the above-described processing routine.

Incidentally, the process from S17 to S25 for the rotation angle displaying routine can be executed prior to the process from S08 to S16 for the pivot angle displaying routine. Alternatively, consequential steps S08 to S16 and another consequential steps S17 to S25 can be performed almost simultaneously through a multi-task processing.

The above-described processing is always executed as long as an electric power is supplied from the battery box 132 even if a main AC power source is not connected, and therefore, angular rotation amount of the turntable 21 and the tilting angle of the circular saw unit 4 can be always recognized. That is, those angles in the former cutting operation can be maintained. In other words, the miter saw 1 can be promptly operated without initial adjustment of the rotation angle and the tilting angle when the AC power source is connected if these angles for the former cutting operation is still available for the subsequent cutting operation. Further, an electric power level supplied from the battery box 132 is dependent on the power storage amount in the battery in the battery box 132. If the storage amount becomes vacant, the power supply will be stopped. In order to avoid this problem, a control can be made to shut off the power supply from the battery box 132 and to start power supply from the AC power source to the control circuit when the AC power source is connected. This control can also be made to start power supply from the battery box 132 if the AC power source is then disconnected.

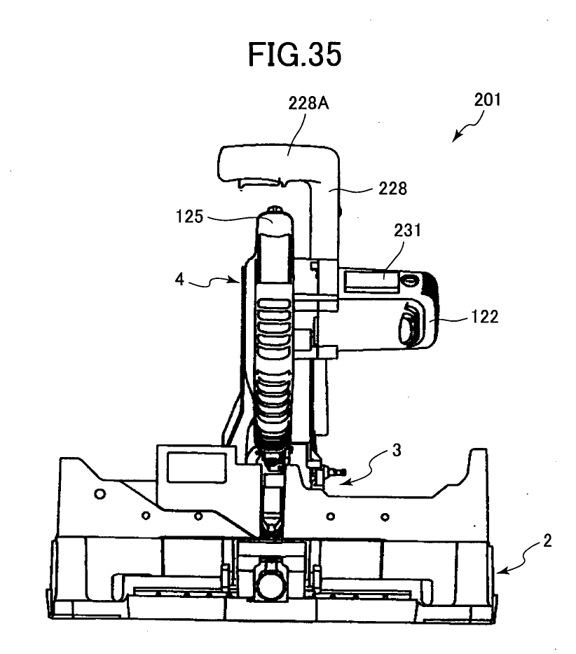

A miter saw according to a second embodiment of the present invention is shown in FIG. 35. In the miter saw 201, a handle 228 extends from the motor housing 122 similar to the first embodiment. However, a handle grip 228A is not positioned above a digital display 231, but is positioned immediately above the saw cover 125. Therefore, when the user grips the handle grip 228A, the digital display 231 is always visible without being hidden by the handle grip 228A regardless of any pivot position of the circular saw unit 4. Thus, the user can always easily recognize the angular rotation angle and the tilting angle.

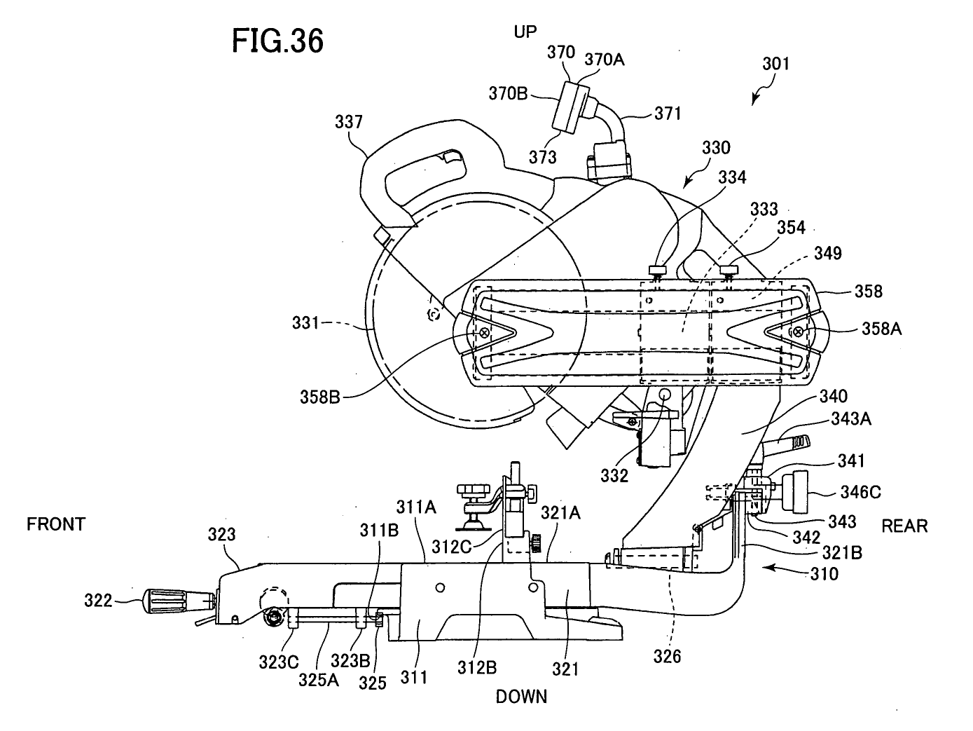

A miter saw according to a third embodiment of the present invention will be described with reference to FIGS. 36 through 54.

As shown in FIG. 36, a miter saw 301 has a base section 310, a circular saw unit 330, and a holder 340. The base section 310 is adapted to mount thereon a workpiece such as a wood block having a rectangular cross-section. The circular saw unit 330 includes a motor (not shown) serving as a drive source and a circular saw blade 331 rotationally driven by the motor. The holder 340 is laterally tiltably supported to the base section 310 and pivotally movably supports the circular saw unit 330 at a position above the base section 310. The circular saw unit 330 is movable toward and away from the base section 310.

The base section 310 includes a base 311 installed on a floor or a stand, and a turntable 321 rotatably supported to the base 311 in a horizontal plane. The turntable 321 has a generally circular shape in a plan view. The base 311 has an upper surface 311A, and the turntable 321 has an upper surface 321A in flush with the upper surface 311A. The workpiece (not shown) is mounted on the upper surfaces 311A and 321A and is subjected to cutting by the circular saw blade 331.

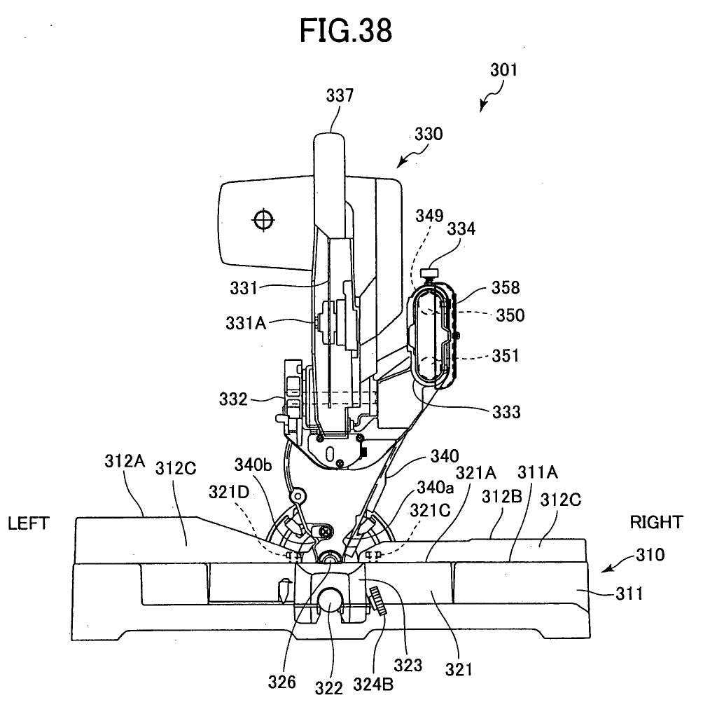

An arcuate section (not shown) is provided integrally with the base 311. The curvature of the arcuate section is in conformance with a rotating direction of the turntable 321. Further, a left fence 312A and a right fence 312B (FIG. 38) protrude in a direction perpendicular to the upper surface 311A of the base 311. These fences 312A and 312B have abutment surfaces 312C facing frontward. Abutment relation is maintained between one surface of the worpiece and the abutment surface 312C so as to stably support the workpiece to stabilize the cutting operation.

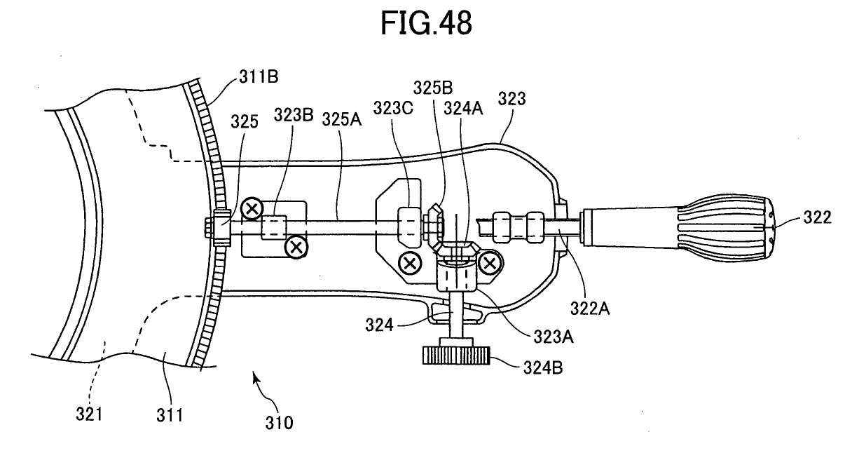

As shown in FIG. 48, a frame 323 extends radially outwardly from the turntable 321. The frame 323 has a knob shaft support section (not shown) where a female thread hole is formed. A knob shaft 322A is rotatably supported to the frame 323, and extends in a radial direction of the turntable 321. The knob shaft 322A has a male thread threadingly engaged with the female thread hole. The knob shaft 322A has an outer end provided with a knob 322 extending in a direction parallel with the upper surfaces 311A, 321A of the base 11 and turntable 321. The knob 322 extends radially outwardly from the turntable 321. Upon rotation of the knob 322 about its axis, the knob 322 and the knob shaft 322A are moved in their axial direction and in the radial direction of the turntable 321 relative to the frame 323.

By moving the knob 322 radially inwardly of the turntable 321, an inner end of the knob shaft 322A is pressingly abuttable against the arcuate section of the base 311 whereupon a free rotation of the turntable 321 about its rotation axis is prevented. By reversely rotating the knob 322 about its axis so as to release the inner end of the knob shaft 322A from the arcuate section, the turntable 321 becomes rotatable about its rotation axis. For rotating the turntable 321 about its rotation axis, the user grips the knob 322 and moves in the circumferential direction of the turntable 321. Thus, the knob 322, frame 323 and turntable 321 are moved together.

A rotation angle fine adjustment mechanism for finely adjusting angular rotational position of the turntable 321 is provided at the base section 310. As shown in FIG. 48, the rotation angle fine adjustment mechanism includes an engagement section 311B, a knob 324 and a pinion 325. The engagement section 311B is in the form of a rack and is disposed at the lower end face of the base 311 and extends along the rotational direction of the turntable 321. The engagement section 311B is provided integrally with the base 311. The knob 324 is rotatably supported to the frame 323 of the turntable 321 through a bearing 323A. The knob 324 includes an inner bevel gear 324A and an outer knob section 324B.

The pinion 325 is rotatably supported to the frame 323 of the turntable 321. More specifically, a pinion shaft 325A extends in the radial direction of the turntable 321, and is rotatably supported to the frame 323 through a pair of bearings 323B and 323C. Thus, a rotation axis of the pinion shaft 325A is positioned at a given position. The pinion shaft 325A has one end fixedly and coaxially provided with the pinion 325, and has another end fixedly and coaxially provided with a bevel gear 325B. The knob 324 has a knob shaft extending in a direction perpendicular to the pinion shaft 325A. The bevel gear 325B of the pinion shaft 325A is in continuous meshing engagement with the bevel gear 324A of the knob 324. Therefore, the rotation of the knob section 324B causes rotation of the pinion 325, and vice versa.

The pinion 325 is in continuous meshing engagement with the engagement section 311B. Therefore, by rotating the knob section 324B, the pinion 325 and pinion shaft 325A are integrally rotated. However, since the engagement section 311B is stationary because of the part of the base 311, the turntable 321 is rotated about its axis by the rotation of the pinion 325. The knob 324 is always rotated in synchronism with the rotation of the turntable 321 relative to the base 311. In other words, rotation angle of the turntable 321 can be finely adjusted by rotating the knob 324.

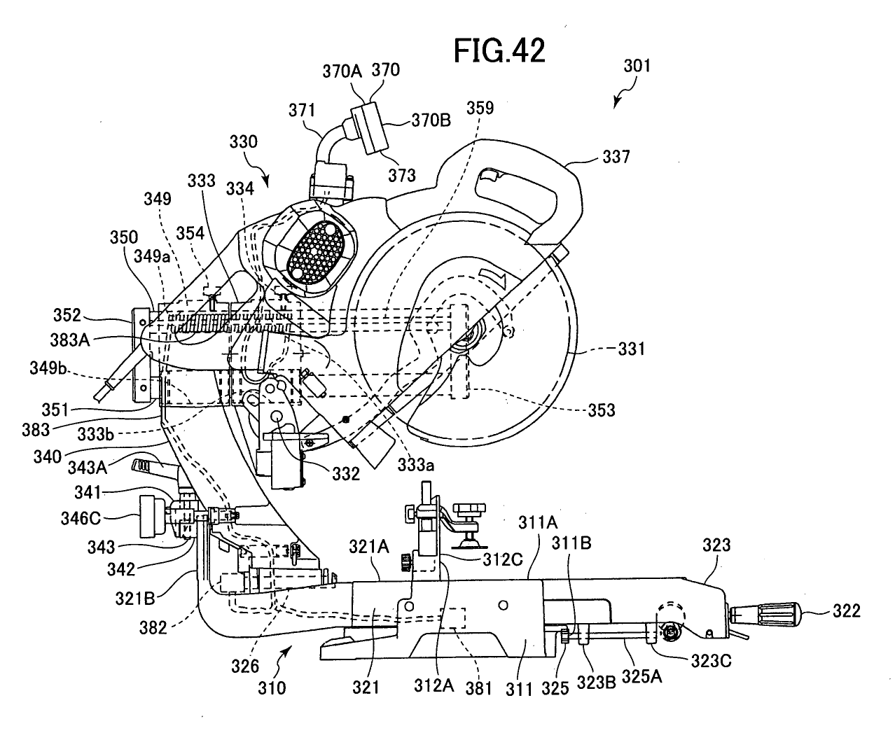

A rotation amount detection unit 381 such as a potentiometer is provided at the base section 310 (FIG. 42) at a position in alignment with the rotation axis of the turntable 321. The rotation amount detection unit 381 has a main body frame (not shown) and a rotation shaft (not shown) rotatable relative to the main body frame. The rotation shaft has one end fixed to the base 311. The rotation amount detection unit 381 is rotatable in response to the rotation of the turntable 321 relative to the base 311, so that electric voltage level output from the rotation amount detection unit 381 into a microcomputer (described later) is linearly changed. In this way, rotation amount of the turntable 321 is detectable by the rotation amount detection unit 381 based on the linear change of the voltage level.

As shown in FIG. 36, the holder 340 has a holder 340 extending from a rear side of the turntable 321 and movable together with the rotational movement of the turntable 321. A holder shaft 326 extends in frontward/rearward direction of the miter saw 301, and is fixed to the turntable 321. The holder 340 is laterally tiltably supported to the turntable 321 through the holder shaft 326 (see FIG. 38 Since the circular saw unit 330 is supported to the holder 340 tilting angle of the holder 340 relative to the upper surface 321A of the turntable 321 is coincident with a tilting angle of a side surface of the circular saw blade 331 relative to the upper surface 321A. Lateral tilting posture of the holder 340 can be fixed by a clamp mechanism described below.

As shown in FIG. 36, an upstanding portion 321B vertically and integrally extends from the rear end of the turntable 321. A projecting portion 341 integrally extends rearward from a rear side of the holder 340. The projecting portion 341 extends over the upper end of the upstanding portion 321B. A slider 342 having a wedge shape is movably disposed between the upstanding portion 321B of the turntable 321 and the projecting portion 341 of the holder 340. A clamp bolt 343 vertically extends through the projecting portion 341 and is threadingly engaged with the slider 342. The clamp bolt 343 has an upper end integrally provided with a clamp lever 343A. A spring (not shown) is provided for urging the slider 342 downward, i.e., toward unclamping position of the slider 342.

By rotating the clamp lever 343A in a unfastening direction, the clamp bolt 343 is rotated about its axis together with the clamp lever 343A so that the slider 342 is moved downward. Therefore clamping force of the slider 342 against the holder 340 is released, so that the holder 340 becomes laterally tiltable about the axis of the holder shaft 326. On the other hand, by rotating the clamp lever 343A in a fastening direction, the clamp bolt 343 is rotated in the opposite direction so that the slider 342 is moved upward against the biasing force of the spring. Therefore, the slider 342 is pressingly interposed between the upstanding portion 321B and the projecting portion 341. Thus, the slider 342 presses the projecting portion 341 rearward by way of a wedge effect. Thus, tilting motion of the holder 340 is prevented. The holder 340 is maintained at a desired tilting angle.

As shown in FIG. 38, a pair of stop notches 340′, 340b is formed at the holder 340 at a position near the base section 310 for regulating the lateral tilting movement of the holder 340. Further, a pair of stop bolts 321C, 321D vertically extends from the upper surface 321A of the turntable 321 at a position in alignment with a locus of the stop notches 340′, 340b. The pair of stop bolts 321C, 321D are threadingly engaged with the turntable 321, so that the vertical height of each head of each bolt is adjustable.

When the holder 340 and the circular saw unit 330 are laterally tilted about the axis of the holder shaft 326, one of the stop notches 340′ and 340b is brought into abutment with one of the stop bolt 321C and 321D to prevent the holder 340 from being further tiltingly moved.

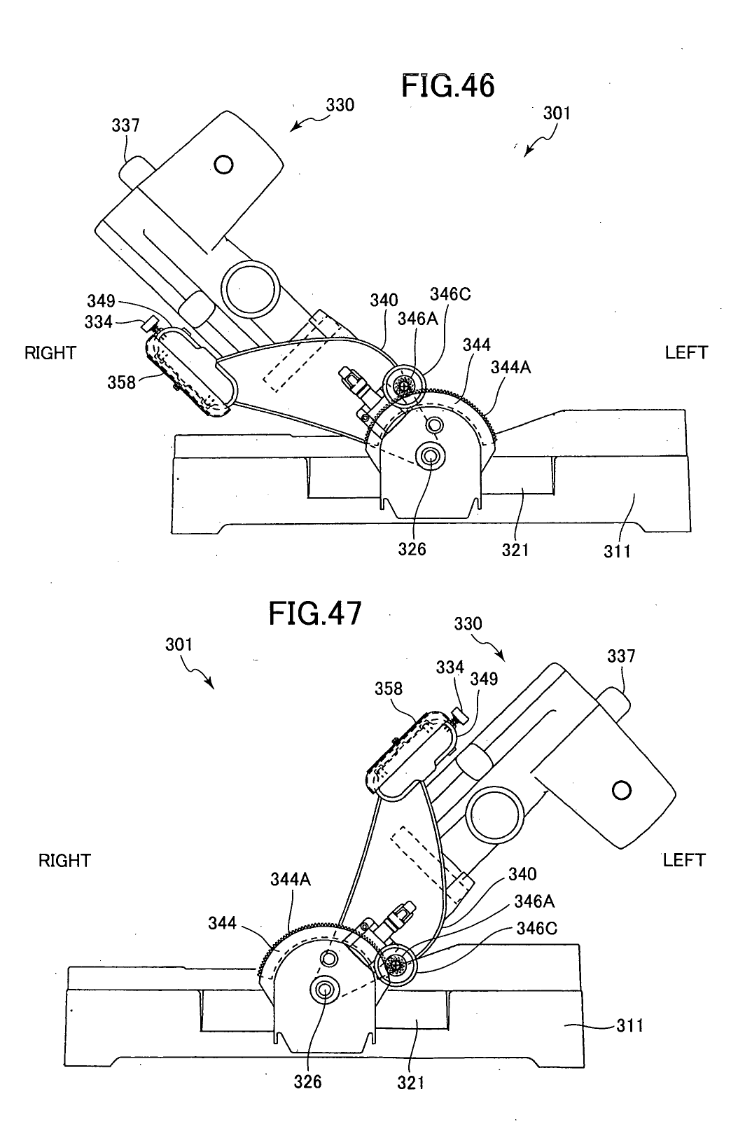

More specifically, an uppermost end position of each head of the stop bolt 321C, 321D is adjusted in such a manner that the stop notch 340′ is brought into abutment with the stop bolt 321C when the holder 340 is rightwardly tilted at a maximum tilting angle of 345 degrees as shown in FIG. 47 and the stop notch 340b is brought into abutment with the stop bolt 321D when the holder 340 is leftwardly tilted at a maximum tilting angle of 345 degrees as shown in FIG. 46.

A tilting amount detection unit 382 such as a potentiometer is provided at the turntable 321 (FIG. 42) at a position adjacent to one end of the holder shaft 326 and in alignment with the rotation axis of the holder shaft 326. The tilting amount detection unit 382 has a main body frame (not shown) fixed to the holder 340 and a rotation shaft (not shown) rotatable relative to the main body frame and fixed to the holder shaft 326 which is rotatable about its axis relative to the holder 340. The rotation shaft of the tilting amount detection unit 382 is rotated relative to the holder 340 in response to the tilting motion of the holder 340 relative to the turntable 321 about the axis of the holder shaft 326, so that electric voltage level output from the tilting amount detection unit 382 into the microcomputer (described later) is linearly changed. In this way, tilting amount of the holder 340 relative to the upper surface 321A of the turntable 321 is detectable by the tilting amount detection unit 382 based on the linear change of the voltage level.

As shown in FIG. 45, the upstanding portion 321B and the holder 340 have flat first confronting surfaces 321E and second confronting surface 341A confronting to each other, respectively. The turntable 321 and the holder 340 are made from aluminum or aluminum alloy, and therefore, the first and second confronting surfaces 321E, 341A are made from the aluminum or aluminum alloy.

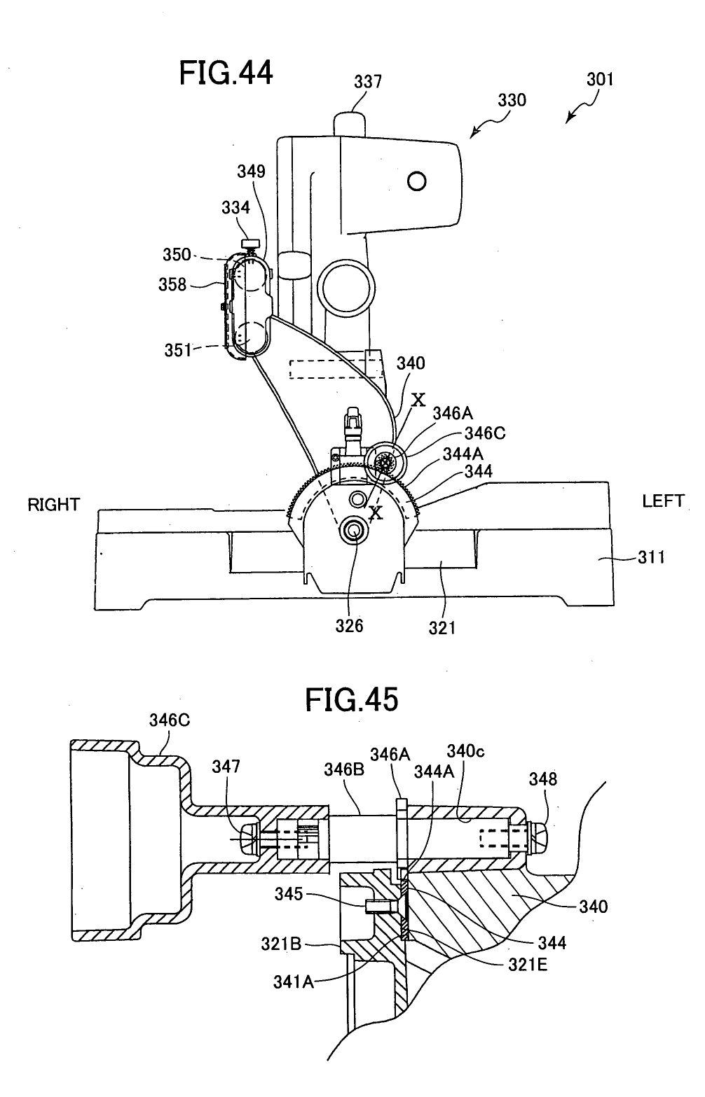

As shown in FIGS. 44, 46 and 47, a plate like engagement member 344 made from an iron is fixed to the first confronting surfaces 321E through a screw 345(FIG. 45). An upper end of the engagement member 344 has an arcuate configuration in a tilting direction of the second confronting surface 41A in accordance with the tilting motion of the holder 340. The upper end of the engagement member 344 has an engagement teeth 344A. The second confronting surface 341A is in sliding contact with the engagement teeth 344A in accordance with the tilting motion of the holder 340. However, since the engagement teeth 344A is made from iron, surface roughening due to direct sliding contact between aluminum members i.e., between the aluminum surfaces 321E and 344A can be prevented, and sliding movement of the second confronting surface 341A relative to the engagement member 344 can be smoothly performed. The engagement member 344 has a thickness of about 2 mm.

As shown in FIGS. 44 and 45, a pinion 346A, a knob 346C and a shaft 346B are provided at a left side of the holder 340 at a position near the second confronting surface 341A. The shaft 346B has one end coaxially fixing the pinion 346A so as to be rotatable together with the pinion 346A. The shaft 346B has another end coaxially fixed with the knob 346C by a screw 347 so as to be rotatable together with the know 346C. A hole 340c extending in the frontward/rearward direction is formed in the holder 340 at a left side thereof. The shaft 346B extends through the hole 340c and is rotatably supported to the holder 340 by a screw 348. The pinion 346A is in continuous meshing engagement with the engagement teeth 344A. Therefore, the knob 346C is rotated about its axis in response to the tilting motion of the holder 340 together with the circular saw unit 330. Reversely, tilting angle o the holder 340 and the circular saw unit 330 relative to the turntable 321 can be finely adjusted by rotating the knob 346C. That is, the rotation of the knob 346C causes integral rotation of the pinion 346A, so that the holder 340 is tiltingly moved about the holder shaft 326 because of the meshing engagement between the pinion 346A and the engagement teeth 344A.

Further, since the pinion 346A, shaft 46B and knob 346C are coaxially and integrally rotated with each other, a simple fine adjustment mechanism can result.

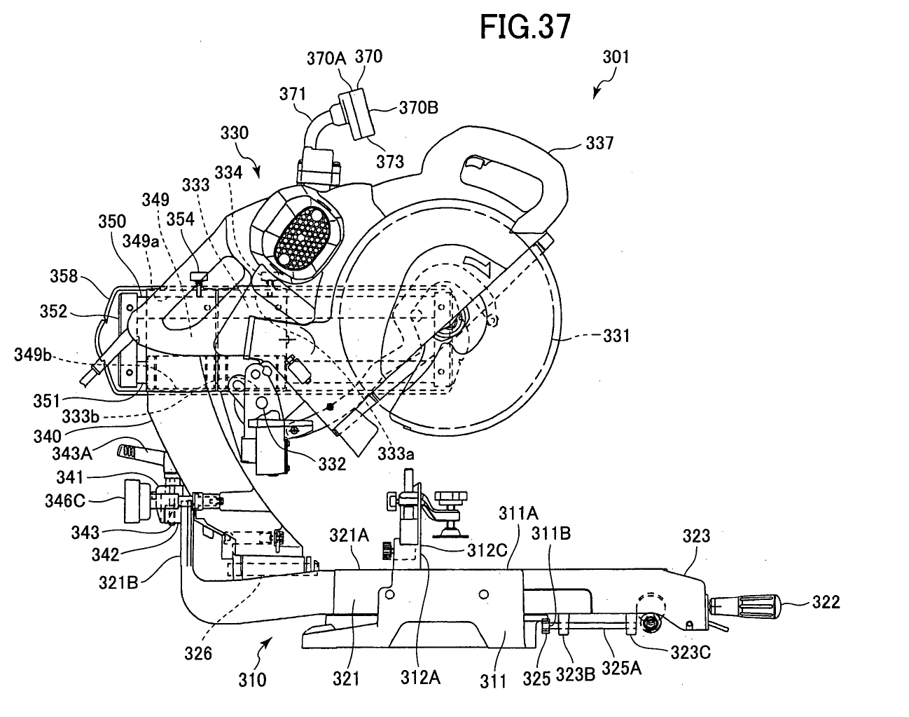

As shown in FIG. 38, the holder 340 extends rightward and upward from the lateral center of the miter saw 301, and serves as a first support section. A first slide support portion 349 is provided at an upper free end of the holder 340. As shown in FIGS. 37, 49 and 50, a pair of through-holes 349a, 349b extending in frontward/rearward direction are formed in the first slide support portion 349. As shown in FIG. 50, the through holes 349a, 349b have generally circular cross-section through which hollow pipes 350, 351 extend.

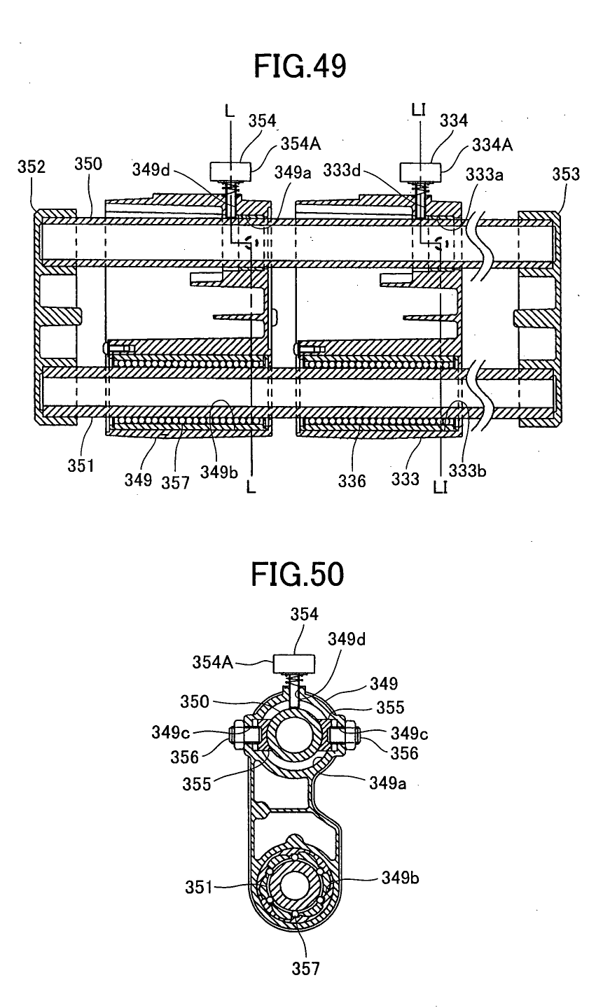

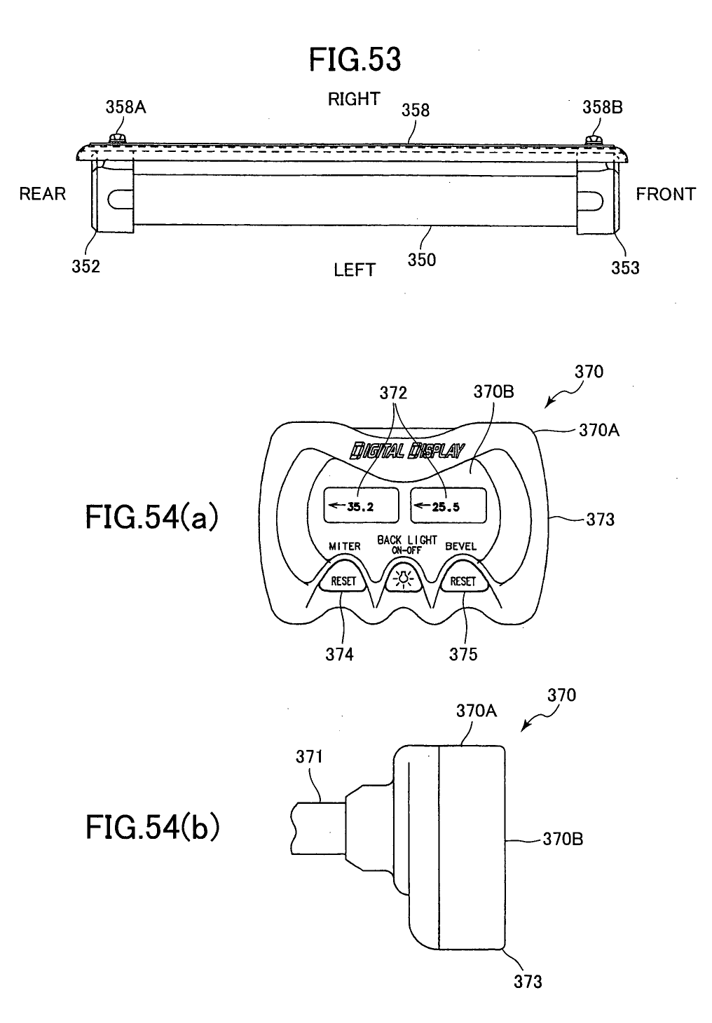

As shown in FIGS. 49 and 53, one end (front end) of each of the pipes 350, 351 is covered with and held by a second end holding member 353 (described later) and another end (rear end) of each of the pipes 350, 351 is covered with and held by a first end holding member 352, so that two pipes 350, 351 extend in parallel with each other. An imaginary plane containing axes of the pipes 350, 351 extends perpendicular to a pivot shaft 32 extending in the lateral direction (FIG. 38) about which the circular saw unit 330 is pivotally movable. Front end portions of the pipes 350, 351 extend through through-holes 333a, 333b of a second slide support 333 (described later), and rear end portions of the pipes 350, 351 extend through the through-holes 349a, 349b of the first slide support portion 349.

An outer diameter of the pipes 350, 351 is smaller than an inner diameter of the through holes 349a, 349b, so that the pipes 350, 351 are slidable in their axial direction relative to the through holes 349a, 349b. The sliding direction of the pipes is substantially perpendicular to the axial direction of the pivot shaft 332. The circular saw unit 330 is supported to the pipes 350, 351 through the second slide support 333. A combination of the holder 340, the pipes 350, 351, the first slide support portion 349 and the second slide support 333 functions as a support section for supporting the circular saw unit 330.

In other words, the one end portion of the pair of pipes 350, 351 supports the circular saw unit 330, and the other end potion thereof is slidably supported by the first slide support portion 349. Since the through holes 349a and 349b are aligned in a vertical direction, the imaginary plane containing the axes of the pipes 350, 351 extends in parallel with the pivotally moving direction of the circular saw unit 330. Since the pair of pipes 350, 351 are slidable relative to the first slide support portion 349, the circular saw blade 331 is movable in a direction perpendicular to the axial direction of the pivot shaft 332.

As shown in FIG. 50, the first slide support portion 349 is formed with a pair of screw holes 349c extending in a diametrical direction of the through-hole 349a in a direction parallel with the pivot shaft 332 of the circular saw unit 330. Further, a screw hole 349d is formed in a vertical direction and at the uppermost position of the first slide support portion 349. That is, the extending direction is perpendicular to the pivot shaft 332 and on the imaginary plane containing the axes of the pair of pipes 350, 351. These screw holes 349c, 349d are formed with female threads. A first screw 354 is threadingly engaged with the screw hole 349d.

One end of the first screw 354 is provided with a first knob 354A. The first screw 354 is moved in its axial direction in the imaginary plane containing the axes of the pipes 350, 351 and in a direction perpendicular to the pivot shaft 332 by manually rotating the knob 354A. Another end of the first screw 354 is abuttable on the pipe 350 and in the through-hole 349a as shown in FIG. 50. Sliding movement of the pipe 350 relative to the first slide support portion 349 is prevented by the pressure contact of the first screw 354 against the pipe 350.

A pair of bolts 356, 356 are threadingly engaged with the screw holes 349c, 349c, and a pair of slide pieces 355, 355 are held at inner ends of the bolts 356, 356 at a position between the first slide support portion 349 and the pipe 350 as shown in FIG. 50. Positions of the slide pieces 355, 355 in the radial direction of the through-hole 349a are adjustable by rotating the bolts 356, so that position of the pipe 350 relative to the through-hole 349a is adjustable. Consequently, a tilting angle of the circular saw blade 331 relative to the upper surface 321A of the turntable 321 is finely adjustable.

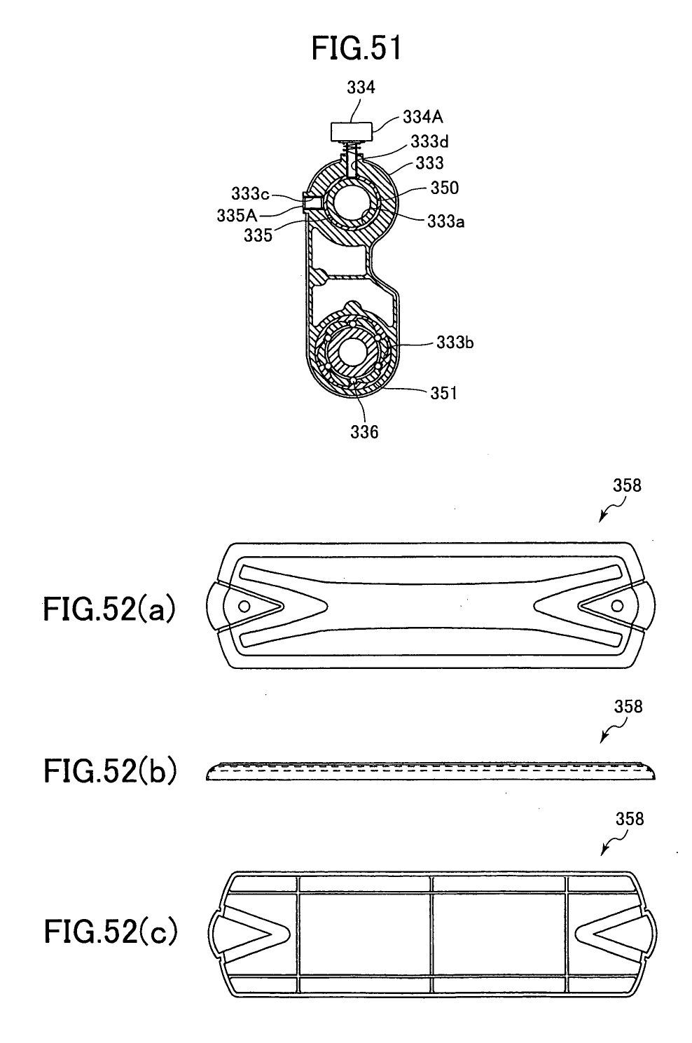

For example, if the slide pieces 355, 355 are moved leftward in FIG. 50 by rotating the bolt 356, 356, the second slide support 333 is tilted leftward in FIG. 38 about the axis of the pipe 351 (leftward in FIG. 51). Accordingly, the circular saw unit 330 supported on the second slide support 333 is tilted leftward about the axis of the pipe 351.

As shown in FIG. 50 a ball bearing 357 is disposed in the through-hole 349b and between the first slide support portion 349 and the pipe 351. The ball bearing 357 is adapted for smoothening the sliding movement of the pipe 351 relative to the first slide support portion 349, and for preventing the pipe 351 from being moved in the radial direction of the through-hole 349b.

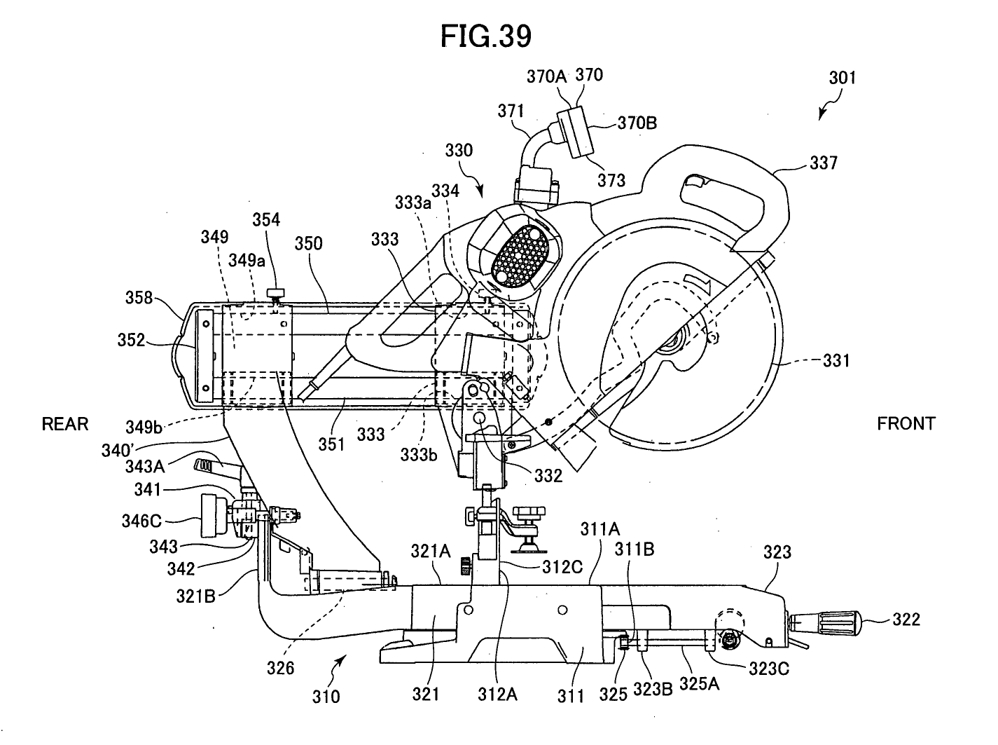

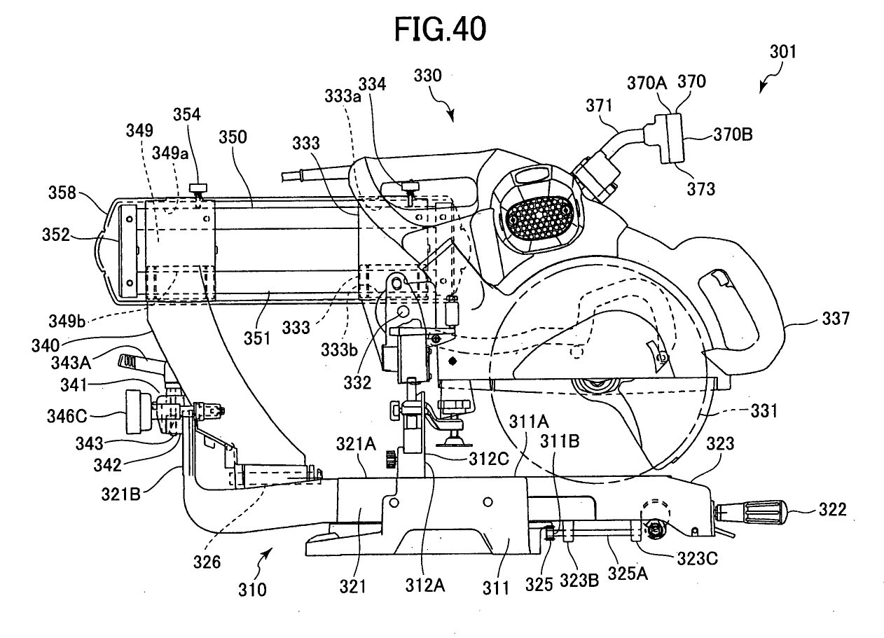

As shown in FIGS. 39 and 40, the circular saw unit 330 includes the pivot shaft 332 extending in a direction parallel with a rotation shaft 331A (FIG. 38) of the circular saw blade 331. The circular saw unit 330 has a rear end provided with the second slide support 333 serving as a second support section, and a front end provided with the circular saw blade 331. As shown in FIGS. 37, 49 and 51, the second slide support 333 is formed with a pair of through-holes 333a, 333b extending in frontward/rearward direction similar to the first slide support portion 349.

As shown in FIG. 5l, the through holes 333a, 333b have generally circular cross-section through which hollow pipes 350, 351 extend. The outer diameter of the pipes 350, 351 is smaller than an inner diameter of the through holes 333a, 333b, so that the pipes 350, 351 are slidable in their axial direction relative to the through holes 333a, 333b. The sliding direction of the pipes is substantially perpendicular to the axial direction of the pivot shaft 332.

The pair of pipes 350, 351 supports at their front end portion the circular saw unit 330 through the second slide support 333. Since the through holes 333a and 333b are aligned in a vertical direction, the imaginary plane containing the axes of the pipes 350, 351 extends in parallel with the pivotally moving direction of the circular saw unit 330. Since the second slide support 333 is slidable relative to the pair of pipes 350, 351, the circular saw blade 331 is movable in the frontward/rearward direction, i.e., in a direction perpendicular to the axial direction of the pivot shaft 332.

A screw hole 333c is provided at a left side (FIG. 51) of the second slide support 333 and extends in a radial direction of the through-hole 333a in a direction parallel with the pivot shaft 332. Further, a screw hole 333d is formed in a vertical direction and at the uppermost position of the second slide support 333. That is, the extending direction is perpendicular to the pivot shaft 332 and on the imaginary plane containing the axes of the pair of pipes 350, 351.

These screw holes 333c, 333d are formed with female threads. A second screw 334 is threadingly engaged with the screw hole 333d. One end of the second screw 334 is provided with a second knob 334A. The second screw 334 is moved in its axial direction in the imaginary plane containing the axes of the pipes 350, 351 and in a direction perpendicular to the pivot shaft 332 by manually rotating the second knob 334A. Another end of the second screw 334 is abuttable on the pipe 350 and in the through-hole 333a as shown in FIG. 51. Sliding movement of the second slide support portion 333 relative to the pipe 350 is prevented by the pressure contact of the second screw 334 against the pipe 350.

As shown in FIG. 51, a slide bearing ring 335 is fitted in the through-hole 333a and between the second slide support 333 and the pipe 350. The slide bearing ring 335 is held to the second slide support 333 by a screw 335A threadingly engaged with the screw hole 333c. Thus, the pipe 350 is immovable in the radial direction of the through-hole 333a because of the slide bearing ring 335. Further, a ball bearing 336 is fitted between the through-hole 333b and the pipe 351 for smoothening axial sliding movement of the pipe 351 relative to the second slide support 333 and for preventing the pipe 351 from moving in the radial direction of the through-hole 333b.

In this way, in the second slide support 333, the pipes 350, 351 are immovable in the radial direction of the through-holes 333a, 333b, and further, in the first slide support portion 349 the pipe 351 is immovable in the radial direction of the through-hole 349b whereas the the pipe 350 is movable in the radial direction of the through-hole 349a. With this arrangement, the lateral position of the pipe 350 within the through-hole 349a is adjustable by adjusting the lateral positions of the slide pieces 355, 355 upon rotation of the bolts 356, 356, so that the second slide support 333 is tiltable about the axis of the pipe 351, whereupon fine adjustment is achievable with respect to the tilting angle of the circular saw blade 331 relative to the upper surface 321A of the turntable 321.

Further, the pipe 350 may be deformed by the pressure applied from the first and second screws 354, 334. Here, the deforming direction of the pipe 350 is coincident with the pivotally moving direction of the circular saw blade 331 toward and away from the turntable 321, i.e., in the direction perpendicular to the pivot shaft 332. As a result, the deformation of the pipe 350 does not affect vertical orientation of the circular saw blade 331 relative to the upper surface 321A of the turntable 321, that is, the deformation of the pipe 350 does not lower the orientation of the circular saw blade 331. Moreover, components for fixing the relative position between the pipe 350 and the first slide support portion 349 and second slide support 333 are of simple structure such as the first and second screws 354, 334.

As shown in FIGS. 36, 52 and 53, a generally plate like cover 358 is spanned between the first end holding member 352 and second end holding member 353 (FIG. 49) those holding each end of he pipes 350, 351. As shown in FIGS. 38 and 53, the cover 358 is positioned at right side of the pair of pipes 350, 351, and in parallel with the imaginary plane containing the axes of the pipes 350, 351. A rear end of the cover 358 is fixed to the first end holding member 352 by a screw 358A, and a front end of the cover 358 is fixed to the second end holding member 353 by a screw 358B. Incidentally, an upper side of FIG. 53 corresponds to right side in FIG. 38. A right side surface of the cover 358 has a relatively large area for the sufficient visibility to a name of a manufacturer and a sales message drawn on the side surface.

Since the cover 358 is attached to the right side of the pair of pipes 350, 351 installed at an outer side of the miter saw 301, the cover 358 prevents an ambient article from being bumped against the pair of pipes 350, 351 to protect the same. Further, the cover 358 can prevent the user from being touched to the pipes 350, 351. This arrangement is advantageous if a lubricant is coated over the pipes 350, 351. Incidentally, the cover 358 is omitted in FIGS. 42, 43, 49, 50 and 51 for the purpose of simplicity.

In the circular saw unit 330, the circular saw blade 331 is rotatable about an axis of the rotation shaft 331A (FIG. 38). A handle 337 is disposed at the upper region of the circular saw unit 330 (FIG. 36), so that the user can pivotally move the circular saw unit 330 about the pivot shaft 332 while gripping the handle 337. A return spring (not shown) is provided for normally urging the circular saw unit 330 upward.

If the circular saw unit 330 is not pressed downward during non-operational phase of the miter saw 301, the circular saw unit 330 is at its uppermost position as shown in FIGS. 36 and 37 by a stop mechanism (not shown). The circular saw unit 330 is provided with a power supply (not shown) and a motor (not shown). Electric power is supplied to the motor from the power supply for rotating the circular saw blade 331.

As shown in FIG. 36, a display unit 370 is provided at the upper portion of the circular saw unit 330 and behind the handle 337. A flexible arm 371 has one end extending from the circular saw unit 330 and another end supporting the display unit 370. Therefore, the display unit 370 is movable in the frontward/rearward direction, leftward/rightward, and upward/downward relative to the circular saw unit 330 because of the universal deformation of the flexible arm 371.

As shown in FIGS. 54(a) and 54(b), the display unit 370 includes an outer frame 370A in which a display body 373 and a substrate (not shown) are accommodated. The substrate mounts thereon a microcomputer (not shown) and a storage unit (not shown). The display body 373 has display surfaces 372 such as a liquid crystal display. The microcomputer is adapted to receive signals from the rotation amount detection unit 381 and the tilting amount detection unit 382, compute angular rotation angle and tilting angle based on these signals, and output a display signal to the display body 373 so as to display the angular rotation angle and the tilting angle at the display surfaces 372. The storage unit is adapted to store the angular rotation angle and the tilting angle those computed by the microcomputer. As shown in FIG. 54(a), two display surfaces 372 are arrayed in line. The display surfaces 372 are covered by a transparent cover 370B serving as a part of the outer frame 370A. An orientation of a normal line of the display surface 372 is changeable, since the orientation of the display unit 370 is changeable universally by the deformation of the flexible arm 371.

BEVEL indicative of the angular rotation angle of the turntable 321 and MITER indicative of the tilting angle of the circular saw blade 331 are printed on the outer frame 370A at positions adjacent to the display surfaces 372 as shown in FIG. 54(a). Therefore, additional display indicating the angular rotation angle and the tilting angle are not required in the display surfaces 372 in order to distinguish these angles from each other. Thus, only the angular rotation angle and the tilting angle are displayed in line. This means that a compact display body 373 results.

Further, two reset buttons 374, 375 serving as reset switches are provided on the outer frame 370A at positions adjacent to the display surfaces 372. These reset buttons 374, 375 are adapted for resetting the angular rotation angle and the tilting angle independently of each other displayed on the display surfaces 372. If the reset buttons 374, 375 are pushed, the reset switches are rendered ON to output reset signals to the microcomputer. Thus, the microcomputer changes the displayed angles to zero.

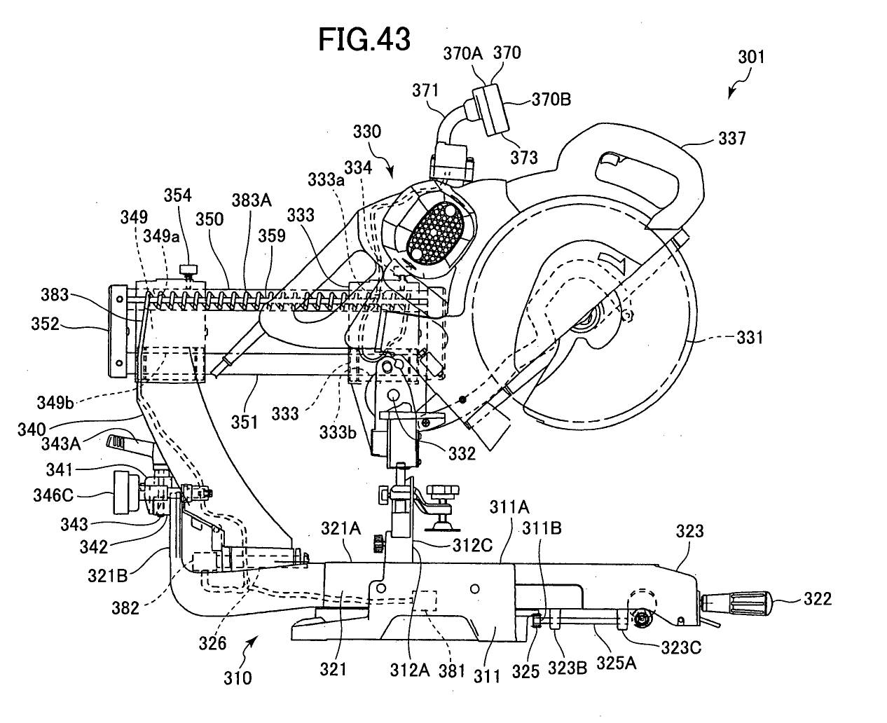

The rotation amount detection unit 381 and the tilting amount detection unit 382 those provided at the base section 310 are connected to the microcomputer provided at the circular saw unit 330 through an electric cord 383. As shown in FIG. 43, the cord 383 extending from the rotation amount detection unit 381 and the tilting amount detection unit 382 passes through the holder 340, and is drawn to an outside of the first slide support portion 349. Then the cord 383 passes along the left side of the first slide support portion 349, the left side of the pair of pipes 350, 351, and is entered into the circular saw unit 330. The cord 383 then passes through the circular saw unit 330, the flexible arm 371, and is entered into the display unit 370 to be connected to the microcomputer. Incidentally, in FIGS. 36 through 41, 44, 46, 47 and 49, the cord 383 is not shown for simplicity.

A part of the cord 383, the part being positioned at left side of the pair of pipes 350, 351 is in the form of a spiral cord 383A. As shown in FIGS. 42 and 43, a support rod 359 extends beside the left side of the pipe 350 in approximately parallel with the pipe 350. One end of the support rod 359 is fixed to the first end holding member 352, and other end of the support rod 359 is fixed to the second end holding member 353. The spiral cord 383A is would over the support rod 359. A distance between the circular saw unit 330 and the holder 340 is shortened by the sliding motion of the pair of pipes 350, 351 relative to the first slide support portion 349 or by the sliding motion of the second slide support 333 relative to the pair of pipes 350, 351. As a result, the a spiral pitch; of the spiral cord 383A is shortened as shown in FIG. 42 to shorten the length of the spiral cord in the longitudinal direction of the support rod 359. On the other hand, if the distance between the circular saw unit 330 and the holder 340 is increased, the spiral pitch of the spiral cord 383A is increased as shown in FIG. 43 to prolong the length of the spiral cord in the longitudinal direction of the support rod 359.

Since the microcomputer is mounted on the substrate, and the substrate and the display body 373 are disposed in the display unit 370 to be attached to the circular saw unit 330, the display body 373 can be easily attached to another kind of miter saw as long as the signals output from the rotation amount detection unit 381 and the tilting amount detection unit 382 are common among various types of miter saws. Further, the display body 373 can be easily attached to the other type of miter saw by a simple modification to the attachment arrangement. Furthermore, a change in design in the display unit 370 can be easily made to be used in the different type of the miter saw because of the unit structure.

Further, since the cord 383 is partly the spiral cord 383A at a position along the pair of pipes 350, 351, the spiral cord 383A can expand or contract in response to the frontward/rearward movement of the circular saw unit 330. Accordingly, the cord 383 does not interfere the movement of the circular saw unit 330 while the electrical connection of the microcomputer to the rotation amount detection unit 381 and the tilting amount detection unit 382 those at the base section 310 is maintained.

In order to perform fine adjustment on the angular rotation angle of the turntable 321 for angled cutting at a desired angle, the knob 322 (FIG. 48) is moved radially outward of the turntable 321, so that the inner end of the knob shaft 322A is out of contact from the arcuate section of the base 311. Thus, the turntable 321 becomes freely rotatable. Then, the user grips the knob 322 and moves the knob 322 in the circumferential direction of the turntable 321 so as to position the turntable 321 close to the desired angular rotational position. Then, the knob section 324B is rotated so as to finely control the angular rotational position of the turntable 321 to obtain the desired angle. Finally, the knob 322 is rotated about its axis to move the knob 322 radially inwardly of the turntable 321. Thus, the inner end of the knob shaft 322A is brought into pressure contact with the arcuate section at the base 311. Thus, the turntable 321 is maintained at the desired rotation angle position. Then, the workpiece is cut by the circular saw blade 331.

In order to perform fine adjustment on the tilting angle of the circular saw blade 331 for tilted cutting, first, the clamp lever 343A (FIG. 36) is unfastened so as to allow the holder 340 and the circular saw unit 330 to be freely tiltable about the holder shaft 326. Then, the user tiltingly moves the holder 340 and circular saw unit 330 to a position close to the desired tilting angle while holding the handle 337. Then, the knob 346C (FIG. 46) is rotated about its axis so as to finely control the tilting position of the holder 340 to obtain the desired angle. Finally, the clamp lever 343A (FIG. 36) is fastened to maintain the tilting position of the holder 340 and the circular saw unit 330. Then, the workpiece is cut by the circular saw blade 331.

For vertically cutting a workpiece having a small width in the frontward/rearward direction on the upper surface 321A of the turntable 321, the pair of pipes 350, 351 are moved frontward until the first end holding member 352 is brought into abutment with the first slide support portion 349 of the holder 340. Then, the knob 354A is fastened to prevent the pipe 350 from sliding movement relative to the first slide support portion 349. As shown in FIG. 37, the second end holding member 353 is moved rearward until the second end holding member 353 is brought into abutment with the first slide support portion 349. Then, the second knob 334A of the second screw 334 is fastened to prevent the second slide support 333 from sliding movement relative to the pipe 350. Thus, the holder 340, the second slide support 333 and the circular saw unit 330 are held at their upright posture as shown in FIG. 38. Then, the circular saw unit 330 is pivotally moved toward the turntable 321 about the pivot shaft 332 so as to cut the workpiece in the vertical direction relative to the upper surface 321A of the turntable 321.

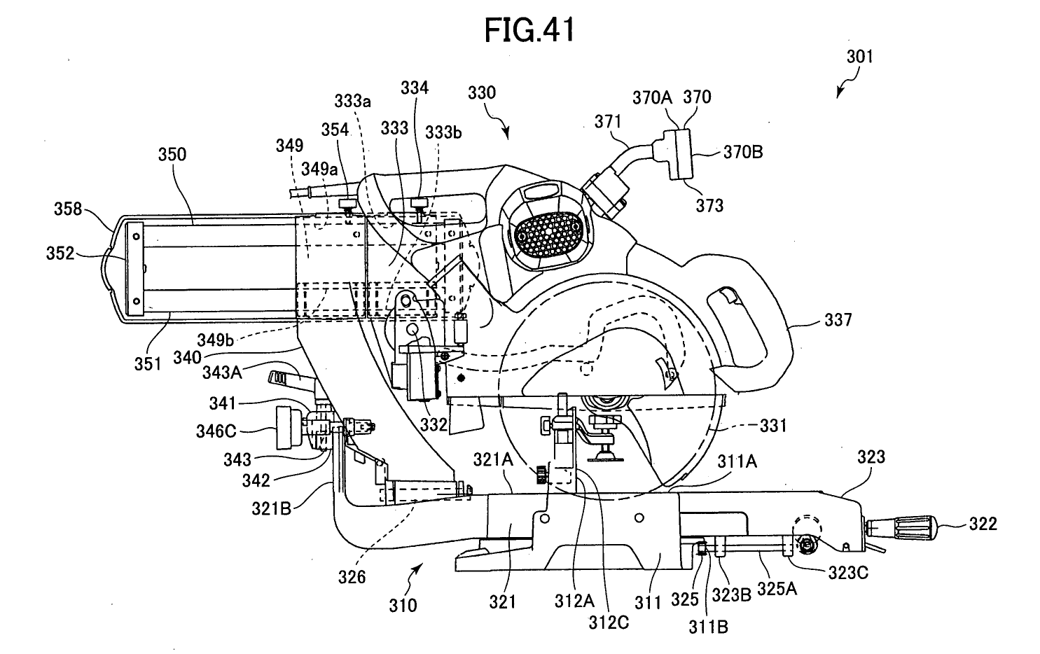

As an alternative way, the pair of pipes 350, 351 are moved rearward until the second end holding member 353 is brought into abutment with the second slide support 333 of the circular saw unit 330. Then, the second knob 334A of the second screw 334 is fastened to prevent the second slide support 333 from sliding movement relative to the pipe 350. Then, as shown in FIG. 41, the pair of pipes 350, 351 are moved rearward until the second slide support 333 is brought into abutment with the first slide support portion 349. Then, the first knob 354A of the first screw 354 is fastened to prevent the pipe 350 from sliding movement relative to the first slide support portion 349. Thus, the holder 340, the second slide support 333 and the circular saw unit 330 are held at their upright posture as shown in FIG. 38. Then, the circular saw unit 330 is pivotally moved toward the turntable 321 about the pivot shaft 332 so as to cut the workpiece in the vertical direction relative to the upper surface 321A of the turntable 321.

For vertically cutting a workpiece having a large width in the frontward/rearward direction on the upper surface 321A of the turntable 321, the pair of pipes 350, 351 are moved frontward until the first end holding member 352 is brought into abutment with the first slide support portion 349. Then, the knob 354A is fastened to prevent the pipe 350 from sliding movement relative to the first slide support portion 349. Further, the second knob 334A of the second screw 334 is fastened to prevent the second slide support 333 from sliding movement relative to the pipe 350. Then, as shown in FIG. 39, the second slide support 333 is moved frontward along the pair of pipes 350, 351 until the second slide support 333 is brought into abutment with the second end holding member 353. Then, the handle 337 is pushed down so as to pivotally move the circular saw unit 330 toward the turntable 321 about the pivot shaft 332 against the biasing force of the torsion spring for cutting the workpiece in the vertical direction relative to the upper surface 321A of the turntable 321 as shown in FIG. 40.

Then, the circular saw unit 330 and second slide support 333 are moved rearward along the pair of pipes 350, 351 while maintaining the handle 337 in its downward position. As a result, the workpiece having a broad width can be vertically cut relative to the upper surface 321A of the turntable 321. When push-down force to the handle 337 is released after cutting the workpiece, the circular saw unit 330 is pivotally moved upward about the pivot shaft 332 by the biasing force of the torsion spring to restore an original uppermost position of the circular saw unit 330. The same process is repeatedly carried out for successively cutting the workpieces each having broad width. Angled cutting and slant cutting are also performed in the same manner with respect to the workpiece having broad width.

A workpiece having a broad width in the frontward/rearward direction can also be cut in the following manner if no impedimenta such as a wall or ambient article is located behind the holder 340. First, the first knob 354A of the first screw 354 is unfastened to allow the pipe 350 to be slidable relative to the first slide support portion 349. Then, the pair of pipes 350, 351 are moved frontward until the first end holding member 352 is brought into abutment with the first slide support portion 349. Further, the second knob 334A of the second screw 334 is unfastened to allow the second slide support 333 to be slidable relative to the pipe 350. Then, the second slide support 333 is moved frontward along the pair of pipes 350, 351 until the second slide support 333 is brought into abutment with the second end holding member 353. Then, the second knob 334A of the second screw 334 is fastened to prevent the second slide support 333 from sliding movement relative to the pipe 350. Then, the handle 337 is pushed down so as to pivotally move the circular saw unit 330 toward the turntable 321 about the pivot shaft 332 against the biasing force of the torsion spring for cutting the workpiece in the vertical direction relative to the upper surface 321A of the turntable 321.

Then, the circular saw unit 330, the second slide support 333, and the pair of pipes 350, 351 are moved rearward relative to the first slide support portion 349 while maintaining the handle 337 in its downward position as shown in FIG. 41. As a result, the workpiece having a broad width can be vertically cut relative to the upper surface 321A of the turntable 321. When push-down force to the handle 337 is released after cutting the workpiece, the circular saw unit 330 is pivotally moved upward about the pivot shaft 332 by the biasing force of the torsion spring to restore an original uppermost position of the circular saw unit 330. The same process is repeatedly carried out for successively cutting the workpieces each having broad width. Angled cutting and slant cutting are also performed in the same manner with respect to the workpiece having broad width.

In the miter saw 301 of the type in which the circular saw unit 330 is movable frontward/rearward in the axial direction of the pipes 350, 351, the circular saw unit 330 is located close to the user in a state shown in FIG. 39 where the circular saw unit 330 is at its uppermost position prior to the cutting operation. In this state, since the display body 373 is disposed at the circular saw unit 330, high visibility to the angular rotation angle and the tilting angle can result. Further, since the display body 373 is supported to the circular saw unit 330 through the flexible arm 371, orientation of the display surfaces 372 is variable in frontward/rearward, leftward/rightward and upward/downward by the universal deformation of the flexible arm 371. That is, the normal line of the display surfaces 372 can be directed toward the user. Consequently, visibility to the angular rotation angle and the tilting angle displayed on the display surfaces 372 can further improved.

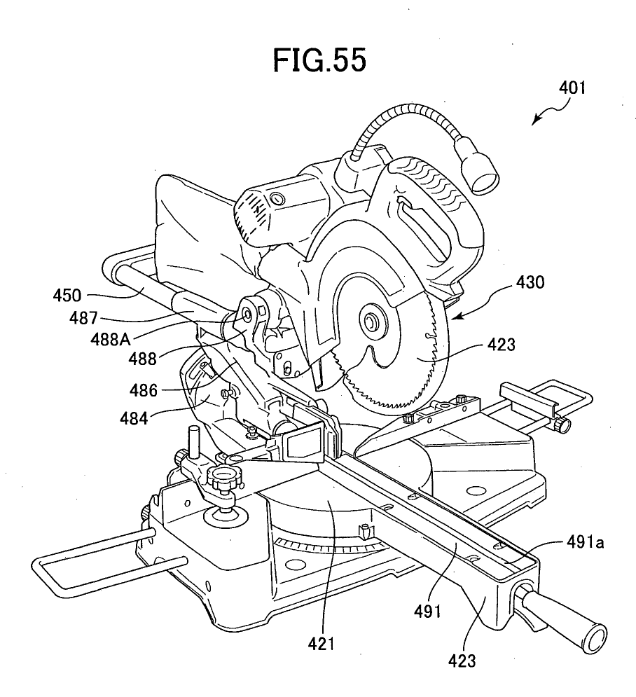

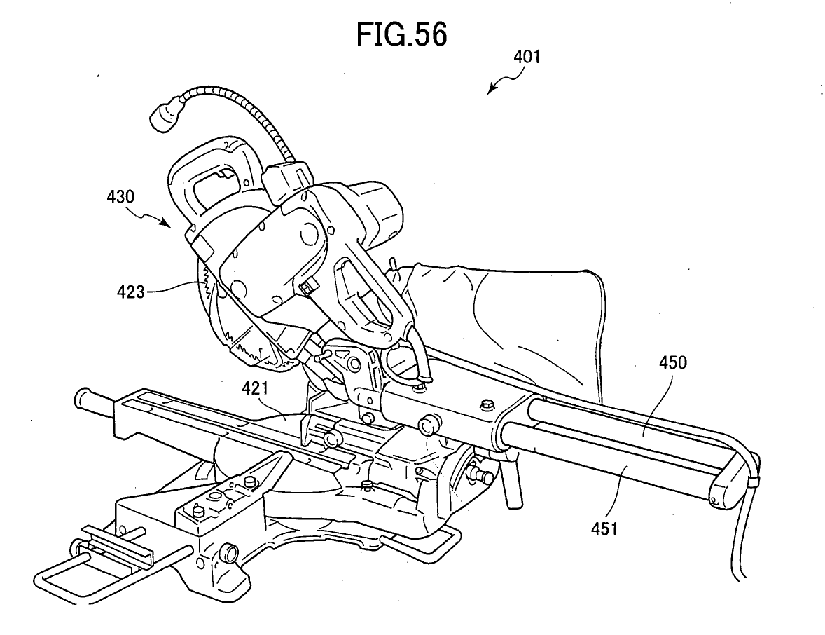

A miter saw according to a fourth embodiment is shown in FIGS. 55 and 56. In the third embodiment, the imaginary plane containing the axes of the pair of pipes 350, 351 extends in a direction parallel with the pivotally moving direction of the circular saw unit 330. However, as shown in FIGS. 55 and 56, a pair of pipes 450,451 of a miter saw 401 are so arrayed such that an imaginary plane containing axes of the pipes 450, 451 extends in a direction to cross a locus of a circular saw unit 430 toward and away from the turntable 421.

Further, in the miter saw 1 according to the first embodiment, the support section 3 pivotally movably extends from the base section 2 and is pivotally movably supports the circular saw unit 4. However, in the miter saw 401, a tilt support portion 484 integrally extends from the turntable 421. Further, a support section corresponding to the support section 3 includes a holder section 486, a slide guide section 487, a slide section including the pair of pipes 450, 451 and a saw unit support section 488.

The holder section 486 has a lower end pivotally movably supported to a turntable 421. A pivot axis of the holder section 486 is coincident with an upper surface of the turntable 421 and with a slit 491a of a slit plate 491 at a neck table section 423 of the turntable 421. The slit 491a is adapted to allow a circular saw blade 423 to be inserted therein when the circular saw unit 430 is moved toward the turntable 421. A pivot posture of the holder section 486 is changed and fixed relative to the tilt support section 484. The holder section 486 has an upper end portion provided with the slide guide portion 487.

The pipes 450, 451 are movable in frontward/rearward direction and are slidably supported by the slide guide portion 487. The saw unit support section 488 is provided at a front end of the pipes 450, 451. The circular saw unit 430 is pivotally movably supported to the saw unit support section 488 through a support pin 488A. Thus, by the sliding movement of the slide section relative to the holder section 486, the circular saw unit 430 is moved in the frontward/rearward direction at a position above the turntable 421. In such a miter saw 401, the angular rotation of the turntable 421 and the tilting motion of the circular saw unit 430 can be performed in the manner similar to the foregoing embodiments.

According to the fourth embodiment, since the circular saw unit 430 is movable in frontward/rearward direction, a workpiece having a greater size in frontward/rearward direction can be cut.

The miter saw according to the present invention is not limited to the above-described embodiments, but various modifications may be conceivable.

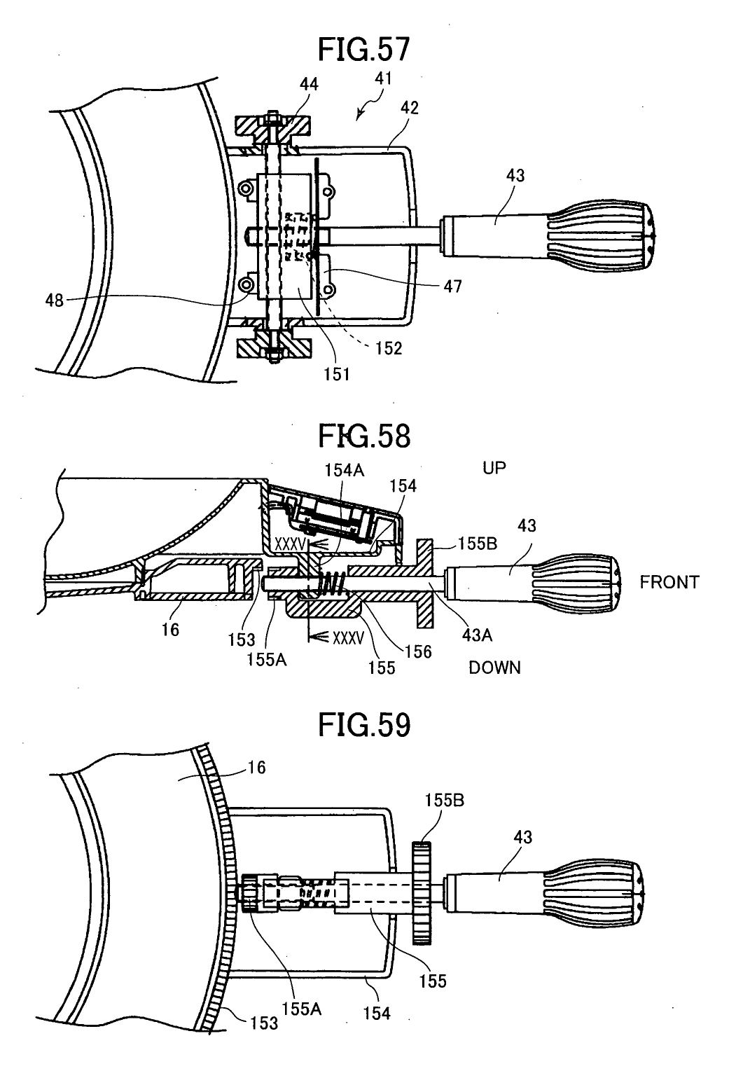

FIG. 57 shows a first modification pertaining to the adjustment unit 41, wherein like parts and components are designated by the same reference numerals and characters as those shown in the foregoing embodiments. In the first modification, a single spring 152 is interposed between a table contact piece 151 (corresponding to the table contact piece 45) and the front wall 47 instead of two springs 46. This modification can reduce components or parts that constitute the adjustment unit 41.

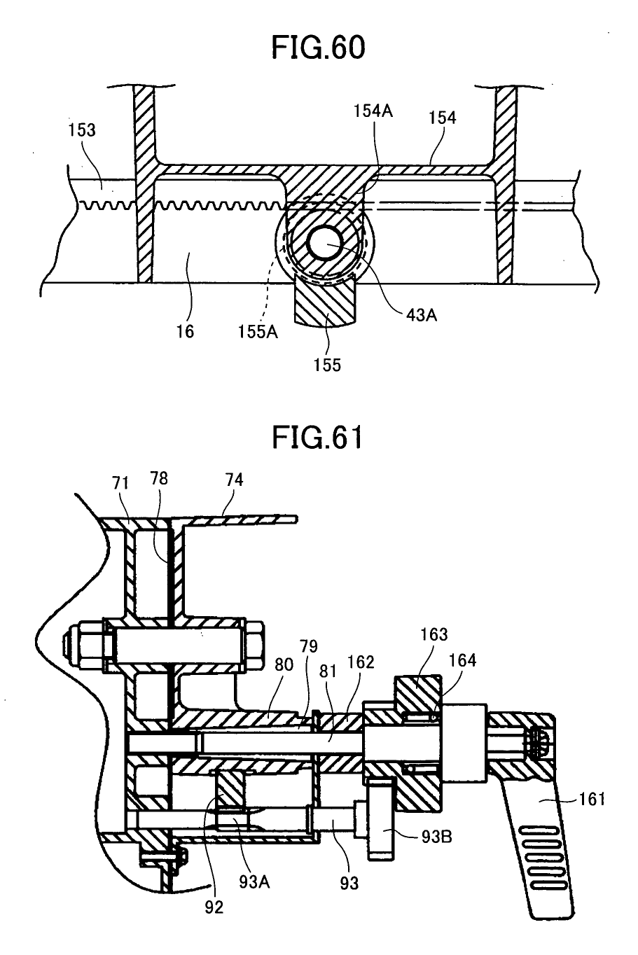

A second modification pertaining to the adjustment unit is shown in FIGS. 58 through 60. The arcuate portion 16 of the base has a lower surface at its outer peripheral side, and the lower surface is formed with gear teeth 153 facing downward. A frame 154 of the turntable is provided with a support portion 154A extending downward therefrom, and a female thread extending frontward/rearward is formed in the support portion 154A. The shaft portion 43A of the fixing handle 43 is threadingly engaged with the female thread. By rotating the fixing handle 43 about its axis in one direction, the tip end of the fixing handle 43 is brought into abutment with the arcuate portion 16 so as to fix the position of the frame 154 relative to the arcuate portion 16.

An adjustment member 155 is disposed over the shaft portion 43A, and rides over the support portion 154A. A spring 156 is disposed over the shaft portion 43A and interposed between a front surface of the support portion 154A and the adjustment member 155 for urging the adjustment member 155 frontward. The adjustment member 155 has a rear end integrally provided with a gear wheel 155A meshedly engageable with the gear teeth 153. The adjustment member 155 has a front end integrally provided with a knob 155B.

Fine adjustment for the rotational position of the turntable 21 using the adjustment member 155 will be described. After the turntable 21 having the frame 154 is rotated to a position near the predetermined rotation angle, the adjustment member 155 is pressed rearward to allow the gear wheel 155A to be meshingly engaged with the gear teeth 153. While maintaining this meshing engagement, the knob 155B is rotated about its axis to perform fine control. Then, the fixing handle 43 is fastened, so that the position of the frame 154 relative to the arcuate portion 16 is fixed at the desired rotational position of the turntable 21.

Because of the meshing engagement between the gear wheel 155A and the gear teeth 153, the turntable 21 is not angularly rotatable relative to the base 11 unless the adjustment member 155 is rotated. Further, since the gear ratio of the gear wheel 155A to the gear teeth 153 is small, angularly rotating amount of the turntable 21 can be small in spite of the several rotations of the adjustment member 155. This facilitates fine adjustment.

A third modification pertaining to a fine adjustment to the tilting angle will be described with reference to FIG. 61 wherein like parts and components are designated by the same reference numerals as those shown in FIG. 18. A spring 164 is interposed between a fine adjustment knob 163 and a clamp lever 161 for normally urging the fine adjustment knob 163 rearward through a spacer 162, so that the slide wall 78 of the tilt section 74 is urged toward the tilt motion support 71. Thus, friction force is generated between the slide wall 78 and the tilt motion support 71.

If the intimate contact of the slide wall 78 to the tilt motion support 71 is released upon unfastening the clamp lever 161, the circular saw unit 4 is urged to be tiltingly moved due to its own weight. However, this tilting motion due to the own weight can be restrained because of the friction force still imparted between the slide wall 78 and the tilting motion support 71 by the biasing force of the spring 164.

Further, free rotation of the fine adjustment knob 163 is restrained because of the biasing force of the spring 164 is imparted on the knob 163. Accordingly, a tilting movement of the tilt section 74 is also restrained since the tilt section 74 is connected to the fine adjustment knob 163 through the rotation shaft 93. Thus, tilting motion of the circular saw unit 4 due to its own weight can be restrained. This means that it is unnecessary to manually support the circular saw unit 4 at a given posture by user's hand during fine adjustment to the tilting angle of the circular saw unit 4. This facilitates the fine adjustment.

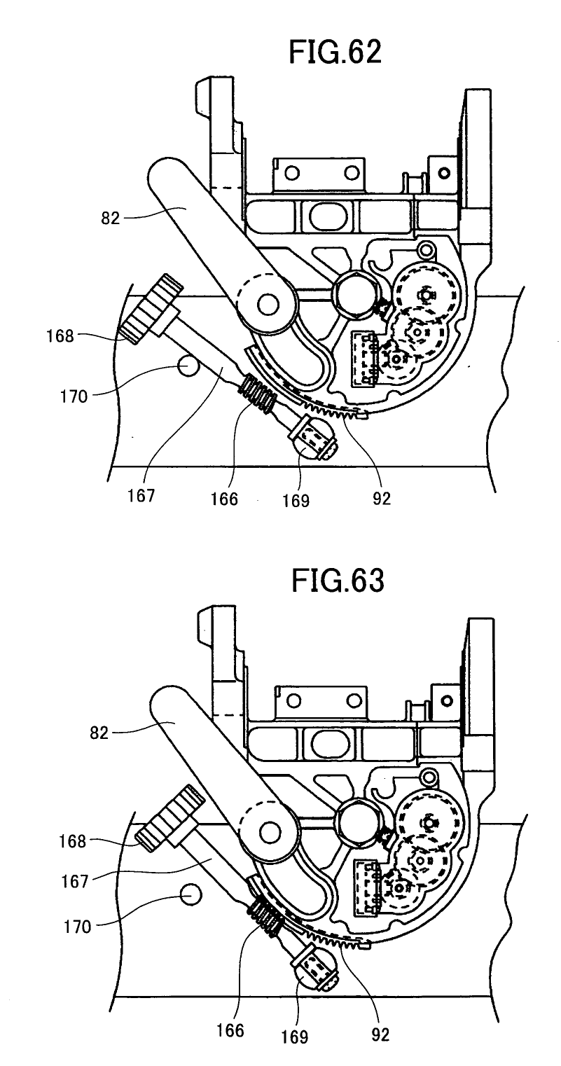

A fourth modification pertaining to a fine adjustment to the tilting angle will be described with reference to FIGS. 62 and 63. A shaft support 169 is rotatably supported in a peripheral side of the turntable at a position below the tilt section 74. A fine adjustment shaft 167 has one end connected to the shaft support 169, so that the fine adjustment shaft 167 is pivotally movable about an axis of the shaft support 169. The fine adjustment shaft 167 has an intermediate portion formed with a worm 166 selectively engageable with the arcuate gear teeth 92. The fine adjustment shaft 167 has a free end integrally provided with a fine adjustment knob 168. A stop 170 extends from the peripheral side of the turntable so as to limit the pivotal movement of the fine adjustment shaft 167 in a direction away from the arcuate gear teeth 92.

Normally, the fine adjustment shaft 167 is in abutment with the stop 170, so that the worm 166 is disengaged from the arcuate gear teeth 92 as shown in FIG. 62. If the circular saw unit 4 is to be tiltingly moved to a desired tilting angle position, the fine adjustment shaft 167 is pivotally moved toward the arcuate gear teeth 92 so as to engage the worm 166 with the arcuate gear teeth 92 as shown in FIG. 63, after the circular saw unit 4 is tiltingly moved to a position near the desired tilting angle position. By this engagement, tilting posture of the circular saw unit 4 can be maintained. Then, the fine adjustment knob 168 is rotated about its axis so that the arcuate gear teeth 92 is moved about the axis of the pivot bolt 76. The movement of the arcuate gear teeth 92 implies the tilting movement of the tilt section 74 about the axis of the pivot bolt 76. Thus, the tilting angle of the circular saw blade 123 can be subjected to fine adjustment. Then, the clamp lever 82 is fastened to fixely secure the tilting angle.

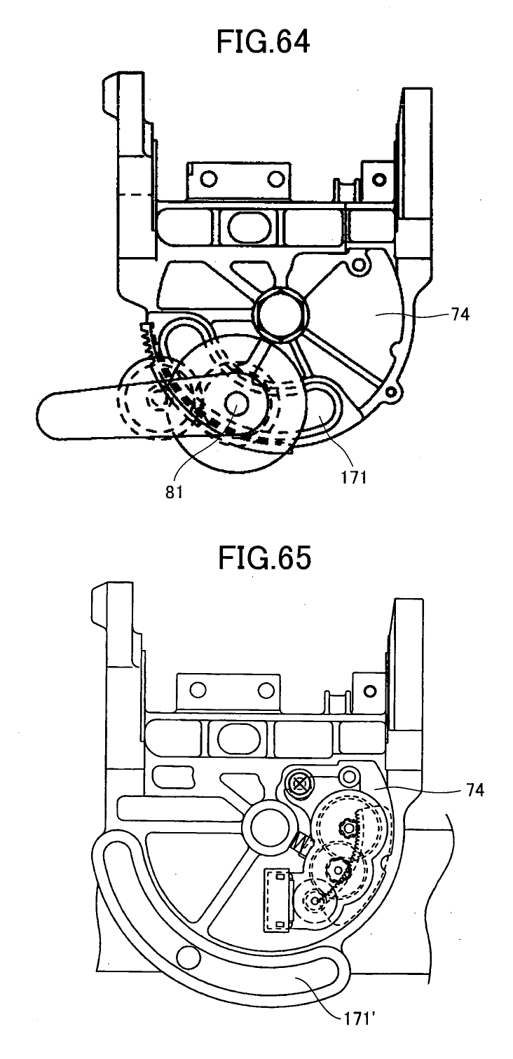

A fifth modification pertaining to a fine adjustment to the tilting angle will be described with reference to FIG. 64. An arcuate elongated slot 171 is formed longer than that of the elongated slot 79, so that the tilt section 74 can be tiltable to the angle of about 45 degrees in both clockwise and counterclockwise directions. Thus, the circular saw unit 4 can be tilted to about 45 degrees in rightward and to 45 degrees in leftward.

A sixth modification pertaining to a fine adjustment to the tilting angle is shown in FIG. 65. According to the modification, an arcuate elongated slot 171′ is positioned along an outer peripheral edge of the tilt section 74.

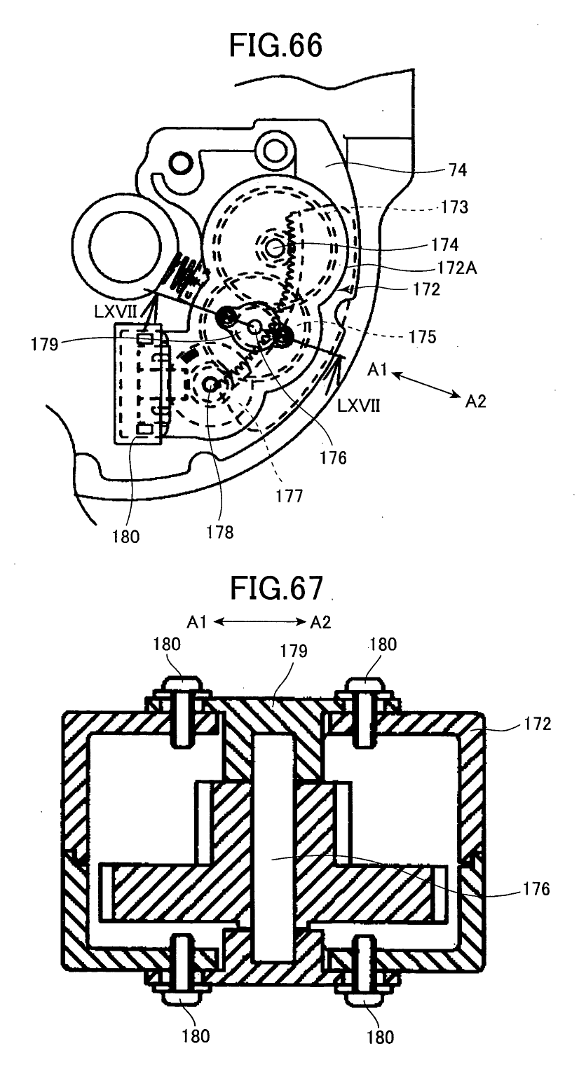

A seventh modification pertaining to a tilting amount detection unit is shown in FIGS. 66 and 67. A tilting amount detection unit 172 includes a housing 172A in which rotation shafts 174 and 178 are rotatably supported. A shaft support 179 is attached to the housing 172A for rotatably supporting a rotation shaft 176.

A first gear set 173, a second gear set 175 and detected segment 177 are coaxially mounted on the shafts 174, 176, 178, respectively. Geometrical relationship among the rotation shafts 174,176,178 is such that a line connecting the rotation shafts 174 and 178 is assumed to be a base line of a triangle, and the rotation shaft 176 is at an apex of the triangle. The shaft support 179 is movable in a direction perpendicular to the line connecting the rotation shafts 174 and 178 and perpendicular to the rotation shaft 176 as shown by arrows A1 and A2. Further, the shaft support 179 can be fixed to the housing 172A by screws 180. An optical sensor 180 is provided beside the detected segment 177.

For assembly, the shaft support 179 is urged in the direction A1 (toward the line connecting the rotation shafts 174 and 178) so as to maintain meshing engagement of the second gear set 175 with the first gear set 173 and the detected segment 177. Then, the screws 180 are fastened to fix the shaft support 179 to the housing 172A. With this arrangement, any rattling among the first gear set 173, the second gear set 175 and the detected segment 177 does not occur. Accordingly, accurate rotation amount of the detected segment 177 in response to the rotation of the first gear set 173 can be obtained, thereby enhancing detection accuracy at the optical sensor 180. A modification is conceivable to the seventh modification such that the shaft support 179 is not fixed to the housing 172A, and a biasing member such as a spring is provided for biasing the shaft support 179 in the direction A1.

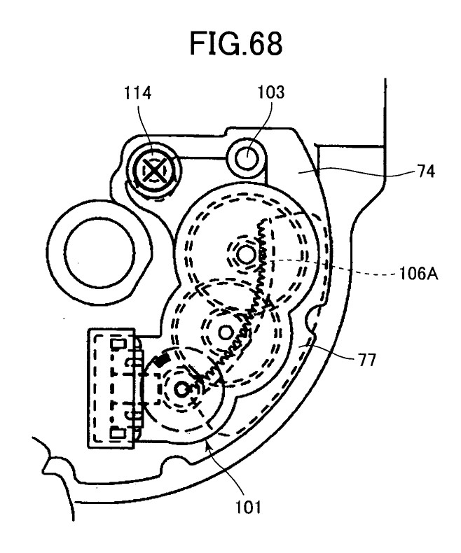

An eighth modification pertaining to a tilting amount detection unit is shown in FIG. 68. According to this modification, the spring 105 in the tilting amount detection unit 101 (FIG. 19) is dispensed with. The tilting amount detection unit 101 is pivotally moved about the axis of the pin 113 so as to meshingly engage the first gear 106A with the arcuate inner gear teeth 77. Then, the screw 114 is fastened to maintain the meshing engagement without rattling. Thus, the position of the tilting amount detection unit 101 can be fixed relative to the arcuate inner gear teeth 77, thereby accurately detecting the tilting angle of the tilt section 74 relative to the tilting motion support 71.

A modification pertaining to a tilting amount detection unit will be described. A low output and low power consumption motor (not shown) is drivingly coupled to the rotation shaft 111 or 178 of the detected segment 110 or 177 so that positive rotation force is imparted on the shaft 111 or 178. By the rotation force, the rotation shafts 107, 109 or 174,176 are urged to be rotated. However, since the first gear 106 or 173 is engaged with the arcuate inner gear teeth 77, and since rotation torque of the motor is extremely small, the detected segment, the first gear set and the second gear set are not rotated. Still however, because of the application of the rotational force by the motor, no rattling occurs between engaging regions. Further, even if relative movement occurs between the arcuate inner gear teeth 77 and the tilting amount detection unit 101 by the tilting motion of the tilt section 74, the motor does not affect the relative movement, since the output of the motor is extremely small. Furthermore, because of the employment of the low power consumption motor, power from the battery box 132 can be used for energizing the motor even if the main power source is not connected.

The above-described modifications to the tilting amount detection unit are also available for the rotation amount detection unit 51. Further, in the above-described embodiments, gears are used for transmitting rotation to the detected segment. Here, friction wheels can be used instead of the gears for amplifying and transmitting rotation.

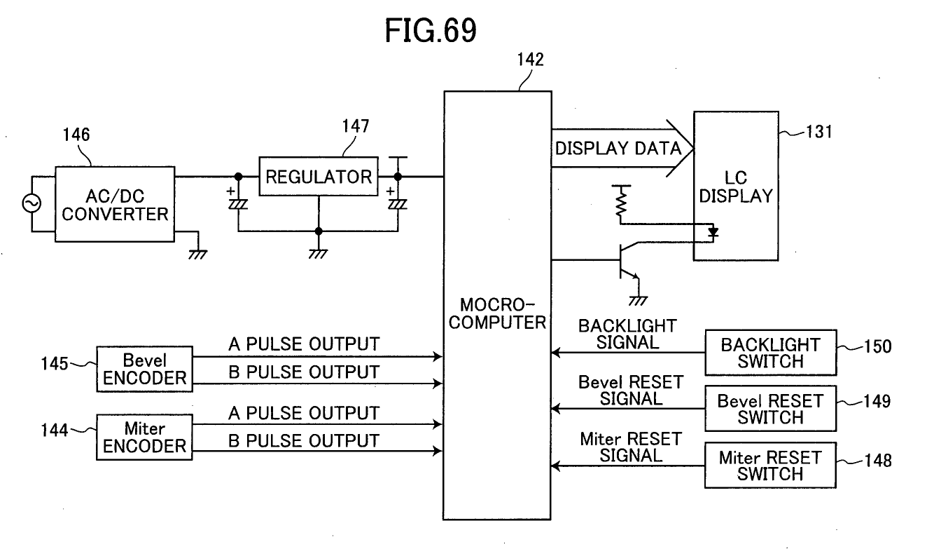

A ninth modification pertaining to a control circuit is shown in FIG. 69. In the control circuit shown in FIG. 24, the battery box 132 is provided for continuously measuring rotation amount of the turntable 21 and tilting amount of the circular saw unit 4. However, in the control circuit shown in FIG. 69, the battery box 132 is dispensed with. In the latter case, if the turntable 21 is angularly rotated or the circular saw unit 4 is tiltingly moved while the AC power source is disconnected, computation of such angle cannot be made in the microcomputer 142. Even if the AC power source is connected thereafter, the rotation amount and tilting amount is unknown. To avoid this problem, a notice as to the necessity of zero resetting can be displayed on the digital display 131. After the turntable 21 is set to zero angle position, and after the circular saw unit 4 is set to zero angle position in response to the notice by the display 131, Miter reset switch 148 and the Bevel reset switch 149 are pressed for initialization. Then, the turntable is angularly rotated or the circular saw unit 4 is tiltingly moved.

Further, the set position of the battery box 132 is not limited to within the semi-circular recess 24, but can be disposed at the lower surface of the base 11.

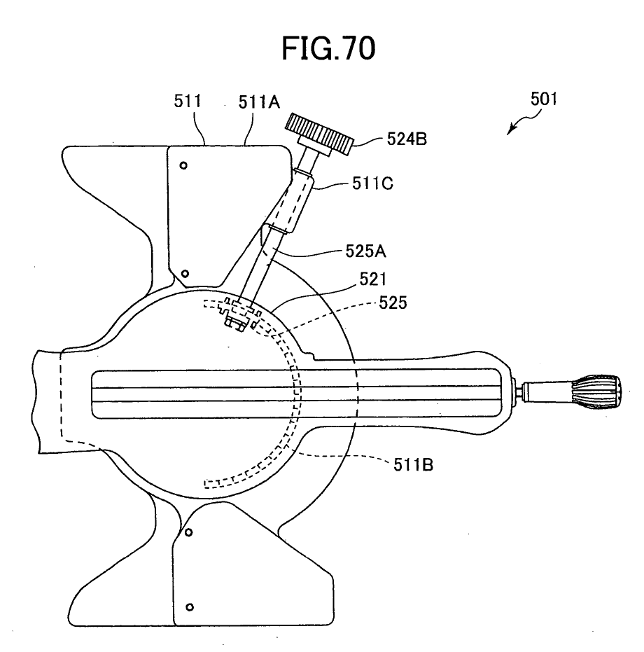

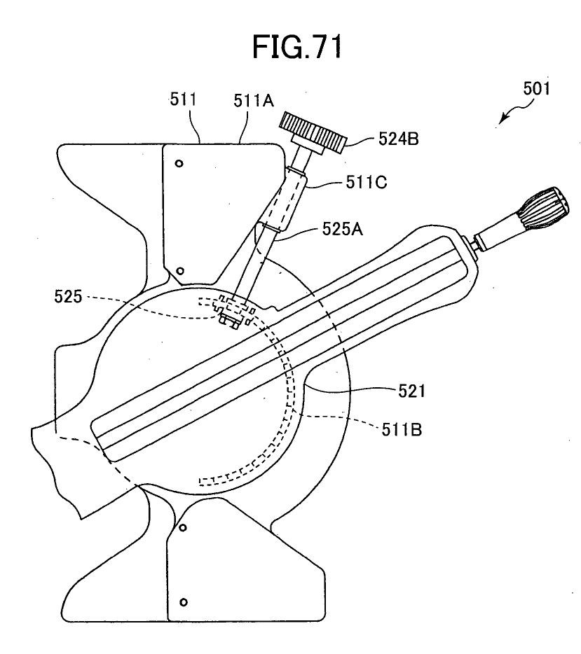

A tenth modification is shown in FIGS. 70 and 71. In the angular rotation angle fine adjustment mechanism according to the third embodiment, the pinion 325 and the knob section 324B are rotatably supported to the frame 323 of the turntable 321, and the engagement section 311B is located at the peripheral end portion of the base 311. However, as shown in FIGS. 70 and 71, a pinion 525 and a knob 524B can be rotatably supported to a base 511, whereas an arcuate engagement section 511B can be formed at a lower peripheral end portion of the turntable 521. That is, the arcuate engagement section 511B extends in a circumferential direction of the turntable 521.

More specifically in FIG. 70, the base 511 has a right base 511A provided with a pinion shaft support portion 511C for rotatably supporting a pinion shaft 525A. The pinion shaft 525A has one end provided with the pinion 525 and another end provided with the knob 524B. The engagement section 511B is provided integrally with the turntable 521. The pinion 525 is in continuous meshing engagement with the engagement section 511B. The pinion 525 is rotated integrally with the pinion shaft 525A upon rotation of the knob 524B. Thus, the turntable 521 is rotated about its axis relative to the base 511 as shown in FIG. 71. Thus, fine control to the angular rotation angle of the turntable 521 can be performed by the rotation of the knob 524B. Reversely, the knob 524B is rotated in synchronism with the angular rotation of the turntable 521. In other words, a temporary fixing to the turntable 521 is unnecessary for the fine adjustment.

Further, in the third embodiment, potentiometer is used as the rotation amount detection unit 381 and tilting amount detection unit 382. However, a rotary encoder adapted to count a rotation angle is also available.

Further, in the third embodiment, the circular saw unit 330 is movable in the axial direction of the pipes 350, 351. However, a circular saw unit can be only pivotally movable toward and away from the turntable without any movement in the frontward/rearward direction.

Further, in the third embodiment, the engagement member 344 is fixed to the first confronting surfaces 321E of the turntable 321, whereas the shaft 346B provided with the pinion 346A and the knob 346C is disposed at a position adjacent to the second confronting surface 341A of the holder 340. However, the reversal positional relationship is also available. That is, the engagement member 344 can be fixed to the second confronting surface 341A, and the shaft 346B provided with the pinion 346A and the knob 346C is disposed at a position adjacent to the first confronting surfaces 321E. Further, the shaft 346B can be dispensed with such that the pinion 346A is directly connected to the knob 346C.

Further, in the third embodiment, the turntable 321 is angularly rotatable and the circular saw blade 331 is laterally tiltable. However, as a first alternative, the turntable is angularly rotatable whereas the circular saw blade is not tiltable. As a second alternative, the turntable is unrotatable whereas the circular saw blade is tiltable.

Further, in the third embodiment, the display unit 370 including the display body 373 and the substrate is attached to the circular saw unit 330. However, the display body 373 can be directly connected to the flexible arm to be supported to the circular saw unit 330.

Further, in the third embodiment, the ball bearings 357, 336 are disposed between the first slide support portion 349 and the pipe 351, and between the second slide support 333 and the pipe 351, respectively. However, an oil-impregnated metal can be used instead of the ball bearing.

Further, in the third embodiment, the first slide support portion 349 and second slide support 333 are provided. However, only one of the first slide support portion 349 and second slide support 333 can be provided for moving the circular saw unit 330 in the axial direction of the pipes.

Various combinations are conceivable with respect to the above-described modifications. Further, various modification can be effected on the slide type miter saw shown in FIGS. 55 and 56.

While the invention has been described in detail and with reference to specific embodiments thereof, it would be apparent to those skilled in the art that various changes and modifications may be made therein without departing from the scope of the invention.

1. A miter saw comprising:
a base section comprising a base, and a turntable for mounting thereon a workpiece and supported on the base and rotatable about a rotation axis relative to the base;
a circular saw unit that rotatably supports a circular saw blade;
a support section provided to the turntable and pivotally movably supporting the circular saw unit at a position above the turntable;
a rotation amount detection unit that detects rotation amount of the turntable relative to the base; and
a digital display disposed at the circular saw unit for displaying a rotation angle based on date transmitted from the rotation amount detection unit.

2. The miter saw as claimed in claim 1, wherein the circular saw unit comprises a motor that rotationally drives the circular saw blade, and a motor housing that accommodates therein the motor, the digital display being attached to the motor housing.

3. The miter saw as claimed in claim 2, wherein the base section has a rear portion at which the support section is laterally movably supported, and
wherein the circular saw unit is pivotally movable between its uppermost position and its lowermost position; and
wherein the digital display is disposed at an upper portion of the motor housing and has a display surface oriented generally frontward when the circular saw unit is at its uppermost position.

4. The miter saw as claimed in claim 3, wherein the display surface is oriented to provide an angle not less than 90 degrees relative to an upper surface of the base section when the circular saw unit is at its lowermost position.

5. The miter saw as claimed in claim 2, wherein the circular saw unit further comprises a saw cover provided integrally with the motor housing, and a handle having a handle grip positioned above the saw cover and offset from the digital display.

6. The miter saw as claimed in claim 1, wherein the rotation amount detection unit transmits an output signal indicative of a rotation amount, and the miter saw further comprising:
a pivot shaft supported to the support section and about which the circular saw unit is pivotally moved,
a control unit that outputs signal indicative of the rotation angle to the display based on the output signal transmitted from the rotation amount detection unit; and
a substrate mounting thereon the control unit and attached to the circular saw unit.

7. The miter saw as claimed in claim 6, wherein the support section comprises:
a holder having one end supported to the turntable and another end;
a slide support portion provided at the another end;
a slide portion slidably supported to the slide support portion and movable in a direction perpendicular to the pivot shaft and in parallel with an upper surface of the turntable, the circular saw unit being pivotally supported to the slide portion through the pivot shaft.

8. The miter saw as claimed in claim 7, wherein the rotation amount detection unit is disposed at the base section; and
the miter saw further comprising an electric cord extending from the rotation amount detection unit, passing along the slide portion and into the circular saw unit for electrically connecting the rotation amount detection unit to the control unit, the electric cord having a part formed into a spiral cord at a position along the slide portion.

9. The miter saw as claimed in claim 8, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion; and
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.

10. The miter saw as claimed in claim 6, further comprising a flexible arm having a base end fixed to the circular saw unit and a free end provided with the display, whereby the display is universally movable frontward/rearward, rightward/leftward and upward/downward relative to the circular saw unit.

11. The miter saw as claimed in claim 6, further comprising an outer display frame disposed outside of the circular saw unit for accommodating therein the display and the substrate to provide a display unit.

12. The miter saw as claimed in claim 11, further comprising a flexible arm having a base end fixed to the circular saw unit and a free end connecting the display unit, whereby the display unit is universally movable frontward/rearward, rightward/leftward and upward/downward relative to the circular saw unit.

13. The miter saw as claimed in claim 1, wherein the support section is laterally tiltable with respect to the turntable so as to laterally tilt the circular saw unit, the turntable having an upper surface, and the miter saw further comprising:
a tilting amount detection unit that detects lateral tilting amount of the support section relative to the upper surface of the turntable, the digital display also displaying a lateral tilting angle based on data transmitted from the tilting amount detection unit, the lateral tilting amount of the support section being coincident with a lateral tilting amount of a side surface of the circular saw blade.

14. The miter saw as claimed in claim 13, wherein the circular saw unit comprises a motor that rotationally drives the circular saw blade, and a motor housing that accommodates therein the motor, the digital display being attached to the motor housing.

15. The miter saw as claimed in claim 14, wherein the base section has a rear portion at which the support section is laterally movably supported, and
wherein the circular saw unit is pivotally movable between its uppermost position and its lowermost position; and
wherein the digital display is disposed at an upper portion of the motor housing and has a display surface oriented generally frontward when the circular saw unit is at its uppermost position.

16. The miter saw as claimed in claim 15, wherein the display surface is oriented to provide an angle not less than 90 degrees relative to an upper surface of the base section when the circular saw unit is at its lowermost position.

17. The miter saw as claimed in claim 14, wherein the circular saw unit further comprises a saw cover provided integrally with the motor housing, and a handle having a handle grip positioned above the saw cover and offset from the digital display.

18. The miter saw as claimed in claim 13, wherein the tilting amount detection unit transmits an output signal indicative of a tilting amount, and the miter saw further comprising:
a pivot shaft supported to the support section and about which the circular saw unit is pivotally moved;
a control unit that outputs signal indicative of the tilting angle to the display based on the output signal transmitted from the tilting amount detection unit; and
a substrate mounting thereon the control unit and attached to the circular saw unit.

19. The miter saw as claimed in claim 18, wherein the support section comprises:
a holder having one end supported to the base section and another end;
a slide support portion provided at the another end;
a slide portion slidably supported to the slide support portion and movable in a direction perpendicular to the pivot shaft and in parallel with the upper surface of the base section, the circular saw unit being pivotally supported to the slide portion through the pivot shaft.

20. The miter saw as claimed in claim 19, wherein the tilting amount detection unit is disposed at the base section; and
the miter saw further comprising an electric cord extending from the tilting amount detection unit, passing along the slide portion and into the circular unit for electrically connecting the tilting amount detection unit to the control unit, the electric cord having a part formed into a spiral cord at a position along the slide portion.

21. The miter saw as claimed in claim 20, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion;
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.

22. A miter saw comprising:
a base section for mounting thereon a workpiece, and comprising a base, and a turntable supported to the base and rotatable about a rotation axis, the workpiece being mountable on the base and the turntable;
a circular saw unit that rotatably supports a circular saw blade;
a support section supported to the turntable and pivotally movably supporting the circular saw unit toward and away from the turntable about a pivot shaft;
a rotation amount detection unit that detects angular rotation amount of the turntable relative to the base and transmits an output signal indicative of a rotation amount;
a display having a display surface that displays a rotation angle of the turntable, the display being attached to the circular saw unit in such a manner that an orientation of a normal line of the display surface is changeable with respect to the circular saw unit; and
a control unit that outputs signal indicative of the rotation angle to the display based on the output signal transmitted from the rotation amount detection unit.

23. The miter saw as claimed in claim 22, wherein the support section comprises:
a holder having one end supported to the turntable and another end;
a slide support portion provided at the another end;
a slide portion slidably supported to the slide support portion and movable relative to the base section in a direction perpendicular to the pivot shaft and in parallel with an upper surface of the turntable, the circular saw unit being pivotally supported to the slide portion through the pivot shaft.

24. The miter saw as claimed in claim 23, wherein the rotation amount detection unit is disposed at the base section; and
the miter saw further comprising an electric cord extending from the rotation amount detection unit, passing along the slide portion and into the circular saw unit for electrically connecting the rotation amount detection unit to the display, the electric cord having a part formed into a spiral cord at a position along the slide portion.

25. The miter saw as claimed in claim 24, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion; and
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.

26. The miter saw as claimed in claim 22, further comprising a flexible arm having a base end fixed to the circular saw unit and a free end provided with the display, whereby the display is universally movable frontward/rearward, rightward/leftward and upward/downward relative to the circular saw unit.

27. The miter saw as claimed in claim 22, wherein the pivot shaft is supported to the support section and about which the circular saw unit is pivotally moved; and the miter saw further comprising:
a tilting amount detection unit that detects a tilting amount of a side surface of the circular saw blade relative to an upper surface of the base section and transmits an output signal indicative of a tilting amount, the display surface also displaying a tilting angle of the circular saw blade, and the control unit also outputting signal indicative of the tilting angle to the display based on the output signal transmitted from the tilting amount detection unit.

28. The miter saw as claimed in claim 27, wherein the support section comprises:
a holder having one end supported to the base section and another end;
a slide support portion provided at the another end;
a slide portion slidably supported to the slide support portion and movable in a direction perpendicular to the pivot shaft and in parallel with the upper surface of the base section, the circular saw unit being pivotally supported to the slide portion.

29. The miter saw as claimed in claim 28, wherein the tilting amount detection unit is disposed at the base section; and
the miter saw further comprising an electric cord extending from the tilting amount detection unit, passing along the slide portion and into the circular unit for electrically connecting the tilting amount detection unit to the display, the electric cord having a part formed into a spiral cord at a position along the slide portion.

30. The miter saw as claimed in claim 29, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion;
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.

31. A miter saw comprising:
a base section for mounting thereon a workpiece;
a circular saw unit that rotatably supports a circular saw blade;
a support section laterally tiltably supported to the base section, and pivotally movably supporting the circular saw unit toward and away from the base section;
a tilting amount detection unit that detects a tilting amount of a side surface of the circular saw blade relative to an upper surface of the base section; and
a digital display disposed at the circular saw unit for displaying a tilting angle based on data transmitted from the tilting amount detection unit.

32. The miter saw as claimed in claim 31, wherein the circular saw unit comprises a motor that rotationally drives the circular saw blade, and a motor housing that accommodates therein the motor, the digital display being attached to the motor housing.

33. The miter saw as claimed in claim 32, wherein the base section has a rear portion at which the support section is laterally movably supported, and
wherein the circular saw unit is pivotally movable between its uppermost position and its lowermost position; and
wherein the digital display is disposed at an upper portion of the motor housing and has a display surface oriented generally frontward when the circular saw unit is at its uppermost position.

34. The miter saw as claimed in claim 33, wherein the display surface is oriented to provide an angle not less than 90 degrees relative to an upper surface of the base section when the circular saw unit is at its lowermost position.

35. The miter saw as claimed in claim 32, wherein the circular saw unit further comprises a saw cover provided integrally with the motor housing, and a handle having a handle grip positioned above the saw cover and offset from the digital display.

36. The miter saw as claimed in claim 31, wherein the tilting amount detection unit transmits an output signal indicative of a tilting amount; and
the miter saw further comprising:
a pivot shaft supported to the support section and about which the circular saw unit is pivotally moved;
a control unit that outputs signal indicative of the tilting angle to the display based on the output signal transmitted from the tilting amount detection unit; and
a substrate mounting thereon the control unit and attached to the circular saw unit.

37. The miter saw as claimed in claim 36, wherein the support section comprises:
a holder having one end supported to the base section and another end;
a slide support portion provided at the another end;
a slide portion slidably supported to the slide support portion and movable in a direction perpendicular to the pivot shaft and in parallel with the upper surface of the base section, the circular saw unit being pivotally supported to the slide portion through the pivot shaft.

38. The miter saw as claimed in claim 37, wherein the tilting amount detection unit is disposed at the base section; and
the miter saw further comprising an electric cord extending from the tilting amount detection unit, passing along the slide portion and into the circular unit for electrically connecting the tilting amount detection unit to the control unit, the electric cord having a part formed into a spiral cord at a position along the slide portion.

39. The miter saw as claimed in claim 38, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion;
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.

40. A miter saw comprising:
a base section for mounting thereon a workpiece;
a circular saw unit that rotatably supports a circular saw blade;
a support section laterally tiltably supported to the base section and pivotally supporting the circular saw unit movably toward and away from the base section about a pivot shaft;
a tilting amount detection unit that detects a tilting amount of a side surface of the circular saw blade relative to an upper surface of the base section and transmits an output signal indicative of a tilting amount;
a display having a display surface that displays a tilting angle of the circular saw blade, and attached to the circular saw unit in such a manner that an orientation of a normal line of the display surface is changeable relative to the circular saw unit; and
a control unit that outputs signal indicative of the tilting angle to the display based on the output signal transmitted from the tilting amount detection unit.

41. The miter saw as claimed in claim 40, wherein the support section comprises:
a holder having one end supported to the base section and another end;
a slide support portion provided at the another end;
a slide portion slidably supported to the slide support portion and movable in a direction perpendicular to the pivot shaft and in parallel with the upper surface of the base section, the circular saw unit being pivotally supported to the slide portion through the pivot shaft.

42. The miter saw as claimed in claim 41, wherein the tilting amount detection unit is disposed at the base section; and
the miter saw further comprising an electric cord extending from the tilting amount detection unit, passing along the slide portion and into the circular unit for electrically connecting the tilting amount detection unit to the display, the electric cord having a part formed into a spiral cord at a position along the slide portion.

43. The miter saw as claimed in claim 42, wherein the slide portion comprises:
a pair of pipes having a rear end portion slidably supported to the slide support portion, and a front end portion supporting the circular saw unit, the circular saw blade being movable in an axial direction of the pipes in response to a sliding movement of the pair of pipes relative to the slide support portion;
a first end holding member holding each rear end of the pair of pipes, and a second end holding member holding each front end of the pair of pipes so as to align the pair of pipes generally in parallel with each other, an imaginary plane containing axes of the pair of pipes being in parallel with a direction of a pivotal movement of the circular saw unit toward and away from the turntable; and
wherein the circular saw unit comprises a second slide support pivotally movably supporting the circular saw blade, and slidable relative to the pair of pipes for moving the circular saw blade in the axial direction of the pair of pipes, and
the miter saw further comprising a plate like cover extending in parallel with the imaginary plane and having a rear end fixed to the first end holding member, and a front end fixed to the second end holding member.
